(19) United States
(12) Patent Application Publication
(10) Pub. No.: US 2026/0159615 A1
(43) Pub. Date: Jun. 11, 2026

(54) METALLOCENES CONTAINING ALKENYLOXYPHENYL GROUPS PRODUCING HIGH MOLECULAR WEIGHT POLYETHYLENE

(71) Applicant: Chevron Phillips Chemical Company LP, The Woodlands, TX (US)

(72) Inventors: Chengbao NI, Bartlesville, OK (US); Qing YANG, Bartlesville, OK (US)

(73) Assignee: Chevron Phillips Chemical Company LP, The Woodlands, TX (US)

(21) Appl. No.: 18/973,254

(22) Filed: Dec. 9, 2024

(51) Int. Cl. C08F 4/76; C08F 4/52; C08F 110/02

(52) U.S. Cl. CPC C08F 4/76; C08F 4/52; C08F 110/02; C08F 2420/09

(57) ABSTRACT

Disclosed are new metallocenes, catalyst systems, and processes, in which the catalyst systems may include metallocene-solid super acids (SSA) activator-support combinations. Ansa-metallocenes having a cyclopentadienyl ligand and a fluorenyl ligand bridged by a linking group of the formula >C[C₆H₂R¹R²₂][R³] are described, wherein R¹ is —O(CH₂)ₘCH═CH₂; each R² is independently H or a C₁-C₂₀ hydrocarbyl group; R³ is H, a C₁-C₂₀ hydrocarbyl group, or [C₆H₂R⁴R⁵₂]; R⁴ is H, a C₁-C₂₀ hydrocarbyl group, or —O(CH₂)ₙCH═CH₂; each R⁵ is independently H or a C₁-C₂₀ hydrocarbyl group; and m and n are selected independently from an integer from 1 to 20. The catalyst systems exhibit high activity and produce polyethylenes with high molecular weights and low levels of long chain branching (LCB) as compared to polyethylenes produced with a benchmark metallocene.

### CROSS REFERENCE TO RELATED APPLICATIONS

None.

### TECHNICAL FIELD OF THE DISCLOSURE

This disclosure relates to catalyst compositions for producing ethylene homopolymers and co-polymers, and polymerization processes for preparing the same.

### BACKGROUND OF THE DISCLOSURE

The development of new olefin polymerization catalysts is of great interest in the polyolefin industry because of their potential to tailor resin architectures and provide customized polymer properties. This interest is particularly intense in the search for new metallocene-based catalysts, where metallocene structures may afford new opportunities and potential for designing next generation catalysts. However, several challenges remain as obstacles to the further advancement of metallocene technology.

Polyolefin molecular weight and long chain branching (LCB) content can play important roles in the processability of polyethylene resins and their applications. One persistent issue with advancing catalyst technology is the need to control the formation of long chain branching (LCB) in metallocene-based polyethylenes, which can greatly affect polymer processing and the final resin properties. Therefore, there remains a need for new catalysts, catalyst compositions, and catalytic processes for preparing polyolefins with controlled or reduced levels of long chain branching, and which provide molecular weight distributions which are not as narrow as polyethylenes produced using conventional metallocene catalysts. The new metallocenes which can provide resins with the desired low levels of LCB, and broader molecular weight distributions are of particular interest.

### SUMMARY OF THE DISCLOSURE

This disclosure provides new metallocene compounds, catalyst compositions comprising a metallocene compound, processes for polymerizing olefins, methods for making catalyst compositions, olefin polymers and copolymers, and articles made from olefin polymers and copolymers. In an aspect, disclosed herein are metallocenes, metallocene-based catalyst compositions, and processes for polymerizing olefins comprising contacting at least one olefin monomer and a catalyst composition comprising a metallocene compound under polymerization conditions to form an olefin polymer, in which low levels of long chain branching (LCB) occur.

One approach to controlling LCB formation can be to incorporate a pendent or tethered olefin moiety into a metallocene catalyst, which has been observed to reduce LCB formation versus an analogous metallocene catalyst with a saturated tether. While not intending to be bound by theory, it is possible that the pendent olefin may protect the active catalytic site by coordinating or interacting with the metallocene and in doing so, inhibit the insertion of an in-situ generated macromonomer or olefin oligomer into a growing polymer chain, which would otherwise lead to long chain branch formation. However, the skilled artisan has been dissuaded from extending this principle to pendent or tethered heteroatom-containing groups in an effort to similarly inhibit macromonomer insertion into the growing polymer chain. One concern arising from this effort is that a polar heteroatom also might be expected to poison and deactivate the metallocene catalyst because of the cationic and highly electrophilic/oxophilic nature of the metal atom.

It has now been unexpectedly discovered that an oxygen containing pendent groups or “tethers” bonded to a metallocene structure can also function to reduce LCB formation versus an analogous metallocene catalyst with an unsubstituted tether. A series of new bridged metallocenes with carbon bridged fluorenyl and cyclopentadienyl ligands and bearing one or two alkenyloxyphenyl on the carbon bridge were prepared and evaluated for their polymerization activities and resulting polyethylene properties. In an aspect, it can be shown that the incorporated one or two alkenyloxyphenyl groups provides metallocene catalysts that are highly active for ethylene polymerization, they produce desirable high molecular weight polymers, and they provide low levels of long chain branching (LCB) similar or improved over metallocenes with a tethered olefin group in substantially closer proximity to the metal site.

Accordingly, in one aspect of this disclosure there is provided a metallocene compound having the formula:

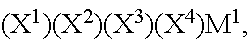

wherein
M¹ is titanium, zirconium, or hafnium;
X¹ is a substituted or an unsubstituted cyclopentadienyl ligand, wherein substituents, when present, are selected independently from a C₁-C₂₀ hydrocarbyl group;
X² is a substituted or an unsubstituted fluorenyl ligand, wherein substituents, when present, are selected independently from a C₁-C₂₀ hydrocarbyl group;
X¹ and X² are bridged by a linking group having the formula >C[C₆H₂R¹R²₂][R³], wherein
   R¹ is —O(CH₂)ₘCH═CH₂;
   R² in each occurrence is selected independently from H or a C₁-C₂₀ hydrocarbyl group;
   R³ is H, a C₁-C₂₀ hydrocarbyl group, or [C₆H₂R⁴R⁵₂];
   R⁴ is H, a C₁-C₂₀ hydrocarbyl group, or —O(CH₂)ₙCH═CH₂;
   R⁵ in each occurrence is selected independently from H or a C₁-C₂₀ hydrocarbyl group; and
   m and n in each occurrence are selected independently from an integer from 1 to 20; and
X³ and X⁴ are independently a monoanionic ligand.

In these metallocene compounds, R¹ can be bonded to the 3-, 4-, or 5-position of the C₆H₂R¹R²₂ group, and independently R⁴ can be bonded to the 3-, 4-, or 5-position of the C₆H₂R⁴R⁵₂ group. It will be appreciated that in the absence of other substituents or when a single substituent occupies the 4-position, the 3- and 5-positions of the aryl ring are equivalent. Further, R¹ and the independently selected R² groups can be bonded to and distributed among the 3-, 4-, and 5-positions of the C₆H₂R¹R²₂ moiety, and independently, R⁴ and the independently selected R⁵ groups can be bonded to and distributed among the 3-, 4-, and 5-positions of the C₆H₂R⁴R⁵₂ moiety. The R¹ and R⁴ groups are selected independently, therefore when R³ is [C₆H₂R⁴R⁵₂], this disclosure provides for linking groups such as >C[C₆H₄-p-R¹][C₆H₄-p-R⁴], >C[C₆H₄-p-R¹][C₆H₄-m-R⁴], >C[C₆H₄-m-R¹][C₆H₄-m-R⁴], and >C[C₆H₄-m-R¹][C₆H₄-p-R⁴], where the meta substituent is the 3-position and the para substituent is the 4-position. Examples of these alkenyloxyphenyl groups include but are not limited to an allyloxyphenyl group and a butenyloxyphenyl group.

Also provided herein are a catalyst composition for polymerizing olefins, in which the catalyst composition can comprise or can comprise the contact product of: (a) the metallocene having the formula (X¹)(X²)(X³)(X⁴)M¹ as set out immediately above; and (b) a metallocene activator or any components thereof. Accordingly, there is provided a process for polymerizing olefins, the process comprising contacting at least one olefin monomer and a catalyst composition under polymerization conditions to form a polyolefin, wherein the catalyst composition can comprise or can comprise the contact product of: (a) the metallocene having the formula (X¹)(X²)(X³)(X⁴)M¹ as set out immediately above; and (b) a metallocene activator or all components thereof necessary to activate the metallocene. Any metallocene activator can be used in this process. Further, there is also provided a method of making a catalyst composition, the method comprising contacting in any order: (a) the metallocene having the formula (X¹)(X²)(X³)(X⁴)M¹ as set out immediately above; and (b) a metallocene activator or any components thereof.

While any metallocene activator can be used, these catalysts showed excellent activity and resin properties when activated using a solid oxide treated with an electron-withdrawing anion, also termed a solid super acid of “SSA”, in combination with a co-catalyst such as an organoaluminum compound. The resulting catalyst compositions exhibited very high activities, excellent melt index (MI) responses to added hydrogen and/or 1-hexene, and a polydispersity that is appropriately broad to impart good resin processability and end use properties. Polymer molecular weights could be readily tuned using either H₂ (hydrogen, also written H2) or 1-hexene (also written C6 or C₆).

These metallocene-based catalysts can produce polymers with a broad molecular weight distribution (MWD, Mw/Mn, or polydispersity index) of from about 1.5 to about 10 for ethylene homopolymers and from about 1.5 to about 13.5 for ethylene-α-olefin copolymers, which contrast with the typical metallocene catalysts which produce polyethylenes having a MWD of from about 2 to about 3. One benchmark metallocene catalyst was a metallocene catalyst absent an alkenyloxyphenyl group but including an omega-alkenyl group bonded to the cyclopentadienyl ring of the metallocene, Ph₂C(2,7-di-t-butylfluorenyl)(2-ω-pentenyl-cyclopentadienyl)ZrCl₂ (Met-4), also written [2,7-t-butylfluorenyl(Ph₂C)(3-penten-1-yl-Cp)]ZrCl₂. Compared with Met-4, the metallocene Ph(4-allyloxy-Ph)C(2,7-di-t-butylfluorenyl)(cyclopentadienyl) ZrCl₂ (Met-1), also written [2,7-t-butylfluorenyl((4-allyl-O—C₆H₄)PhC)Cp]ZrCl₂, showed activity in ethylene polymerization and produced polymers with significantly higher molecular weight.

Accordingly, in one aspect of this disclosure, there is provided a catalyst composition for polymerizing olefins, in which the catalyst composition can comprise or comprise the contact product of:
(a) a metallocene compound having the formula:

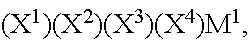

wherein
   M¹ is titanium, zirconium, or hafnium;
   X¹ is a substituted or an unsubstituted cyclopentadienyl ligand, wherein substituents, when present, are selected independently from a C₁-C₂₀ hydrocarbyl group;
   X² is a substituted or an unsubstituted fluorenyl ligand, wherein substituents, when present, are selected independently from a C₁-C₂₀ hydrocarbyl group;
   X¹ and X² are bridged by a linking group having the formula >C[C₆H₂R¹R²₂][R³], wherein
      R¹ is —O(CH₂)ₘCH═CH₂;
      R² in each occurrence is selected independently from H or a C₁-C₂₀ hydrocarbyl group;
      R³ is H, a C₁-C₂₀ hydrocarbyl group, or [C₆H₂R⁴R⁵₂];
      R⁴ is H, a C₁-C₂₀ hydrocarbyl group, or —O(CH₂)ₙCH═CH₂;
      R⁵ in each occurrence is selected independently from H or a C₁-C₂₀ hydrocarbyl group; and
      m and n in each occurrence are selected independently from an integer from 1 to 20; and
   X³ and X⁴ are independently a monoanionic ligand;
(b) a metallocene activator or any components thereof; and
(c) optionally, a co-catalyst.

There is also disclosed a process for polymerizing olefins, the process comprising contacting at least one olefin monomer and a catalyst composition under polymerization conditions to form a polyolefin, wherein the catalyst composition comprises the contact product of:
(a) a metallocene compound having the formula:

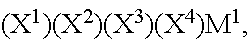

wherein
   M¹ is titanium, zirconium, or hafnium;
   X¹ is a substituted or an unsubstituted cyclopentadienyl ligand, wherein substituents, when present, are selected independently from a C₁-C₂₀ hydrocarbyl group;
   X² is a substituted or an unsubstituted fluorenyl ligand, wherein substituents, when present, are selected independently from a C₁-C₂₀ hydrocarbyl group;
   X¹ and X² are bridged by a linking group having the formula >C[C₆H₂R¹R²₂][R³], wherein
      R¹ is —O(CH₂)ₘCH═CH₂;
      R² in each occurrence is selected independently from H or a C₁-C₂₀ hydrocarbyl group;
      R³ is H, a C₁-C₂₀ hydrocarbyl group, or [C₆H₂R⁴R⁵₂];
      R⁴ is H, a C₁-C₂₀ hydrocarbyl group, or —O(CH₂)ₙCH═CH₂;
      R⁵ in each occurrence is selected independently from H or a C₁-C₂₀ hydrocarbyl group; and
      m and n in each occurrence are selected independently from an integer from 1 to 20; and
   X³ and X⁴ are independently a monoanionic ligand;
(b) a metallocene activator or all components thereof; and
(c) optionally, a co-catalyst.

Still another aspect of the disclosure provides a method of making a catalyst composition, the method comprising contacting in any order:
(a) a metallocene compound having the formula:

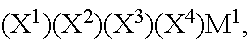

wherein
   M¹ is titanium, zirconium, or hafnium;
   X¹ is a substituted or an unsubstituted cyclopentadienyl ligand, wherein substituents, when present, are selected independently from a C₁-C₂₀ hydrocarbyl group;
   X² is a substituted or an unsubstituted fluorenyl ligand, wherein substituents, when present, are selected independently from a C₁-C₂₀ hydrocarbyl group;
   X¹ and X² are bridged by a linking group having the formula >C[C₆H₂R¹R²₂][R³], wherein
      R¹ is —O(CH₂)ₘCH═CH₂;
      R² in each occurrence is selected independently from H or a C₁-C₂₀ hydrocarbyl group;
      R³ is H, a C₁-C₂₀ hydrocarbyl group, or [C₆H₂R⁴R⁵₂];
      R⁴ is H, a C₁-C₂₀ hydrocarbyl group, or —O(CH₂)ₙCH═CH₂;
      R⁵ in each occurrence is selected independently from H or a C₁-C₂₀ hydrocarbyl group; and
      m and n in each occurrence are selected independently from an integer from 1 to 20; and
   X³ and X⁴ are independently a monoanionic ligand;
(b) a metallocene activator or any components thereof; and
(c) optionally, a co-catalyst.

In each of the above aspects and embodiments, X³ and X⁴ can be selected independently from any suitable monoanionic ligand, such as but not limited to, halide, hydride, a C₁-C₂₀ hydrocarbyl group, a C₁-C₂₀ heterohydrocarbyl group, tetrahydroborate, OBR^{A}₂, OSO₂R^{A}, or NR^{A}₂ wherein R^{A} is independently a C₁-C₁₂ hydrocarbyl group.

In the above aspects and embodiments, the metallocene activator can be any suitable metallocene activator. In embodiments, the metallocene activator can be an activator-support comprising, consisting essentially of, of consisting of a solid oxide treated with an electron-withdrawing anion (“solid super acid”). Examples of solid oxide treated with an electron-withdrawing anion include but are not limited to those in which: (a) the solid oxide comprises, consists essentially of, or is selected from silica, alumina, silica-alumina, silica-coated alumina, mullite, aluminum phosphate, aluminophosphate, heteropolytungstate, titania, zirconia, magnesia, boria, zinc oxide, a mixed oxide thereof, or any mixture thereof; and (b) the electron-withdrawing anion comprises, consists essentially of, or is selected from sulfate, bisulfate, fluorosulfate, phosphate, fluorophosphates, fluoride, or chloride. Alternatively, the catalyst composition can comprise, consist essentially of, or consist of any metallocene activator, such as, for example alkylaluminoxanes, other activator-supports with or without other co-cocatalysts as described herein.

Also in these above aspects and embodiments the catalyst composition, process for polymerizing olefins, and method for making a catalyst composition, can further comprise a co-catalyst. For example, in the catalyst composition or the process for polymerizing olefins, the catalyst composition further comprises the contact product with a co-catalyst. In the method of making a catalyst composition, the contacting step further comprises contacting the metallocene compound and the metallocene activator or any components thereof with a co-catalyst in any order. In some aspects, the co-catalyst can comprise, consist essentially of, or be selected from an alkylating agent. Suitable co-catalysts include but are not limited to organoaluminum co-catalysts, as described.

This disclosure further describes the olefin polymers made by the disclosed process and describes fabricating an article of manufacture comprising the olefin polymers produced according to the disclosure, by any technique.

These and other embodiments and aspects of the processes, methods, and compositions including catalyst compositions are described more fully in the Detailed Description and claims and further disclosure such as the Examples provided herein.

### BRIEF DESCRIPTION OF THE FIGURES

FIG. 1 illustrates the structures of representative metallocene compounds according to this disclosure (Met-1 through Met-3), and comparative metallocene Met-4.

FIG. 2A and FIG. 2B provide comparative data for Met-1, Met-2, Met-3, and comparative metallocene Met-4 when producing ethylene homopolymers. FIG. 2A demonstrates the catalyst response to hydrogen, plotting the H₂ concentration (ppm) versus metallocene catalyst activity (g PE/(g metallocene·hour)) using 0-200 ppm of H₂ and 390 psi of ethylene (90° C. for 30 minutes). FIG. 2B shows a Janzen-Colby plot for the noted homopolymer Examples in Table 1 and Table 2 produced with metallocenes Met-1 through Met-4.

FIGS. 3A-3D provide comparative data for Met-1 versus Met-4 metallocene catalysts and polymers. FIG. 3A plots the responses to hydrogen (0-200 ppm of H₂, 390 psi of ethylene, 90° C. for 30 minutes). FIG. 3B plots the responses to 1-hexene (0-30 g of 1-hexene, 340 psi of ethylene, 80° C. for 30 minutes). FIG. 3C plots provides the molecular weight distribution plots (MWD) of homopolymers (runs with 0 ppm of H₂) and copolymers (runs with ˜30 g of 1-hexene). FIG. 3D presents the Janzen-Colby plots of homopolymers (runs with 0 and 100 ppm of H₂).

FIGS. 4A-4D provide comparative data for Met-1 versus Met-2 metallocene catalysts and polymers. FIG. 4A plots the responses to hydrogen (0-200 ppm of H₂, 390 psi of ethylene, 90° C. for 30 minutes). FIG. 4B plots the responses to 1-hexene (0-30 g of 1-hexene, 340 psi of ethylene, 80° C. for 30 minutes). FIG. 4C plots provides the molecular weight distribution plots (MWD) of homopolymers (runs with 0 ppm of H₂) and copolymers (runs with ˜30 g of 1-hexene). FIG. 4D presents the Janzen-Colby plots of homopolymers (runs with 0 and 100 ppm of H₂).

FIGS. 5A-5D provide comparative data for Met-2 versus Met-3 metallocene catalysts and polymers. FIG. 5A plots the responses to hydrogen (0-200 ppm of H₂, 390 psi of ethylene, 90° C. for 30 minutes). FIG. 5B plots the responses to 1-hexene (0-30 g of 1-hexene, 340 psi of ethylene, 80° C. for 30 minutes). FIG. 5C plots provides the molecular weight distribution plots (MWD) of homopolymers (runs with 0 ppm of H₂) and copolymers (runs with ˜30 g of 1-hexene). FIG. 5D presents the Janzen-Colby plots of homopolymers (runs with 0 and 100 ppm of H₂).

### DETAILED DESCRIPTION OF THE DISCLOSURE

### General Description

This disclosure provides generally for metallocene compounds, catalyst compositions comprising a metallocene compound, processes for polymerizing olefins, methods for making catalyst compositions, olefin polymers and copolymers and articles made from the olefin polymers and copolymers. In an aspect, this disclosure provides for catalytic processes for polymerizing olefins to form a polyethylene having limited or reduced levels of long chain branching in the polymer. The disclosure also describes the ethylene homopolymers and ethylene-co-alpha-olefin copolymers prepared using the catalytic processes, as well as articles made from these polymers and copolymers.

Accordingly, it has now been unexpectedly discovered that an oxygen containing pendent groups or “tethers” bonded to a metallocene structure can function to reduce LCB formation versus an analogous metallocene catalyst with an unsubstituted tether. This result is quite unexpected, as conventional thought teaches away from using a polar heteroatom substituent on a metallocene, such as an oxygen-containing substituent, which might be expected to poison and deactivate the catalyst because of the cationic and highly electrophilic/oxophilic nature of the metal atom.

This series of new bridged metallocenes includes structures having carbon-bridged fluorenyl and cyclopentadienyl ligands, in which the bridging carbon bears one or two independently selected 3-, 4-, or 5-alkenyloxyphenyl groups were prepared and examined for their polymerization activities and the resulting polyethylene properties. In an aspect, it can be shown that the incorporated one or two alkenyloxyphenyl groups provide metallocene catalysts that are highly active for ethylene polymerization, they produce desirable high molecular weight polymers, and they provide low levels of long chain branching (LCB) similar or improved over metallocenes with a tethered olefin group in substantially closer proximity to the metal site.

Specific examples of metallocenes that incorporate an alkenyloxyphenyl group include those with 4-allyloxy-Ph or 4-butenyloxy-Ph groups on the bridging atom. In the solid state, these complexes show comparable metallocene structures to those absent such groups, suggesting that the allyloxy or butenyloxy groups not impacting the solid-state structures of metallocenes.

In an aspect, this disclosure provides a metallocene compound having the formula:

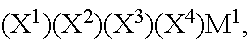

wherein
M¹ is titanium, zirconium, or hafnium;
X¹ is a substituted or an unsubstituted cyclopentadienyl ligand, wherein substituents, when present, are selected independently from a C₁-C₂₀ hydrocarbyl group;
X² is a substituted or an unsubstituted fluorenyl ligand, wherein substituents, when present, are selected independently from a C₁-C₂₀ hydrocarbyl group;
X¹ and X² are bridged by a linking group having the formula >C[C₆H₂R¹R²₂][R³], wherein
   R¹ is —O(CH₂)ₘCH═CH₂;
   R² in each occurrence is selected independently from H or a C₁-C₂₀ hydrocarbyl group;
   R³ is H, a C₁-C₂₀ hydrocarbyl group, or [C₆H₂R⁴R⁵₂];
   R⁴ is H, a C₁-C₂₀ hydrocarbyl group, or —O(CH₂)ₙCH═CH₂;
   R⁵ in each occurrence is selected independently from H or a C₁-C₂₀ hydrocarbyl group; and
   m and n in each occurrence are selected independently from an integer from 1 to 20; and
X³ and X⁴ are independently a monoanionic ligand.

In these metallocene compounds, R¹ can be bonded to the 3-, 4-, or 5-position of the C₆H₂R¹R²₂ group, and independently R⁴ can be bonded to the 3-, 4-, or 5-position of the C₆H₂R⁴R⁵₂ group. As understood by the skilled person, in the absence of other substituents or when a single substituent occupies the 4-position, the 3- and 5-positions of the aryl ring are equivalent. Further, R¹ and the independently selected R² groups can be bonded to and distributed among the 3-, 4-, and 5-positions of the C₆H₂R¹R²₂ moiety, and independently, R and the independently selected R⁵ groups can be bonded to and distributed among the 3-, 4-, and 5-positions of the C₆H₂R⁴R⁵₂ moiety. The R¹ and R⁴ groups are selected independently, therefore when R³ is [C₆H₂R⁴R⁵₂], this disclosure provides for linking groups such as >C[C₆H₄-p-R¹][C₆H₄-p-R⁴], >C[C₆H₄-p-R¹][C₆H₄-m-R⁴], >C[C₆H₄-m-R¹][C₆H₄- m-R⁴], and >C[C₆H₄-m-RJ][C₆H₄-p-R⁴], where the meta substituent is the 3-position and the para substituent is the 4-position.

Catalyst compositions for polymerizing olefins are also provided which can comprise or can comprise the contact product of: (a) the metallocene having the formula (X¹)(X²)(X³)(X⁴)M¹ as set out immediately above; (b) a metallocene activator or any components thereof; and (c) optionally, a co-catalyst. A process for polymerizing olefins is described, in which the process can comprise contacting at least one olefin monomer and a catalyst composition under polymerization conditions to form a polyolefin, in which the catalyst composition can comprise or can comprise the contact product of: (a) the metallocene having the formula (X¹)(X²)(X³)(X⁴)M¹ as set out immediately above; (b) a metallocene activator or all components thereof which are necessary to activate the metallocene; and (c) optionally, a co-catalyst. A method of making the catalyst composition is also described in which the method comprising contacting in any order: (a) the metallocene having the formula (X¹)(X²)(X³)(X⁴)M¹ as set out immediately above; (b) a metallocene activator or any components thereof; and (c) optionally, a co-catalyst.

While not intending to be bound by theory, it is possible that the pendent or tethered alkenyl moieties of the independently selected 3-, 4-, or 5-alkenyloxyphenyl groups may protect the active catalytic site by interacting with the transition metal, possibly through coordination, and in doing so inhibit the insertion of an in-situ generated macromonomer or olefin oligomer into a growing polymer chain, which would otherwise lead to long chain branch formation.

These metallocenes were unexpectedly shown to exhibit excellent activities and resin properties when activated using a solid oxide treated with an electron-withdrawing anion (solid super acid or “SSA”) in combination with a co-catalyst such as an organoaluminum compound. Significantly, the resins produced using these metallocene catalyst compositions showed reduced levels of long chain branching while also having a desirable broad molecular weight distribution (MWD or Mw/Mn). Therefore, these catalyst compositions fulfil a need for new catalysts with the ability to tune the resulting polyethylene resin properties within certain ranges over several parameters such as molecular weights, polydispersity indices, long chain branching, melt indices, and the like, all of which can be tuned to provide the desired resin properties.

In aspects of this disclosure, the metallocene activator can be a compound or a material that can convert a transition metal component such as a metallocene compound into an active catalyst that can polymerize olefins. While not intending to be bound by theory, an activator may function as a Lewis acid and interact with the transition metal or metallocene catalyst to form a cationic complex or incipient cationic complex, which is an active site for olefin polymerization. The metallocene activators disclosed herein can include, but are not limited to, a solid oxide treated with an electron-withdrawing anion (also termed an “activator-support”) in combination with an organoaluminum compound such as trialkylaluminum compounds. In the examples provided with this disclosure, the metallocene compounds were activated for olefin polymerization by contacting the metallocene with a co-catalyst such as triisobutylaluminum and an activator comprising a solid oxide treated with an electron withdrawing anion.

The solid oxide treated with an electron-withdrawing anion is fully described herein and may also be referred to throughout this disclosure using terms such as a solid oxide that has been chemically treated with an electron withdrawing anion, a chemically treated solid oxide (CTSO), a solid super acid (SSA), or an activator-support, and these terms are used interchangeably. Examples of the solid oxide that can be used to prepare the solid super acid (SSA) include, but are not limited to, silica, alumina, silica-alumina, silica-coated alumina, aluminum phosphate, mullite, boehmite, heteropolytungstates, titania, zirconia, magnesia, boria, zinc oxide, silica-zirconia, silica-titania, or any combination thereof. Examples of the electron withdrawing anion and the source for the electron withdrawing anion may that can be used to prepare the solid super acid (SSA) include, but are not limited to, fluoride, chloride, bromide, iodide, sulfate, bisulfate, fluorosulfate, fluoroborate, phosphate, fluorophosphate, trifluoroacetate, triflate, mesylate, thiosulfate, fluorozirconate, fluorotitanate, trifluoroacetate, and the like.

Each of the catalyst composition components and processes for making and using the catalyst composition for polymerizing olefins is fully described herein. Definitions of terms that are used in this disclosure are set out.

### Definitions

To define more clearly the terms used herein, the following definitions are provided, and unless otherwise indicated or the context requires otherwise, these definitions are applicable throughout this disclosure. If a term is used in this disclosure but is not specifically defined herein, the definition from the IUPAC Compendium of Chemical Terminology, 2^{nd} Ed (1997) can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

Regarding claim transitional terms or phrases, the transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Unless specified to the contrary, describing a compound or composition “consisting essentially of” is not to be construed as “comprising,” but is intended to describe the recited component that includes materials which do not significantly alter composition or method to which the term is applied. For example, a feedstock consisting essentially of a material and can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of, apply only to feature class to which is utilized, and it is possible to have different transitional terms or phrases utilized with different features within a claim. For example, a method can comprise several recited steps (and other non-recited steps) but utilize a catalyst composition preparation consisting of specific steps but utilize a catalyst composition comprising recited components and other non-recited components. While compositions and methods are described in terms of “comprising” various components or steps, the compositions and methods can also “consist essentially of” or “consist of” the various components or steps.

The terms “a,” “an,” and “the” are intended, unless specifically indicated otherwise, to include plural alternatives, e.g., at least one. For instance, the disclosure of “an organoaluminum compound” is meant to encompass one organoaluminum compound, or mixtures or combinations of more than one organoaluminum compound unless otherwise specified.

Groups of elements of the periodic table are indicated using the numbering scheme indicated in the version of the periodic table of elements published in Chemical and Engineering News, 63(5), 27, 1985. In some instances, a group of elements may be indicated using a common name assigned to the group; for example, alkali metals for Group 1 elements, alkaline earth metals for Group 2 elements, transition metals for Group 3-12 elements, halogens or halides for Group 17 elements, and the like.

For any compound disclosed herein, a general structure or name presented is also intended to encompass all structural isomers, conformational isomers, and stereoisomers that can arise from a particular set of substituents, unless indicated otherwise. Thus, a general reference to a compound includes all structural isomers unless explicitly indicated otherwise; e.g., a general reference to pentane includes n-pentane, 2-methyl-butane, and 2,2-dimethylpropane, while a general reference to a butyl group includes an n-butyl group, a sec-butyl group, an isobutyl group, and a tert-butyl group. Additionally, the reference to a general structure or name encompasses all enantiomers, diastereomers, and other optical isomers whether in enantiomeric or racemic forms, as well as mixtures of stereoisomers, as the context permits or requires. For any formula or name that is presented, any general formula or name presented also encompasses all conformational isomers, regioisomers, and stereoisomers that can arise from a particular set of substituents.

Groups may be specified according to the atom that is bonded to the metal or bonded to another chemical moiety as a substituent, such as an “oxygen-bonded group,” which is also called an “oxygen group.” For example, an oxygen-bonded group includes species such as hydrocarbyloxide (—OR where R is a hydrocarbyl group, also termed hydrocarboxy), alkoxide (—OR where R is an alkyl group), aryloxide (—OAr where Ar is an aryl group), or substituted analogs thereof, which function as ligands or substituents in the specified location. Therefore, an alkoxide group and an aryloxide group are each a subgenus of a hydrocarbyloxide (hydrocarbyloxy) group.

Unless otherwise specified, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified or unless the context requires otherwise, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. In an aspect, the context could require other ranges or limitations, for example, when the subject carbon-containing group is an aryl group or an alkenyl group, the lower limit of carbons in these subject groups is six carbon atoms and two carbon atoms, respectively. Moreover, other identifiers or qualifying terms may be utilized to indicate the presence or absence of a particular substituent, a particular regiochemistry and/or stereochemistry, or the presence of absence of a branched underlying structure or backbone, and the like.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, by disclosing a temperature of from 70° C. to 80° C., Applicant's intent is to recite individually 70° C., 71° C., 72° C., 73° C., 74° C., 75° C., 76° C., 77° C., 78° C., 79° C., and 80° C., including any sub-ranges and combinations of sub-ranges encompassed therein, and these methods of describing such ranges are interchangeable. Moreover, all numerical end points of ranges disclosed herein are approximate, unless excluded by proviso. As a representative example, if Applicant states that one or more steps in the processes disclosed herein can be conducted at a temperature in a range from 10° C. to 75° C., this range should be interpreted as encompassing temperatures in a range from “about” 10° C. to “about” 75° C.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±15% of the stated value, ±10% of the stated value, ±5% of the stated value, or ±3% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any individual substituents, analogs, compounds, ligands, structures, or groups thereof, or any members of a claimed group, if for any reason Applicant chooses to claim less than the full measure of the disclosure, for example, to account for a reference or prior disclosure that Applicants may be unaware of at the time of the filing of the application.

The term “substituted” when used to describe a group, for example, when referring to a substituted analog of a particular group, is intended to describe any non-hydrogen moiety that formally replaces a hydrogen in that group and is intended to be non-limiting. A group or groups can also be referred to herein as “unsubstituted” or by equivalent terms such as “non-substituted,” which refers to the original group in which a non-hydrogen moiety does not replace a hydrogen within that group. Unless otherwise specified, “substituted” is intended to be non-limiting and include inorganic substituents or organic substituents as understood by one of ordinary skill in the art.

A chemical “group” may be described according to how that group is formally derived from a reference or “parent” compound, for example, by the number of hydrogen atoms formally removed from the parent compound to generate the group, even if that group is not literally synthesized in this manner. These groups can be utilized as substituents or coordinated or bonded to metal atoms. For example, an “alkyl group” formally can be derived by removing one hydrogen atom from an alkane, while an “alkanediyl group” (also referred to as a “alkylene group”) formally can be derived by removing two hydrogen atoms from an alkane. Moreover, a more general term can be used to encompass a variety of groups that formally are derived by removing any number (“one or more”) of hydrogen atoms from a parent compound, which in this example can be described as an “alkane group,” which encompasses an “alkyl group,” an “alkanediyl group,” and materials have three or more hydrogen atoms, as necessary for the situation, removed from the alkane. The disclosure that a substituent, ligand, or other chemical moiety can constitute a particular “group” implies that the known rules of chemical structure and bonding are followed when that group is employed as described. When describing a group as being “derived by,” “derived from,” “formed by,” or “formed from,” such terms are used in a formal sense and are not intended to reflect any specific synthetic method or procedure, unless specified otherwise or the context requires otherwise.

The term “hydrocarbon” whenever used in this specification and claims refers to a compound containing only carbon and hydrogen. Other identifiers can be utilized to indicate the presence of particular groups in the hydrocarbon (e.g., halogenated hydrocarbon indicates that the presence of one or more halogen atoms replacing an equivalent number of hydrogen atoms in the hydrocarbon).

The term “hydrocarbyl” group is used herein in accordance with the definition specified by IUPAC as follows: a univalent group formed by removing a hydrogen atom from a hydrocarbon (that is, a group containing only carbon and hydrogen). Non-limiting examples of hydrocarbyl groups include ethyl, phenyl, tolyl, propenyl, cyclopentyl, and the like. The term “hydrocarbylene” group is also used herein in accordance with the definition specified by IUPAC as follows: a “hydrocarbylene” group refers to a divalent group formed by removing two hydrogen atoms from a hydrocarbon or a substituted hydrocarbon, the free valencies of which are not engaged in forming a double bond. By way of example and comparison, examples of hydrocarbyl and hydrocarbylene groups include, respectively: aryl and arylene; alkyl and alkanediyl (or “alkylene”); cycloalkyl and cycloalkanediyl (or “cycloalkylene”); aralkyl and aralkanediyl (or “aralkylene”); and so forth. For example, an “arylene” group is used in accordance with IUPAC definition to refer to a bivalent group derived from arenes by removal of a hydrogen atom from two ring carbon atoms, which may also be termed an “arenediyl” group. Examples of hydrocarbylene groups include but are not limited to: 1,2-phenylene; 1,3-phenylene; 1,2-propandiyl; 1,3-propandiyl; 1,2-ethandiyl; 1,4-butandiyl; 2,3-butandiyl; and methylene (—CH₂—).

The term “heterohydrocarbyl” group is used herein to refer to a univalent group, which can be linear, branched, or cyclic, formed by removing a single hydrogen atom from [a] a heteroatom or [b] a carbon atom of a parent “heterohydrocarbon” molecule, the heterohydrocarbon molecule being one in which at least one carbon atom is replaced by a heteroatom. Examples of “heterohydrocarbyl” groups formed by removing a single hydrogen atom from a heteroatom of a heterohydrocarbon molecule include, for example: [1] a hydrocarbyloxide group, for example, an alkoxide (—OR) group such as tert-butoxide or aryloxide (—OAr) group such as a substituted or unsubstituted phenoxide formed by removing the hydrogen atom from the hydroxyl (OH) group of a parent alcohol or a phenol molecule; [2] a hydrocarbylsulfide group, for example, an alkylthiolate (—SR) group or arylthiolate (—SAr) group formed by removing the hydrogen atom from the thiol (—SH) group of an alkylthiol or arylthiol; [3] a hydrocarbylamino group, for example, an alkylamino (—NHR) group or arylamino (—NHAr) group formed by removing a hydrogen atom from the amino (—NH₂) group of an alkylamine or arylamine molecule; and [4] a trihydrocarbylsilyl group such as trialkylsilyl (—SiR₃) or triarylsilyl (—SiAr₃) group. Examples of “heterohydrocarbyl” groups formed by removing a single hydrogen atom from a carbon atom of a heterohydrocarbon molecule include, for example, heteroatom-substituted hydrocarbyl groups such as a heteroatom-substituted alkyl group such as trimethylsilylmethyl (—CH₂SiMe₃) or methoxymethyl (—CH₂OCH₃) or a heteroatom-substituted aryl group such as p-methoxy-substituted phenyl (—C₆H₅-p-OCH₃).

An “aliphatic” compound is a class of acyclic or cyclic, saturated or unsaturated, carbon compounds, excluding aromatic compounds, e.g., an aliphatic compound is a non-aromatic organic compound. An “aliphatic group” is a generalized group formed by removing one or more hydrogen atoms (as necessary for that group) from a carbon atom of an aliphatic compound. Aliphatic compounds and therefore aliphatic groups can contain organic functional group(s) and/or atom(s) other than carbon and hydrogen.

The term “alkane” whenever used in this specification and claims refers to a saturated hydrocarbon compound. Other identifiers can be utilized to indicate the presence of particular groups in the alkane (e.g., halogenated alkane indicates that the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic and/or linear or branched unless otherwise specified. Primary, secondary, and tertiary alkyl groups are derived by removal of a hydrogen atom from a primary, secondary, and tertiary carbon atom, respectively, of an alkane. The n-alkyl group can be derived by removal of a hydrogen atom from a terminal carbon atom of a linear alkane. The groups of the form RCH₂ (R≠H), R₂CH (R≠H), and R₃C (R≠H) are primary, secondary, and tertiary alkyl groups, respectively, wherein R is itself alkyl group.

The term “carbocyclic” group is used herein to refer to a group in which a carbocyclic compound is the parent compound, that is, a cyclic compound in which all the ring members are carbon atoms. The carbocyclic group is formed by removing one or more hydrogen atoms from the carbocyclic compound. For example, a carbocyclic group can be a univalent group formed by removing a hydrogen atom from a carbocyclic compound. Non-limiting examples of carbocyclic groups include, for example, cyclopentyl, cyclohexyl, phenyl, tolyl, naphthyl and the like.

A “cycloalkane” is a saturated cyclic hydrocarbon, with or without side chains, for example, cyclobutane. Other identifiers can be utilized to indicate the presence of particular groups in the cycloalkane (e.g., halogenated cycloalkane indicates that the presence of one or more halogen atoms replacing an equivalent number of hydrogen atoms in the cycloalkane). Unsaturated cyclic hydrocarbons having one endocyclic double or one triple bond are called cycloalkenes and cycloalkynes, respectively. Those having more than one such multiple bond are cycloalkadienes, cycloalkatrienes, and so forth. Other identifiers can be utilized to indicate the presence of particular groups in the cycloalkenes, cycloalkadienes, cycloalkatrienes, and so forth.

A “cycloalkyl” group is a univalent group derived by removing a hydrogen atom from a ring carbon atom from a cycloalkane. Examples of cycloalkyl groups include cyclobutyl, cyclopentyl, cyclohexyl, and cycloheptyl groups. For clarity, other examples of cycloalkyl groups include a 1-methylcyclopropyl group and a 2-methylcyclopropyl group are illustrated as follows.

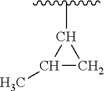 [SMILES: *C1CC1C]

A “cycloalkane group” refers to a generalized group formed by removing one or more hydrogen atoms (as necessary for the particular group and at least one of which is a ring carbon) from a cycloalkane.

The term “alkene” whenever used in this specification and claims refers to an olefin that has at least one carbon-carbon double bond. The term “alkene” includes aliphatic or aromatic, cyclic or acyclic, and/or linear and branched alkene unless expressly stated otherwise. The term “alkene,” by itself, does not indicate the presence or absence of heteroatoms and/or the presence or absence of other carbon-carbon double bonds unless explicitly indicated. Other identifiers may be utilized to indicate the presence or absence of particular groups within an alkene. Alkenes may also be further identified by the position of the carbon-carbon double bond. Alkenes, having more than one such multiple bond are alkadienes, alkatrienes, and so forth, and may be further identified by the position of the carbon-carbon double bond.

An “alkenyl group” is a univalent group derived from an alkene by removal of a hydrogen atom from any carbon atom of the alkene. Thus, “alkenyl group” includes groups in which the hydrogen atom is formally removed from a sp² hybridized (olefinic) carbon atom and groups in which the hydrogen atom is formally removed from any other carbon atom. For example, and unless otherwise specified, 1-propenyl (—CH═CHCH₃), 2-propenyl [(CH₃)C═CH₂], and 3-propenyl (—CH₂CH═CH₂) groups are all encompassed with the term “alkenyl group.” Other identifiers may be utilized to indicate the presence or absence of particular groups within an alkene group. Alkene groups may also be further identified by the position of the carbon-carbon double bond. Similarly, a “cycloalkenyl” group is a univalent group derived from a cycloalkene by removal of a hydrogen atom from any carbon atom of the cycloalkene, whether that carbon atom is sp² hybridized (olefinic) or sp³ hybridized carbon atom.

The term “olefin” is used herein in accordance with the definition specified by IUPAC: acyclic and cyclic hydrocarbons having one or more carbon-carbon double bonds apart from the formal ones in aromatic compounds. The class “olefins” subsumes alkenes and cycloalkenes and the corresponding polyenes. Ethylene, propylene, 1-butene, 2-butene, 1-hexene and the like are non-limiting examples of olefins. The term “alpha olefin” as used in this specification and claims refers to an olefin that has a double bond between the first and second carbon atom of the longest contiguous chain of carbon atoms. The term “alpha olefin” includes linear and branched alpha olefins unless expressly stated otherwise.

An “aromatic group” refers to a generalized group formed by removing one or more hydrogen atoms (as necessary for the particular group and at least one of which is an aromatic ring carbon atom) from an aromatic compound. Thus, an “aromatic group” as used herein refers to a group derived by removing one or more hydrogen atoms from an aromatic compound, that is, a compound containing a cyclically conjugated hydrocarbon that follows the Hückel (4n+2) rule and containing (4n+2) pi-electrons, where n is an integer from 1 to about 5. Aromatic compounds and hence “aromatic groups” may be monocyclic or polycyclic unless otherwise specified. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms by trivalent or divalent heteroatoms, in such a way as to maintain the continuous pi-electron system characteristic of aromatic systems and a number of out-of-plane pi-electrons corresponding to the Hückel rule (4n +2)). While arene compounds and heteroarene compounds are mutually exclusive members of the group of aromatic compounds, a compound that has both an arene group and a heteroarene group, that compound is generally considered a heteroarene compound. Aromatic compounds, arenes, and heteroarenes may be mono- or polycyclic unless otherwise specified. Examples of arenes include, but are not limited to, benzene, naphthalene, and toluene, among others. Examples of heteroarenes include, but are not limited to furan, pyridine, and methylpyridine, among others. As disclosed herein, the term “substituted” may be used to describe an aromatic group wherein any non-hydrogen moiety formally replaces a hydrogen in that group, and is intended to be non-limiting.

An arene is an aromatic hydrocarbon, with or without side chains (e.g., benzene, toluene, or xylene, among others). An “aryl group” is a group derived from the formal removal of a hydrogen atom from an aromatic hydrocarbon ring carbon atom from an arene compound. One example of an “aryl group” is phenyl. Another example of an “aryl group” is ortho-tolyl (o-tolyl), the structure of which is shown here.

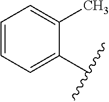 [SMILES: *c1ccccc1C]

The arene can contain a single aromatic hydrocarbon ring (e.g., benzene or toluene), contain fused aromatic rings (e.g., naphthalene or anthracene), and contain one or more isolated aromatic rings covalently linked via a bond (e.g., biphenyl) or non-aromatic hydrocarbon group(s) (e.g., diphenylmethane).

A “heterocyclic compound” is a cyclic compound having at least two different elements as ring member atoms. For example, heterocyclic compounds may comprise rings containing carbon and nitrogen (for example, tetrahydropyrrole), carbon and oxygen (for example, tetrahydrofuran), or carbon and sulfur (for example, tetrahydrothiophene), among others. Heterocyclic compounds and heterocyclic groups may be either aliphatic or aromatic.

An “aralkyl group” is an aryl-substituted alkyl group having a free valance at a non-aromatic carbon atom, for example, a benzyl group and a 2-phenylethyl group are examples of an “aralkyl” group.

A “halide”, also referred to as a “halo” group or a halogen substituent or group has its usual meaning. Examples of halides include fluoride, chloride, bromide, and iodide.

The term “polymer” is used herein generically to include olefin homopolymers, copolymers, terpolymers, and so forth. A copolymer is derived from an olefin monomer and one olefin comonomer, while a terpolymer is derived from an olefin monomer and two olefin comonomers. Accordingly, “polymer” encompasses copolymers, terpolymers, etc., derived from any olefin monomer and comonomer(s) disclosed herein. Similarly, an ethylene polymer would include ethylene homopolymers, ethylene copolymers, ethylene terpolymers, and the like. As an example, an olefin copolymer, such as an ethylene copolymer, can be derived from ethylene and a comonomer, such as 1-butene, 1-hexene, or 1-octene. If the monomer and comonomer were ethylene and 1-hexene, respectively, the resulting polymer could be categorized an as ethylene/1-hexene copolymer.

In like manner, the scope of the term “polymerization” includes homopolymerization, copolymerization, terpolymerization, etc. Therefore, a copolymerization process could involve contacting one olefin monomer (e.g., ethylene) and one olefin comonomer (e.g., 1-hexene) to produce a copolymer.

The term “co-catalyst” is used generally herein to refer to compounds such as organoaluminum compounds, organoboron compounds, organozinc compounds, organomagnesium compounds, organolithium compounds, and the like, that can constitute one component of a catalyst composition, when used, for example, in addition to an activator-support. The term “co-catalyst” is used regardless of the actual function of the compound or any chemical mechanism by which the compound may operate. In one aspect, a co-catalyst can function as an alkylating agent for a metallocene, or a co-catalyst can function to transfer a hydride ligand to the metallocene. Therefore, in an aspect, a co-catalyst can function to provide an activatable ligand (for example, an alkyl or a hydride) to the metallocene, which can engage in olefin polymerization when activated. In this aspect, and while not intending to be bound by theory, it is thought that when the metallocene itself comprises an activatable hydrocarbyl or hydride ligand without being contacting with a co-catalyst, an active catalyst can form without the use of a co-catalyst.

The term “activator”, as used herein, refers generally to a substance that is capable of converting a transition metal component such as a metallocene compound into an active catalyst that can polymerize olefins. In an aspect, the transition metal or metallocene compound can have an activatable ligand which can function as a site for olefin polymerization upon activation. The term “activator” is used regardless of the actual activating mechanism. Illustrative activators include activator-supports, aluminoxanes, organoborate compounds, ionizing ionic compounds, and the like, including combinations thereof.

The terms “solid super acid” or “SSA”, “solid oxide treated with an electron withdrawing anion”, “chemically treated solid oxide”, “treated solid oxide”, “treated solid oxide compound,” and the like, are used herein to indicate a solid, inorganic oxide of relatively high porosity, which can exhibit Lewis acidic or Brønsted acidic behavior, and which has been treated with an electron-withdrawing component such as an anion or anion source, and which is calcined. The catalyst composition component referred to as the “activator-support” comprises, consists of, consists essentially or, or is selected from a solid oxide treated with an electron-withdrawing anion. The electron-withdrawing component is typically an electron-withdrawing anion source compound. Thus, the solid super acid can comprise a calcined contact product of at least one solid oxide with at least one electron-withdrawing anion source compound. Typically, the solid super acid comprises at least one acidic solid oxide compound. The terms “support” and “activator-support” are not used to imply that these components are inert, and such components should not be construed as an inert component of the catalyst composition.

An “organoaluminum compound,” is used to describe any compound that contains an aluminum-carbon bond. Thus, organoaluminum compounds include, but are not limited to, hydrocarbyl aluminum compounds such as trihydrocarbyl-, dihydrocarbyl-, or monohydrocarbylaluminum compounds; hydrocarbylaluminum halide compounds; hydrocarbylalumoxane compounds; and aluminate compounds which contain an aluminum-organyl bond such as tetrakis(p-tolyl)aluminate salts. An “organoboron” compound, an “organozinc compound,” an “organomagnesium compound,” and an “organolithium compound” are used in an analogous fashion to describe any compound that contains a direct metal-carbon bond between an organic group and the recited metal.

The terms “catalyst composition,” “catalyst mixture,” “catalyst system,” and the like, do not depend upon the actual product or composition resulting from the contact or reaction of the initial components of the claimed catalyst composition/mixture/system, the nature of the active catalytic site, or the fate of the co-catalyst, the metallocene compound(s), any olefin monomer used to prepare a precontacted mixture, or the activator (e.g., activator-support), after combining these components. Therefore, the terms “catalyst composition,” “catalyst mixture.” “catalyst system,” and the like, encompass the initial starting components of the composition, as well as whatever product(s) may result from contacting these initial starting components, and this is inclusive of both heterogeneous and homogenous catalyst systems or compositions. The terms “catalyst composition,” “catalyst mixture,” “catalyst system,” and the like, are used interchangeably throughout this disclosure.

The term “contact product” is used herein to describe compositions wherein the components are contacted together in any order, in any manner, and for any length of time. For example, the components can be contacted by blending or mixing. Further, contacting of any component can occur in the presence or absence of any other component of the compositions described herein. Combining additional materials or components can be done by any suitable method. Further, the term “contact product” includes mixtures, blends, solutions, slurries, reaction products, and the like, or combinations thereof. Although “contact product” can include reaction products, it is not required for the respective components to react with one another. Similarly, the term “contacting” is used herein to refer to materials which can be blended, mixed, slurried, dissolved, reacted, allowed to react, treated, or otherwise contacted in some other manner.

Similarly, the term “precontacted” mixture is used herein to describe a first mixture of catalyst components that are contacted for a first period of time prior to the first mixture being used to form a “postcontacted” or second mixture of catalyst components that are contacted for a second period of time.

Although any methods, devices, and materials similar or equivalent to those described herein can be used in the practice or testing of the invention, the typical methods, devices and materials are herein described.

All publications and patents mentioned herein are incorporated herein by reference for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

### Metallocene Compounds and Metallocene-Based Catalyst Compositions

The present disclosure is directed generally to new metallocene compounds, new catalyst systems and catalyst compositions comprising the metallocene compounds, methods for preparing the catalyst compositions, methods for using the catalyst compositions to polymerize olefins, the polymer resins produced using such catalyst compositions, and articles produced using these polymer resins. General experimental procedures and detailed procedures for the metallocene synthesis and polymerization tests are set out in the Examples.

Accordingly, in an aspect this disclosure provides a metallocene compound, having the formula (X¹)(X²)(X³)(X⁴)M¹, wherein: M¹ is (X¹)(X²)(X³)(X⁴)M¹, wherein M¹ is titanium, zirconium, or hafnium; X¹ is a substituted or an unsubstituted cyclopentadienyl ligand, wherein substituents, when present, are selected independently from a C₁-C₂₀ hydrocarbyl group; X² is a substituted or an unsubstituted fluorenyl ligand, wherein substituents, when present, are selected independently from a C₁-C₂₀ hydrocarbyl group; X¹ and X² are bridged by a linking group having the formula >C[C₆H₂R¹R²₂][R³], wherein R¹ is —O(CH₂)ₘCH═CH₂; R² in each occurrence is selected independently from H or a C₁-C₂₀ hydrocarbyl group; R³ is H, a C₁-C₂₀ hydrocarbyl group, or [C₆H₂R⁴R⁵₂]; R⁴ is H, a C₁-C₂₀ hydrocarbyl group, or —O(CH₂)ₙCH═CH₂; R⁵ in each occurrence is selected independently from H or a C₁-C₂₀ hydrocarbyl group; and m and n in each occurrence are selected independently from an integer from 1 to 20; and X³ and X⁴ are independently a monoanionic ligand.

Also disclosed is a catalyst composition for polymerizing olefins, in which the catalyst composition can comprise or can comprise the contact product of: (a) the metallocene having the formula (X¹)(X²)(X³)(X⁴)M¹ as set out immediately above; (b) a metallocene activator or any components thereof; and (c) optionally, a co-catalyst. A process for polymerizing olefins is described in which the process can comprise contacting at least one olefin monomer and a catalyst composition under polymerization conditions to form a polyolefin, wherein the catalyst composition can comprise or can comprise the contact product of: (a) the metallocene having the formula (X¹)(X²)(X³)(X⁴)M¹ as set out immediately above; (b) a metallocene activator or all components thereof necessary to activate the metallocene; and (c) optionally, a co-catalyst. Any metallocene activator can be used in this process. Further, there is also provided a method of making a catalyst composition, the method comprising contacting in any order: (a) the metallocene having the formula (X¹)(X²)(X³)(X⁴)M¹ as set out immediately above; (b) a metallocene activator or any components thereof; and (c) optionally, a co-catalyst.

In the metallocenes of this disclosure, the ligands X³ and X⁴ independently can be a monoanionic ligand. Ligands X³ and X⁴ can include, but are not limited to, a halide, hydride, a C₁-C₂₀ hydrocarbyl group, a C₁-C₂₀ heterohydrocarbyl group, tetrahydroborate, OBR^{A}₂, OSO₂R^{A}, or NR^{A}₂ wherein R^{A} is independently a C₁-C₁₂ hydrocarbyl group. Therefore, X³ and X⁴ can be selected independently from F, Cl, Br, a hydride, a C₁-C₁₂ hydrocarbyl group, a C₁-C₁₂ hydrocarbyloxide group, or an SiR^{D}₃-substituted C₁ to C₁₂ hydrocarbyl group wherein R^{D} is independently a C₁ to C₈ hydrocarbyl group. Most commonly, X³ and X⁴ are selected independently from Cl or Br.

In the metallocenes of this disclosure, X¹ can be a substituted or an unsubstituted cyclopentadienyl ligand, wherein a substituent, when present, is selected independently from a C₁-C₂₀ hydrocarbyl group, and X² can be a substituted or an unsubstituted fluorenyl ligand, wherein a substituent, when present, is selected independently from a C₁-C₂₀ hydrocarbyl group. For example, the substituent on X¹ and the substituent on X², when present, can be selected independently from a C₁ to C₁₅ hydrocarbyl group; a C₁ to C₁₀ hydrocarbyl group, a C₁ to C₈ hydrocarbyl group, or a C₁ to C₆ hydrocarbyl group. In another aspect, the substituent on X¹ and the substituent on X², when present, can be selected independently from a C₁-C₂₀ aliphatic group, a C₆-C₂₀ aromatic group, a C₁-C₁₂ aliphatic group, a C₆-C₁₂ aromatic group, a C₁-C₁₀ aliphatic group, or a C₆-C₁₀ aromatic group, wherein the carbon count includes any hydrocarbyl substituent or branch on the aliphatic group or the aromatic group.

Other examples of independently selected X¹ and X², when present, include a C₁-C₁₂ alkyl, a C₂-C₁₂ alkenyl, a C₃-C₇ cycloalkyl, a C₆-C₁₀ aryl, or a C₇-C₁₂ aralkyl. The C₁-C₂₀ hydrocarbyl group, when present as a substituent on X¹ or X², can be selected independently from methyl, ethyl, i-propyl, n-propyl, t-butyl, n-butyl, n-hexyl, or phenyl. In particular examples, in the metallocene: (a) X¹ can be an unsubstituted cyclopentadienyl and X² can be an unsubstituted fluorenyl; (b) X¹ can be an unsubstituted cyclopentadienyl and X² can be 2,7-di-t-butyl-fluorenyl; (c) X¹ can be a substituted cyclopentadienyl and X² can be an unsubstituted fluorenyl; or (d) X¹ can be a substituted cyclopentadienyl and X² can be 2,7-di-t-butyl-fluorenyl.

The metallocene structures include a linking or bridging group that links the cyclopentadienyl ligand X¹ and the fluorenyl ligand X², wherein the linking group has the formula >C[C₆H₂R¹R²₂][R³], wherein R¹ is —O(CH₂)ₘCH═CH₂; R² in each occurrence is selected independently from H or a C₁-C₂₀ hydrocarbyl group; R³ is H, a C₁-C₂₀ hydrocarbyl group, or [C₆H₂R⁴R⁵₂]; R⁴ is H, a C₁-C₂₀ hydrocarbyl group, or —O(CH₂)ₙCH═CH₂; R⁵ in each occurrence is selected independently from H or a C₁-C₂₀ hydrocarbyl group; and m and n in each occurrence are selected independently from an integer from 1 to 20. In other aspects, n and m can be selected independently from an integer from 1 to 15, alternatively an integer from 1 to 12, alternatively an integer from 1 to 6, alternatively an integer from 1 to 4, or alternatively 1, 2, or 3. The integers n and m can be the same or different. For example, n and m both can be 1, alternatively n and m both can be 2, alternatively n and m both can be 3, alternatively n and m both can be 4, or alternatively n and m both can be 5.

When the bridging group >C[C₆H₂R¹R²₂][R³] is >C[C₆H₂R¹R²₂][C₆H₂R⁴R⁵₂], R¹ can be bonded to the 3-, 4-, or 5-position of the C₆H₂R¹R²₂ group, and independently R⁴ can be bonded to the 3-, 4-, or 5-position of the C₆H₂R⁴R⁵₂ group. It will be appreciated that in the absence of other substituents or when a single substituent occupies the 4-position, the 3- and 5-positions of the aryl ring are equivalent. Further, R¹ and the independently selected R² groups can be bonded to and distributed among the 3-, 4-, and 5-positions of the C₆H₂R¹R²₂ moiety, and independently, R⁴ and the independently selected R⁵ groups can be bonded to and distributed among the 3-, 4-, and 5-positions of the C₆H₂R⁴R⁵₂ moiety.

According to further aspects of the disclosure, when the bridging group is >C[C₆H₂R¹R²₂][C₆H₂R⁴R⁵₂]:
(a) R¹ can be bonded to the 4-position and the independently selected R² groups can be bonded to and distributed between the 3- and 5-positions of the C₆H₂R¹R²₂ moiety; and
R⁴ can be bonded to the 4-position and the independently selected R⁵ groups can be bonded to and distributed between the 3- and 5-positions of the C₆H₂R⁴R⁵₂ moiety;
(b) R¹ can be bonded to the 3-position and the independently selected R² groups can be bonded to and distributed between the 4- and 5-positions of the C₆H₂R¹R²₂ moiety; and
R⁴ can be bonded to the 3-position and the independently selected R⁵ groups can be bonded to and distributed between the 4- and 5-positions of the C₆H₂R⁴R⁵₂ moiety;
(c) R¹ can be bonded to the 4-position and the independently selected R² groups can be bonded to and distributed between the 3- and 5-positions of the C₆H₂R¹R²₂ moiety; and
R⁴ can be bonded to the 3-position and the independently selected R⁵ groups can be bonded to and distributed between the 4- and 5-positions of the C₆H₂R⁴R⁵₂ moiety;
   or
(d) R¹ can be bonded to the 3-position and the independently selected R² groups can be bonded to and distributed between the 4- and 5-positions of the C₆H₂R¹R²₂ moiety; and
R⁴ can be bonded to the 4-position and the independently selected R⁵ groups can be bonded to and distributed between the 3- and 5-positions of the C₆H₂R⁴R⁵₂ moiety;

In further aspects, the R¹ and R⁴ groups bonded to the aryl group can be situated, independently, either meta or para to the carbon bond to the bridging carbon, that is, either in the 3- or 4-position of the aryl group bonded to the bridging carbon atom. In embodiments, R¹ can be bonded to the 4-position of the C₆H₂R¹R²₂ group and R⁴ is bonded to the 4-position of the C₆H₂R⁴R⁵₂ group. Therefore, in this aspect, the linking group can have the formula: >C[C₆H₄-p-R¹][C₆H₄-p-R⁴]; >C[C₆H₄-p-R¹][C₆H₄-m-R⁴]; >C[C₆H₄-m-R¹][C₆H₄-m-R⁴]; or >C[C₆H₄-m-R¹][C₆H₄-p-R⁴]. These four bridging group structures therefore include the bridging groups >C[C₆H₄-p-R¹][C₆H₅] and >C[C₆H₄-m-R¹][C₆H₅], when R⁴ is H. Examples of R¹ and R⁴ also include a group selected independently from OCH₂CH═CH₂, O(CH₂)₂CH═CH₂, O(CH₂)₃CH═CH₂, O(CH₂)₄CH═CH₂, O(CH₂)₅CH═CH₂, or O(CH₂)₆CH═CH₂. In other aspects and embodiments, when the bridging group >C[C₆H₂R¹R²₂][R³] is >C[C₆H₂R¹R²₂][C₆H₂R⁴R⁵₂], R⁴ and R⁵ in each occurrence can be H. In the linking group substituents [C₆H₂R¹R²₂] and when present, [C₆H₂R⁴R⁵₂], R² and R⁵ in each occurrence can be selected independently from H, methyl, ethyl, i-propyl, n-propyl, t-butyl, n-butyl, n-hexyl, or phenyl.

In other aspects, the metallocene compound can have the formula:

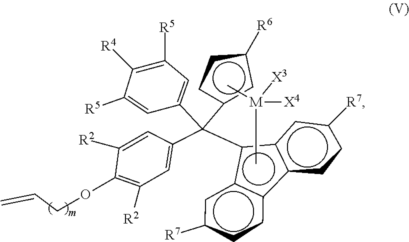

wherein
M is Zr or Hf;
X³ and X⁴ are both Cl or both Br;
R⁴ is H or —O(CH₂)·CH═CH₂;
R², R⁵, and R⁶ in each occurrence are selected independently from H, methyl, ethyl, n-propyl, i-propyl, or t-butyl;
R⁷ is H, methyl, or t-butyl; and
m and n are selected independently from 1, 2, 3, 4, 5, 6, 7, or 8.

In other aspects, the metallocene compound may have the formula:

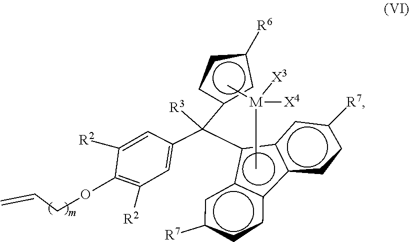

wherein
M is Zr or Hf;
X³ and X⁴ are both Cl or both Br;
R² in each occurrence, R³, and R⁶ are selected independently from H, methyl, ethyl, n-propyl, i-propyl, t-butyl, or phenyl;
R⁷ is H, methyl, or t-butyl; and
m is selected from 1, 2, 3, 4, 5, 6, 7, or 8.

In yet another aspect, the metallocene compound may have the formula:

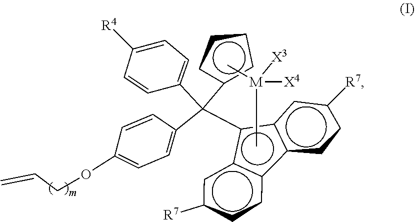

wherein
M is Zr or Hf;
X³ and X⁴ are both Cl or both Br;
R⁴ is H or —O(CH₂)ₙCH═CH₂;
R⁷ is H, methyl, or t-butyl; and
m and n are selected independently from 1, 2, 3, 4, 5, 6, 7, or 8.

In further embodiments or aspects, the metallocene compound may have the formula:

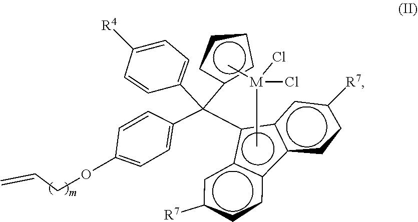

wherein
M is Zr or Hf;
R⁴ is H or —O(CH₂)·CH═CH₂;
R⁷ is H or t-butyl; and
m and n are selected independently from 1, 2, 3, 4, 5, or 6.

The metallocene compound also may have the formula:

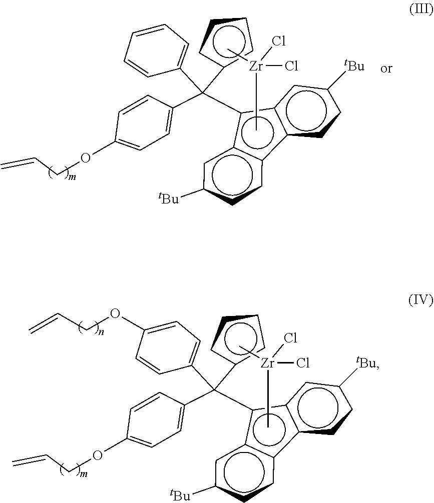

wherein m and n are selected independently from 1, 2, 3, 4, or 5.

Examples of the metallocene compounds of this disclosure include compounds having the formula:

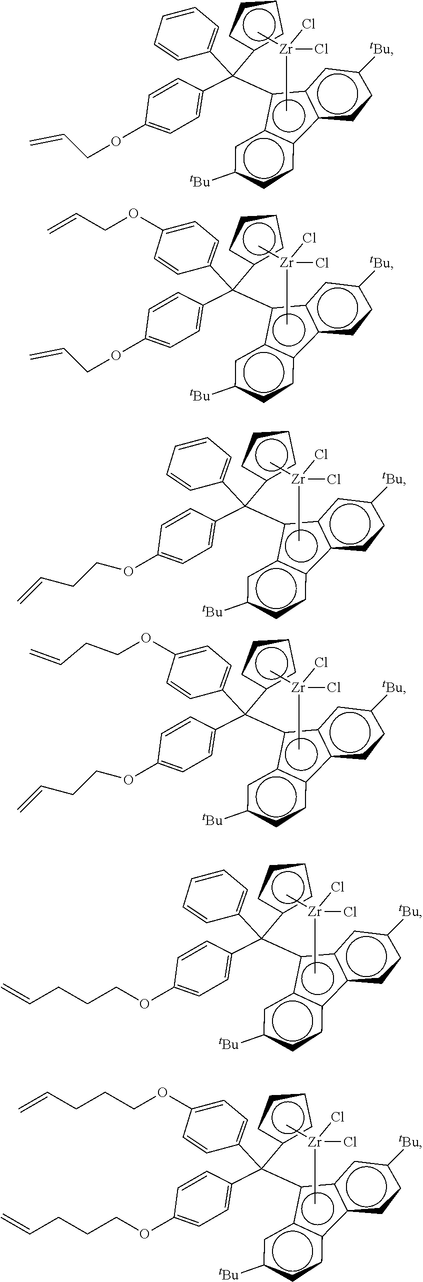

or any combination thereof.

It is also noted that in the catalyst composition described herein, the catalyst composition can include more than one metallocene, and the process for polymerizing olefins can be carried out using more than one metallocene. By “more than one” metallocene, it is intended to reflect that any additional, for example a “second” metallocene, can be selected from another metallocene as those metallocene compounds disclosed herein, or the additional metallocene(s) can be selected from a metallocene that is not encompassed by the structures presented herein. The catalyst composition also can be absent any other (e.g., second) metallocene compound, and the contacting step in the process for polymerizing olefins can be absent any other (e.g., second) metallocene compound.

### Metallocene Activators

Solid Super Acids. In addition to the metallocenes described herein, the catalyst composition can also include a metallocene activator. The term “metallocene activator” is used herein to refer to a substance that is capable of converting a metallocene compound into an active catalyst that can polymerize olefins. In an aspect, the transition metal or metallocene compound can have an activatable ligand which can function as a site for olefin polymerization upon activation. The term “activator” can include multiple components, for example the SSA activator-supports are referred to as “activators” and the organoaluminum compounds used in conjunction with the SSA activator-supports may also be referred to as a component of the activator. the organoaluminum compounds are also referred to as co-catalysts in this disclosure. Thus, the term “activator” is used regardless of the actual activating mechanism.

In embodiments, the metallocene activator can comprise, consist essentially of, consist of, or be selected from an activator-support comprising a solid oxide treated with an electron-withdrawing anion (“SSA”, or solid super-acid), an organoboron compound, an organoborate compound, an ionizing ionic compound, an aluminoxane compound, or any combination thereof. Illustrative activators include other activator-supports and other components such as alkylating agents, organoaluminum compounds and the like that are used to convert the metallocene compound into an active polymerization catalyst.

In an aspect, the metallocene activator can comprise, consist essentially of, consist of, or be selected from a solid oxide treated with an electron-withdrawing anion. These materials are also referred to herein as an “SSA”, which means a solid super-acid. In these solid oxides treated with an electron-withdrawing anion (SSAs), in embodiments, the solid oxide can comprise or can be selected from Al₂O₃, B₂O₃, BeO, Bi₂O₃, CdO, Co₃O₄, Cr₂O₃, CuO, Fe₂O₃, Ga₂O₃, La₂O₃, Mn₂O₃, MoO₃, Na₂O, NiO, P₂O₅, Sb₂O₅, SiO₂, SnO₂, SrO, ThO₂, TiO₂, V₂O₅, WO₃, Y₂O₃, ZnO, ZrO₂, K₂O, CaO, Ce₂O₃, mixtures thereof, mixed oxides thereof, and any combinations thereof.

In another aspect, for example, the solid oxide of the SSA can comprise or can be selected from silica, alumina, titania, zirconia, magnesia, boria, calcia, zinc oxide, silica-alumina, silica-coated alumina, silica-titania, silica-zirconia, silica-magnesia, alumina-titania, alumina-zirconia, zinc-aluminate, alumina-boria, silica-boria, aluminum phosphate, aluminophosphate, aluminophosphate-silica, magnesium aluminate, titania-zirconia, mullite, boehmite, heteropolytungstates, mixed oxides thereof, a pillared clay such as a pillared montmorillonite, or any combination thereof. In a further aspect, for example, the electron-withdrawing anion of the SSA can comprise or be selected from fluoride, chloride, bromide, iodide, sulfate, bisulfate, fluorosulfate, phosphate, fluorophosphate, triflate, mesylate, tosylate, thiosulfate, C₁-C₁₀ alkyl sulfonate, C₆-C₁₄ aryl sulfonate, trifluoroacetate, fluoroborate, fluorozirconate, fluorotitanate, or any combination thereof.

The solid oxide treated with an electron-withdrawing anion also can comprise at least one solid oxide treated with at least two electron-withdrawing anions, and wherein the at least two electron-withdrawing anions comprise or are selected from fluoride and phosphate, fluoride and sulfate, chloride and phosphate, chloride and sulfate, triflate and sulfate, or triflate and phosphate.

In aspects, the solid oxide treated with an electron-withdrawing anion (SSA) can be generated by treatment of a solid oxide with sulfuric acid, sulfate ion, bisulfate ion, fluorosulfuric acid, fluorosulfate ion, phosphoric acid, phosphate ion, fluorophosphoric acid, monofluorophosphate ion, triflic (trifluoromethanesulfonic) acid, triflate trifluoromethanesulfonate) ion, methanesulfonic acid, mesylate (methanesulfonate) ion, toluenesulfonic acid, tosylate (toluenesulfonate) ion, thiosulfate ion, C₁-C₁₀ alkyl sulfonic acid, C₁-C₁₀ alkyl sulfonate ion, C₆-C₁₄ aryl sulfonic acid, C₆-C₁₄ aryl sulfonate ion, fluoride ion, chloride ion, or any combination thereof.

In examples of the SSA materials, the solid oxide treated with an electron-withdrawing anion can comprise a sulfated solid oxide, bisulfated (hydrogen sulfated) solid oxide, fluorosulfated solid oxide, phosphated solid oxide, fluorophosphated solid oxide, fluoride solid oxide, or chloride solid oxide. For example, the solid oxide treated with an electron-withdrawing anion can comprise or be selected from a fluorided solid oxide, a sulfated solid oxide or a phosphated solid oxide.

The solid oxide treated with an electron-withdrawing anion also can comprise or be selected from fluorided alumina, chlorided alumina, bromided alumina, sulfated alumina, phosphated alumina, fluorided silica-alumina, chlorided silica-alumina, bromided silica-alumina, sulfated silica-alumina, phosphated silica-alumina, fluorided silica-zirconia, chlorided silica-zirconia, bromided silica-zirconia, sulfated silica-zirconia, phosphated silica-zirconia, fluorided mullite, chlorided mullite, bromided mullite, sulfated mullite, phosphated mullite, fluorided silica-coated alumina, chlorided silica-coated alumina, bromided silica-coated alumina, sulfated silica-coated alumina, phosphated silica-coated alumina, or any combination thereof.

In embodiments of the SSA activator-support, the solid oxide can comprise, consist essentially of, consist of, or be selected from silica, alumina, silica-alumina, silica-coated alumina, mullite, aluminum phosphate, aluminophosphate, heteropolytungstate, titania, zirconia, magnesia, boria, zinc oxide, a mixed oxide thereof, or any mixture thereof; and (b) the electron-withdrawing anion can comprise, consist essentially of, consist of, or be selected from sulfate, bisulfate, fluorosulfate, phosphate, fluorophosphates, fluoride, or chloride.

In one aspect of this disclosure, the solid oxide material is chemically treated by contacting it with at least one electron-withdrawing component, typically an electron-withdrawing anion source. Further, the solid oxide material can be chemically treated with a metal ion if desired, then calcining to form a metal-containing or metal-impregnated solid super acid. Alternatively, a solid oxide material and an electron-withdrawing anion source are contacted and calcined simultaneously. The method by which the oxide is contacted with an electron-withdrawing component, typically a salt or an acid of an electron-withdrawing anion, includes, but is not limited to, gelling, co-gelling, impregnation of one compound onto another, and the like. Typically, following any contacting method, the contacted mixture of oxide compound, electron-withdrawing anion, and the metal ion if present can be calcined. The electron-withdrawing component used to treat the oxide is any component that increases the Lewis or Brønsted acidity of the solid oxide upon treatment. In one aspect, the electron-withdrawing component is an electron-withdrawing anion derived from a salt, an acid, or other compound such as a volatile organic compound that may serve as a source or precursor for that anion.

When the electron-withdrawing component can comprise a salt of an electron-withdrawing anion, the counterion or cation of that salt may be selected from any cation that allows the salt to revert or decompose back to the acid during calcining. Factors that dictate the suitability of the particular salt to serve as a source for the electron-withdrawing anion include, but are not limited to, the solubility of the salt in the desired solvent, the lack of adverse reactivity of the cation, ion-pairing effects between the cation and anion, hygroscopic properties imparted to the salt by the cation, and the like, and thermal stability of the anion. Examples of suitable cations in the salt of the electron-withdrawing anion include, but are not limited to, ammonium, trialkyl ammonium, tetraalkyl ammonium, tetraalkyl phosphonium, H⁺, [H(OEt₂)₂]⁺, and the like; alternatively, ammonium; alternatively, trialkyl ammonium; alternatively, tetraalkyl ammonium; alternatively, tetraalkyl phosphonium; or alternatively, H⁺, [H(OEt₂)₂]⁺.

Specific examples of solid super acids include but are not limited to: (a) the solid oxide comprises, consists essentially of, or is selected from alumina, silica-alumina, silica-coated alumina, silica-zirconia, mullite, or a mixture thereof, and (b) the electron-withdrawing anion comprises, consists essentially of, or is selected from fluoride, chloride, sulfate, or phosphate. In aspects, the electron-withdrawing anion can comprise or be selected from a sulfur oxoacid anion-modified solid oxide generated by sulfuric acid treatment or sulfate ion treatment. In other aspects, the electron-withdrawing anion can comprise or be selected from a phosphorus oxoacid anion-modified solid oxide generated by phosphoric acid treatment or phosphate ion treatment.

This aspect of the disclosure is well understood by the person of ordinary skill. In aspects, the solid oxide treated with an electron-withdrawing anion is any solid oxide or any combination of solid oxides disclosed herein, treated with any electron-withdrawing anion or any combination of electron-withdrawing anions disclosed herein. The solid oxide treated with an electron-withdrawing anion can be produced by a process comprising contacting any suitable solid oxide and any suitable solid oxide with an electron-withdrawing anion to provide a mixture, and concurrently and/or subsequently drying and/or calcining the mixture.

In a further aspect of embodiment of the catalyst composition of this disclosure, the solid oxide itself used to prepare the SSA, and the SSA once prepared, can be characterized as follows:
(a) the solid oxide component used to prepare the solid oxide treated with an electron-withdrawing anion, that is, the solid oxide prior to treatment with the electron-withdrawing anion, can have the following properties:
   (i) a surface area from about 100 m²/g to about 1000 m²/g, from about 200 to about 800 m²/g, or from about 250 to about 600 m²/g;
   (ii) a pore volume from about 0.1 mL/g to about 3.0 mL/g, from about 0.25 mL/g to about 2.5 mL/g; or from about 0.4 mL/g to about 2.0 mL/g, or from about 0.5 mL/g to about 1.7 mL/g, greater than about 0.1 mL/g, greater than about 0.5 mL/g, or greater than about 1.0 mL/g;
   (iii) an average particle size from about 1 micron to about 250 microns, from about 2 microns to about 200 microns, from about 5 microns to about 150 microns, or from about 10 to about 100 microns; or
   (iv) any combination of (i), (ii), and (iii);

or
(b) the solid oxide treated with an electron-withdrawing anion can have the following properties:
   (i) a surface area from about 100 m²/g to about 1000 m²/g, from about 200 to about 800 m²/g, or from about 250 to about 600 m²/g;
   (ii) a pore volume from about 0.1 mL/g to about 3.0 mL/g, from about 0.25 mL/g to about 2.5 mL/g; or from about 0.4 mL/g to about 2.0 mL/g, or from about 0.5 mL/g to about 1.7 mL/g, greater than about 0.1 mL/g, greater than about 0.5 mL/g, or greater than about 1.0 mL/g;
   (iii) an average particle size from about 1 micron to about 250 microns, from about 2 microns to about 200 microns, from about 5 microns to about 150 microns, or from about 10 to about 100 microns; or
   (iv) any combination of (i), (ii), and (iii).

The solid oxide treated with an electron-withdrawing anion can have a surface area from about 150 m²/g to about 700 m²/g. The solid oxide treated with an electron-withdrawing anion also may have a pore volume from about 0.5 mL/g to about 2.5 mL/g. Further, the solid oxide treated with an electron-withdrawing anion can have an average particle size (d50) from about 20 microns to about 100 microns.

Various SSA activator-supports and processes to prepare these SSA activator-supports have been reported, for example in U.S. Pat. Nos. 6,107,230, 6,165,929, 6,294,494, 6,300,271, 6,316,553, 6,355,594, 6,376,415, 6,391,816, 6,395,666, 6,524,987, 6,548,441, 6,750,302, 6,831,141, 6,936,667, 6,992,032, 7,601,665, 7,026,494, 7,148,298, 7,470,758, 7,517,939, 7,576,163, 7,294,599, 7,629,284, 7,501,372, 7,041,617, 7,226,886, 7,199,073, 7,312,283, 7,619,047, and U.S. Patent Appl. Publ. No. 2010/0076167, each of which is incorporated by reference herein.

### Aluminoxane Compounds

While the use of a combination of SSA and an organoaluminum compound work well for activating the metallocene described herein, other activators also work well. For example, the metallocene activator comprises or further comprises an aluminoxane compound, an organoboron or organoborate compound, an ionizing ionic compound, or combinations thereof. In embodiments, the metallocene activator can comprise or can be selected from an aluminoxane compound, and the preparing the catalyst composition further comprises contacting in any order an aluminoxane compound with the other recited components including the metallocene.

In a further aspect of any embodiment provided here, the catalyst composition can comprise, either in combination with the solid super acid or any other activators(s) or alone, at least one aluminoxane. In a further aspect, the catalyst compositions and polymerization processes disclosed herein may be absent an aluminoxane. Aluminoxanes are also referred to as poly(hydrocarbyl aluminum oxides), organoaluminoxanes, or alumoxanes.

Aluminoxane compounds that can be used in the catalyst composition of this disclosure include, but are not limited to, oligomeric compounds. The oligomeric aluminoxane compounds can comprise linear structures, cyclic, or cage structures, or mixtures of all three. Oligomeric aluminoxanes, whether oligomeric or polymeric compounds, have the repeating unit formula:

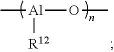

wherein R¹² is a linear or branched alkyl having from 1 to 10 carbon atoms, and n is an integer from 3 to about 10 are encompassed by this disclosure. Linear aluminoxanes having the formula:

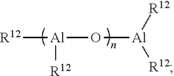

wherein R¹² is a linear or branched alkyl having from 1 to 10 carbon atoms, and n is an integer from 1 to about 50, are also encompassed by this disclosure.

Further, aluminoxanes may also have cage structures of the formula R^{t}_{5m+α}R^{b}_{m-α}Al₄ₘO₃ₘ, wherein m is 3 or 4 and α is =n_{Al(3)}−n_{O(2)}+n_{O(4)}; wherein n_{Al(3)} is the number of three coordinate aluminum atoms, n_{O(2)} is the number of two coordinate oxygen atoms, n_{O(4)} is the number of 4 coordinate oxygen atoms, R^{t} represents a terminal alkyl group, and R^{b} represents a bridging alkyl group; wherein R is a linear or branched alkyl having from 1 to 10 carbon atoms.

Aluminoxanes that can serve as activators in this disclosure are generally represented by formulas such as (R¹²—Al—O)ₙ, R¹²(R¹²—Al—O)ₙAl(R¹²)₂, and the like, wherein the R¹² group is typically a linear or branched C₁-C₆ alkyl such as methyl, ethyl, propyl, butyl, pentyl, or hexyl wherein n typically represents an integer from 1 to about 50. In one embodiment, the aluminoxane compounds of this disclosure include, but are not limited to, methylaluminoxane (MAO), ethylaluminoxane, modified methylaluminoxane (MMAO) such as an isobutyl-modified methyl aluminoxane, n-propylaluminoxane, iso-propylaluminoxane, n-butylaluminoxane, t-butylaluminoxane, sec-butylaluminoxane, iso-butylaluminoxane, t-butyl aluminoxane, 1-pentylaluminoxane, 2-pentylaluminoxane, 3-pentylaluminoxane, iso-pentyl-aluminoxane, neopentylaluminoxane, or combinations thereof.

While organoaluminoxanes with different types of “R” groups such as R¹² are encompassed by the present disclosure, methyl aluminoxane (MAO), ethyl aluminoxane, or isobutyl aluminoxane are typical aluminoxane activators used in the catalyst compositions of this disclosure. These aluminoxanes are prepared from trimethylaluminum, triethylaluminum, or triisobutylaluminum, respectively, and are sometimes referred to as poly(methylaluminum oxide), poly(ethylaluminum oxide), and poly(isobutylaluminum oxide), respectively. It is also within the scope of the disclosure to use an aluminoxane in combination with a trialkylaluminum, such as disclosed in U.S. Pat. No. 4,794,096, which is herein incorporated by reference in its entirety.

The present disclosure contemplates many values of n in the aluminoxane formulas (R¹²—Al—O)ₙ and R¹²(R¹²—Al—O)ₙAl(R¹²)₂, and preferably n is at least about 3. However, depending upon how the organoaluminoxane is prepared, stored, and used, the value of n may be variable within a single sample of aluminoxane, and such a combination of organoaluminoxanes are comprised in the methods and compositions of the present disclosure.

Organoaluminoxanes can be prepared by various procedures which are well known in the art. Examples of organoaluminoxane preparations are disclosed in U.S. Pat. Nos. 3,242,099 and 4,808,561, each of which is incorporated by reference herein, in its entirety. One example of how an aluminoxane may be prepared is as follows. Water which is dissolved in an inert organic solvent may be reacted with an aluminum alkyl compound such as AlR₃ to form the desired organoaluminoxane compound. While not intending to be bound by this statement, it is believed that this synthetic method can afford a mixture of both linear and cyclic (R—Al—O)ₙ aluminoxane species, both of which are encompassed by this disclosure. Alternatively, organoaluminoxanes may be prepared by reacting an aluminum alkyl compound such as AlR₃ with a hydrated salt, such as hydrated copper sulfate, in an inert organic solvent.

The other catalyst components may be contacted with the aluminoxane in a saturated hydrocarbon compound solvent, though any solvent which is substantially inert to the reactants, intermediates, and products of the activation step can be used. The catalyst composition formed in this manner may be collected by methods known to those of skill in the art, including but not limited to filtration, or the catalyst composition may be introduced into the oligomerization reactor without being isolated.

### Organoboron and Organoborate Compounds

In a further aspect of any embodiment provided here, the catalyst composition can comprise, either in combination with the solid super acid or any other activators(s) or alone, at least one organoboron, borate, or organoborate compound as an activator. The catalyst compositions and polymerization processes disclosed herein also may be absent an organoboron, a borate, or an organoborate compound.

Organoboron compounds that can be used in the catalyst composition of this disclosure are varied. In one aspect, the organoboron compound can comprise neutral boron compounds, borate salts, or combinations thereof. For example, the organoboron compounds of this disclosure can comprise a fluoroorgano boron compound, a fluoroorgano borate compound, or a combination thereof. Any fluoroorgano boron or fluoroorgano borate compound known in the art can be utilized. The term fluoroorgano boron compound has its usual meaning to refer to neutral compounds of the form BY₃. The term fluoroorgano borate compound also has its usual meaning to refer to the monoanionic salts of a fluoroorgano boron compound of the form [cation]⁺[BY₄]⁻, where Y represents a fluorinated organic group. For convenience, fluoroorgano boron and fluoroorgano borate compounds are typically referred to collectively by organoboron compounds, or by either name as the context requires.

Examples of fluoroorgano borate compounds that can be used as activators in the present disclosure include, but are not limited to, fluorinated aryl borates such as, N,N-dimethylanilinium tetrakis(pentafluorophenyl)borate, triphenylcarbenium tetrakis(pentafluorophenyl)borate, lithium tetrakis(pentafluorophenyl)borate, N,N-dimethylanilinium tetrakis[3,5-bis(trifluoromethyl)phenyl]borate, triphenylcarbenium tetrakis[3,5-bis(trifluoromethyl)phenyl]borate, and the like, including mixtures thereof; alternatively, N,N-dimethylanilinium tetrakis(pentafluorophenyl)borate; alternatively, triphenylcarbenium tetrakis(pentafluorophenyl)borate; alternatively, lithium tetrakis-(pentafluorophenyl)borate; alternatively, N,N-dimethylanilinium tetrakis[3,5-bis(trifluoro-methyl)phenyl]borate; or alternatively, triphenylcarbenium tetrakis[3,5-bis(trifluoromethyl)-phenyl]borate. Examples of fluoroorgano boron compounds that can be used as activators in the present disclosure include, but are not limited to, tris(pentafluorophenyl)boron, tris[3,5-bis(trifluoromethyl)phenyl]boron, and the like, including mixtures thereof.

Although not intending to be bound by the following theory, these examples of fluoroorgano borate and fluoroorgano boron compounds, and related compounds, are thought to form “weakly-coordinating” anions when combined with organometal compounds, as disclosed in U.S. Pat. No. 5,919,983, which is incorporated herein by reference in its entirety. Other examples of suitable organoboron and/or organoborate compounds and how they can be used as metallocene activators are provided in U.S. Pat. Nos. 5,576,259, 5,807,938, 11,186,665, and 11,325,938, each of which is incorporated herein by reference.

### Ionizing Ionic Compounds

In a further aspect of any embodiment provided here, the catalyst composition can comprise, either in combination with the solid super acid or any other activators(s) or alone, at least one ionizing ionic compound. The catalyst compositions and polymerization processes disclosed herein also may be absent an ionizing ionic compound.

An ionizing ionic compound is an ionic compound which can function to enhance the activity of the catalyst composition. While not bound by theory, it is believed that the ionizing ionic compound may be capable of reacting with the metallocene compound and converting it into a cationic metallocene compound or a metallocene compound that is an incipient cation. Again, while not intending to be bound by theory, it is believed that the ionizing ionic compound may function as an ionizing compound by at least partially extracting an anionic ligand such as a chloride or alkoxide from the metallocene compound(s). However, the ionizing ionic compound is an activator regardless of whether it is ionizes the metallocene compound(s), abstracts an anionic ligand in a fashion as to form an ion pair, weakens the metal-anionic ligand bond in the metallocene compound, simply coordinates to anionic ligand, or any other mechanism by which activation may occur.

Further, it is not necessary that the ionizing ionic compound activate the metallocene compounds only. The activation function of the ionizing ionic compound is evident in the enhanced activity of catalyst composition as a whole, as compared to a catalyst composition that does not comprise any ionizing ionic compound. It is also not necessary that the ionizing ionic compound activate different metallocene compounds to the same extent.

In one aspect and in any embodiment disclosed herein, the ionizing ionic compound can have the formula:

[Q]⁺[M⁶Z₄]⁻.

In embodiments, Q can be selected from [NR^{A}R^{B}R^{C}R^{D}]⁺, [CR^{E}R^{F}R^{G}]⁺, [C₇H₇]⁺, Li⁺, Na⁺, and K⁺; alternatively, [NR^{A}R^{B}R^{C}R^{D}]⁺; alternatively, [CR^{E}R^{F}R^{G}]⁺; alternatively, [C₇H₇]⁺; alternatively, Li⁺; alternatively, Na⁺; alternatively, K⁺. In an embodiment, R^{A}, R^{B}, and R^{C} are each selected independently from hydrogen, and a C₁ to C₂₀ hydrocarbyl; alternatively, hydrogen and a C₁ to C₁₀ hydrocarbyl; alternatively, hydrogen and a C₆ to C₂₀ aryl; alternatively, hydrogen and a C₆ to C₁₀ aryl; alternatively, hydrogen and a C₁ to C₂₀ alkyl; alternatively, hydrogen and a C₁ to C₁₀ alkyl; or alternatively, hydrogen and a C₁ to C₅ alkyl. In an embodiment, R^{D} is selected from hydrogen, a halide, and a C₁ to C₂₀ hydrocarbyl; alternatively, hydrogen, a halide, and a C₁ to C₁₀ hydrocarbyl; alternatively, hydrogen, a halide, and a C₆ to C₂₀ aryl; alternatively, hydrogen, a halide, and a C₆ to C₁₀ aryl; alternatively, hydrogen, a halide, and a C₁ to C₂₀ alkyl; alternatively, hydrogen, a halide, and a C₁ to C₁₀ alkyl; or alternatively, hydrogen, a halide, and a C₁ to C₅ alkyl. In an embodiment, R^{E}, R^{F}, and R^{G} are each selected independently from hydrogen, a halide, and a C₁ to C₂₀ hydrocarbyl; alternatively, hydrogen, a halide, and a C₁ to C₁₀ hydrocarbyl; alternatively, hydrogen, a halide, and a C₆ to C₂₀ aryl; or alternatively, hydrogen, a halide, and a C₆ to C₁₀ aryl. In some embodiments, Q may be a trialkyl ammonium or a dialkylarylamine (e.g., dimethyl anilinium); alternatively, triphenylcarbenium or substituted triphenyl carbenium; alternatively, tropylium or a substituted tropylium; alternatively, a trialkyl ammonium; alternatively, a dialkylarylamine (e.g., dimethyl anilinium) alternatively, a triphenylcarbenium; or alternatively, tropylium. In other embodiments, Q may be tri(n-butyl) ammonium, N,N-dimethylanilinium, triphenylcarbenium, tropylium, lithium, sodium, and potassium; alternatively, tri(n-butyl) ammonium and N,N-dimethylanilinium; alternatively, triphenylcarbenium, tropylium; or alternatively, lithium, sodium and potassium. In an embodiment, M⁶ is B or Al; alternatively, B; or alternatively, Al. In an embodiment, Z is selected independently from halide and

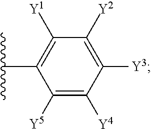

alternatively, halide; or alternatively,

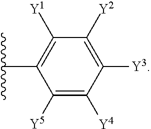

In an embodiment, Y¹, Y², Y³, Y⁴, and Y⁵ are each selected independently from hydrogen, a halide, a C₁ to C₂₀ hydrocarbyl, a C₁ to C₂₀ hydrocarboxy; alternatively, hydrogen, a halide, a C₁ to C₁₀ hydrocarbyl, a C₁ to C₁₀ hydrocarboxide; alternatively, hydrogen, a halide, a C₆ to C₂₀ aryl, a C₁ to C₂₀ alkyl, a C₆ to C₂₀ aryloxide, a C₁ to C₂₀ alkoxide; alternatively, hydrogen, a halide, a C₆ to C₁₀ aryl, a C₁ to C₁₀ alkyl, a C₆ to C₁₀ aryloxide, a C₁ to C₁₀ alkoxide; or alternatively, hydrogen, a halide, a C₁ to C₅ alkyl, a C₁ to C₅ alkoxide. In some embodiments, Y¹, Y², Y³, Y⁴, and Y⁵ may be selected independently from phenyl, p-tolyl, m-tolyl, 2,4-dimethylphenyl, 3,5-dimethylphenyl, pentafluorophenyl, and 3,5-bis(trifluoromethyl)phenyl; alternatively, phenyl; alternatively, p-tolyl; alternatively, m-tolyl; alternatively, 2,4-dimethylphenyl; alternatively, 3,5-dimethylphenyl; alternatively, pentafluorophenyl; or alternatively, 3,5-bis(trifluoromethyl)phenyl. In some embodiments, any hydrocarbyl, aryl, alkyl, hydrocarboxide, aryloxide, or alkoxide can be substituted by one or more halide, C₁ to C₅ alkyl, halide-substituted C₁ to C₅ alkyl, C₁ to C₅ alkoxide, or halide-substituted C₁ to C₅ alkoxide group. Particular halide, hydrocarbyl, aryl, alkyl, hydrocarboxide, and alkoxide are described herein and may be utilized without limitation to provide particular ionizing ionic compound having the formula [Q]⁺[M⁶Z₄]⁻.

Examples of ionizing ionic compound and how they can be used with the present metallocenes as activators are disclosed in U.S. Pat. Nos. 5,576,259, 5,807,938, 11,186,665, and 11,325,938, each of which is incorporated herein by reference, in its entirety.

### Co-Catalysts

In another aspect, the catalyst compositions disclosed here can comprise a co-catalyst, the catalyst compositions can further comprise the contact product of a co-catalyst with the additional catalyst compositions components, or the method of making the catalyst composition can further comprise contacting in any order a co-catalyst and the additional catalyst compositions components.

One aspect of this disclosure provides a catalyst composition and a process for producing an olefin polymer composition, in which the catalyst composition and process can utilize a co-catalyst. In some aspects, the co-catalyst can be optional. While not intending to be bound by theory, some co-catalysts may function as alkylating agents for the metallocene and it is thought that in some embodiments, for example when a metallocene comprises a ligand such as an alkyl ligand, a co-catalyst may not be required. That is, when the contact product of the metallocene and an activator can initiate olefin polymerization without any further alkylation or treatment of the metallocene. However, even in cases in which polymerization activity can be initiated without the addition of a co-catalyst as a component of the catalyst composition, it may be desirable to include a co-catalyst in the catalyst composition.

When parameters such as molar ratios are disclosed, for example when referring to the molar ratio of any co-catalyst or combination of co-catalysts to the metallocene compound, the molar ratios are intended to reflect the total moles of the metallocene compound or metallocene compounds.

One aspect of this disclosure provides for a catalyst composition for polymerizing olefins and a process for polymerizing olefins using a catalyst composition, comprising contacting at least one olefin and a catalyst composition, wherein the catalyst composition can comprise a metallocene compound and optionally a co-catalyst. In any embodiment provided here, the catalyst composition can further comprise an activator, such as a solid oxide treated with an electron-withdrawing anion, an organoboron compound, an organoborate compound, an ionizing ionic compound, an aluminoxane compound, or any combination thereof.

In an aspect, for example, the co-catalyst can comprise, consist of, consist essentially or, or can be selected from an organoaluminum compound, an organoboron compound, an organozinc compound, an organomagnesium compound, an organolithium compound, or any combination thereof. In another aspect, the co-catalyst can comprise or can be selected from an organoaluminum compound, an organozinc compound, an organomagnesium compound, an organolithium compound, or any combination thereof. Examples of co-catalysts include, but are not limited to:
(a) M³(X¹⁰)ₙ(X¹¹)₃₋ₙ, wherein M³ is boron or aluminum and n is from 1 to 3 inclusive;
(b) M⁴(X¹⁰)ₙ(X¹¹)₂₋ₙ, wherein M⁴ is magnesium or zinc and n is from 1 to 2 inclusive; and/or
(c) M⁵X¹⁰, wherein M⁵ is Li;

wherein
(i) X¹⁰ is independently hydride or a C₁ to C₂₀ hydrocarbyl; and
(ii) X¹¹ is independently a halide, a hydride, a C₁ to C₂₀ hydrocarbyl, or a C₁ to C₂₀ hydrocarbyloxide.

For example, the co-catalyst can comprise, consist of, consist essentially of, or be selected from an organoaluminum compound having a formula Al(X¹²)ₛ(X¹³)₃₋ₛ, wherein X¹² is independently a C₁ to C₁₂ hydrocarbyl, X¹¹ is independently a halide, a hydride, or a C₁ to C₁₂ hydrocarboxide, and s is an integer from 1 to 3 (inclusive).

In an aspect, the co-catalyst can comprise or can be selected from an organoaluminum compound, wherein the organoaluminum compound can comprise, can consist essentially of, or can be selected from trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, or any combination thereof. For example, the co-catalyst can comprise, consist of, consist essentially of, or be selected from triethylaluminum, triisobutylaluminum, diethylaluminum ethoxide, diethylaluminum chloride, or any combination thereof.

In a further aspect, the catalyst composition and/or the reaction mixture to prepare and use the catalyst composition can be substantially free of aluminoxane compounds, organoboron or organoborate compounds, ionizing ionic compounds, or combinations thereof. That is, “substantially free” is used to indicated that none of the recited compound or component is intentionally added into the catalyst composition or reaction system. For example, “substantially free” can mean that the recited composition or reaction mixture contains a concentration of less than 10 ppmw (parts per million by weight) of the component that the composition or mixture is substantially free of. In another aspect, the catalyst composition and/or the reaction mixture to prepare and use the catalyst composition can be substantially free of aluminoxane compounds, meaning that no aluminoxane or reagents which form aluminoxane in the presence of an aluminum hydrocarbyl compound (such as water) are intentionally added to the catalyst composition.

Examples of compounds which can be used as co-catalysts are described in more detail below.

### Organoaluminum Compounds

One aspect of this disclosure provides a catalyst composition and a process for producing an olefin polymer composition, in which the catalyst composition and process can utilize a co-catalyst such as an organoaluminum compound. In a further aspect of any embodiment provided here, the catalyst composition can comprise, either in combination with the solid super acid or any other activators or alone, at least one organoaluminum compound.

Organoaluminum compounds that can be used in the catalyst composition of this disclosure include but are not limited to compounds having the formula:

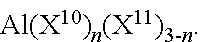

In an embodiment, each X¹⁰ can be independently a C₁ to C₂₀ hydrocarbyl; alternatively, a C₁ to C₁₀ hydrocarbyl; alternately, a C₆ to C₂₀ aryl; alternatively, a C₆ to C₁₀ aryl; alternatively, a C₁ to C₂₀ alkyl; alternatively, a C₁ to C₁₀ alkyl; or alternatively, a C₁ to C₅ alkyl. In an embodiment, each X¹¹ can be independently a halide, a hydride, or a C₁ to C₂₀ hydrocarboxide; alternatively, a halide, a hydride, or a C₁ to C₁₀ hydrocarboxide; alternatively, a halide, a hydride, or a C₆ to C₂₀ aryloxide; alternatively, a halide, a hydride, or a C₆ to C₁₀ aryloxide; alternatively, a halide, a hydride, or a C₁ to C₂₀ alkoxide; alternatively, a halide, a hydride, or a C₁ to C₁₀ alkoxide; alternatively, a halide, a hydride, or, or a C₁ to C₅ alkoxide. In an embodiment, n can be a number (whole or otherwise) from 1 to 3, inclusive. In another aspect and in any embodiment, organoaluminum compounds that can be used in the catalyst composition of this disclosure include but are not limited to compounds having the formula:

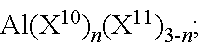

wherein
X¹⁰ can be a hydrocarbyl having from 1 to about 20 carbon atoms;
X¹¹ can be selected from alkoxide or aryloxide, any one of which having from 1 to about 20 carbon atoms, halide, or hydride; and

n can be a number (whole or otherwise) from 1 to 3, inclusive.

For example, X¹⁰ can be selected independently from a C₁ to C₁₂ hydrocarbyl, X¹¹ can be selected independently from a halide, a hydride, or a C₁ to C₁₂ hydrocarboxide, and s can be an integer from 1 to 3 (inclusive).

In one aspect of the formula Al(X¹⁰)ₙ(X¹¹)₃₋ₙ, X¹⁰ can be an alkyl having from 1 to about 10 carbon atoms. Examples of X¹⁰ alkyl group are described herein and may be utilized to describe the alkyl aluminum compounds without limitation. In an aspect, X¹¹ may be selected independently from fluoro or chloro. In yet another aspect, X¹¹ may be chloro.

In the formula Al(X¹⁰)ₙ(X¹¹)₃₋ₙ, n can be a number (whole or otherwise) from 1 to 3 inclusive, and typically, n is 2 or n is 3. The value of n is not restricted to be an integer, therefore this formula includes sesquihalide compounds or other organoaluminum cluster compounds.

Generally, examples of organoaluminum compounds that can be used in this disclosure include, but are not limited to, trialkylaluminum compounds, dialkylaluminum halide compounds, alkylaluminum dihalide compounds, dialkylaluminum alkoxide compounds, dialkylaluminum hydride compounds, and combinations thereof. Specific examples of organoaluminum compounds that are useful in this disclosure include, but are not limited to: trimethylaluminum (TMA), triethylaluminum (TEA), ethylaluminum dichloride, tripropylaluminum, diethylaluminum ethoxide, tributylaluminum, diisobutylaluminum hydride, triisobutylaluminum, diethylaluminum chloride (DEAC), and combinations thereof.

In one aspect, the present disclosure provides for precontacting the metallocene compound with at least one organoaluminum compound and an olefin monomer to form a precontacted mixture, prior to contact this precontacted mixture with the solid oxide activator-support to form the active catalyst. When the catalyst composition is prepared in this manner, typically, though not necessarily, a portion of the organoaluminum compound can be added to the precontacted mixture and another portion of the organoaluminum compound can be added to the postcontacted mixture prepared when the precontacted mixture can be contacted with the solid oxide activator. However, all the organoaluminum compound may be used to prepare the catalyst in either the precontacting or postcontacting step. Alternatively, all the catalyst components may be contacted in a single step.

Further, more than one organoaluminum compounds may be used, in either the precontacting or the postcontacting step. When an organoaluminum compound is added in multiple steps, the amounts of organoaluminum compound disclosed herein include the total amount of organoaluminum compound used in both the precontacted and postcontacted mixtures, and any additional organoaluminum compound added to the polymerization reactor. Therefore, total amounts of organoaluminum compounds are disclosed, regardless of whether a single organoaluminum compound is used, or more than one organoaluminum compound. In another aspect, triethylaluminum (TEA) or triisobutylaluminum are typical organoaluminum compounds used in this disclosure.

In one aspect and in any embodiment disclosed herein, the molar ratio of the organoaluminum compound to the metallocene compound can be from 0.001:1 to 100,000:1. Alternatively and in any embodiment, the molar ratio of the organoaluminum compound to the metallocene compound can be from 0.01:1 to 10,000:1; alternatively from 0.1:1 to 100:1; alternatively, from 0.5:1 to 10:1; or alternatively, from 0.2:1 to 5:1. When referring to the molar ratio of the organoaluminum compound or any other co-catalyst to the metallocene compound, the molar ratios are intended to reflect the total moles of the metallocene compound or metallocene compounds, when more than one metallocene is present.

### Organozinc and Organomagnesium Compounds

In an aspect, the co-catalyst of this disclosure can comprise, consist of, consist essentially or, or be selected from an organozinc compound, an organomagnesium compound, or a combination thereof. Organozinc compounds and organomagnesium compounds that can be used in the catalyst composition of this disclosure include but are not limited to compounds having the formula:

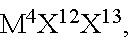

wherein M⁴ is magnesium or zinc. In an embodiment, each X¹² is independently a C₁ to C₂₀ hydrocarbyl; alternatively, a C₁ to C₁₀ hydrocarbyl; alternatively, a C₆ to C₂₀ aryl; alternatively, a C₆ to C₁₀ aryl; alternatively, a C₁ to C₂₀ alkyl; alternatively, a C₁ to C₁₀ alkyl; or alternatively, C₁ to C₅ alkyl. In an embodiment, each X¹³ is independently a halide, a hydride, or a C₁ to C₂₀ hydrocarbyl; alternatively, a halide, a hydride, or a C₁ to C₁₀ hydrocarbyl; alternatively, a halide, a hydride, or a C₆ to C₂₀ aryl; alternatively, a halide, a hydride, or a C₆ to C₁₀ aryl; alternatively, a halide, a hydride, or a C₁ to C₂₀ alkyl; alternatively, a halide, a hydride, or a C₁ to C₁₀ alkyl; alternatively, a halide, a hydride, or a C₁ to C₅ alkyl; alternatively, a halide, a hydride, or a C₁ to C₂₀ hydrocarboxide; alternatively, a halide, a hydride, or a C₁ to C₁₀ hydrocarboxide; alternatively, a halide, a hydride, or a C₆ to C₂₀ aryloxide; alternatively, a halide, a hydride, or a C₆ to C₁₀ aryloxide; alternatively, a halide, a hydride, or a C₁ to C₂₀ alkoxide; alternatively, a halide, a hydride, or a C₁ to C₁₀ alkoxide; or alternatively, a halide, a hydride, or a C₁ to C₅ alkoxide.

In a further aspect and in any disclosed embodiment, the catalyst composition can further comprise an organozinc or organomagnesium co-catalyst, selected from a compound with the following formula:

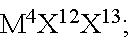

wherein:
M⁴ is Zn or Mg;
X¹² is a hydrocarbyl having from 1 to about 20 carbon atoms; and
X¹³ is selected from a hydrocarbyl, an alkoxide, or an aryloxide having from 1 to about 20 carbon atoms, halide, or hydride.

In another aspect, and in the various embodiments of this disclosure, useful organozinc compounds can be selected from or alternatively can comprise dimethylzinc, diethylzinc, dipropylzinc, dibutylzinc, dineopentylzinc, di(trimethylsilylmethyl)zinc, and the like, including any combinations thereof; alternatively, dimethylzinc; alternatively, diethylzinc; alternatively, dipropylzinc; alternatively, dibutylzinc; alternatively, dineopentylzinc; or alternatively, di(trimethylsilylmethyl)zinc.

In one aspect and in any embodiment disclosed herein, the molar ratio of the organozinc compound to the metallocene compound can be from 0.001:1 to 100,000:1. Alternatively and in any embodiment, the molar ratio of the organozinc compound to the metallocene compound can be from 0.01:1 to 10,000:1; alternatively from 0.1:1 to 100:1; alternatively, from 0.5:1 to 10:1; or alternatively, from 0.2:1 to 5:1. As indicated previously, the molar ratios are intended to reflect the total moles of the metallocene compound or metallocene compounds, when more than one metallocene is present.

### Diluents

In a further aspect, the catalyst compositions disclosed herein may further comprises a diluent, the catalyst compositions can further comprise the contact product of a diluent with the additional catalyst compositions components, or the method of making the catalyst composition can further comprise contacting in any order a diluent and the additional catalyst compositions components. Thus, the polymerization process and the method for making a catalyst composition can be carried out using a diluent or carrier for the components of the catalyst composition.

According to an aspect, the diluent can comprise, consist of, consist essentially of, or can be selected from any suitable non-protic (aprotic) solvent, or any non-protic solvent disclosed herein. For example, in an aspect, the diluent can comprise any suitable non-coordinating solvent such as the hydrocarbon solvents disclosed herein.

For example, the diluent can comprise any suitable aliphatic hydrocarbon solvent, or any aliphatic hydrocarbon solvent disclosed herein. In an aspect, the diluent can comprise, consist of, consist essentially of, or be selected from at least one olefin monomer in the case of bulk polymerizations, propane, butanes (for example, n-butane, iso-butane), pentanes (for example, n-pentane, iso-pentane), hexanes, heptanes, octanes, petroleum ether, light naphtha, heavy naphtha, and the like, or any combination thereof.

In another aspect, the diluent can comprise any suitable aromatic hydrocarbon solvent, or any aromatic hydrocarbon solvent disclosed herein, for example, benzene, xylene, toluene, and the like.

The diluent may also comprise an olefin or a combination of olefins. For example, the diluent can comprise at least one olefin monomer, wherein the olefin monomer comprises, consists essentially of, or is selected from ethylene, propylene, butene (e.g., 1-butene), pentene, hexene (e.g., 1-hexene), heptene, octene (e.g., 1-octene), styrene, and the like.

The term “solvent” as used herein does not imply that all or any of the components of the catalyst composition are soluble, but rather “solvent” is used interchangeably with the term “carrier” or “diluent”. The skilled person will appreciate that not all metallocene compounds, co-catalysts, and activators may be highly stable in all of the diluents described herein, and it is not intended to reflect that this is the case.

### Catalyst Preparation and Polymerization Processes

The Examples section of this disclosure sets out the synthesis of 4-substituted benzophenones, their use to prepare fulvene compounds, the synthesis of the cyclopentadienyl-fluorenyl ligands, and metallocene synthesis from these ligands. Once prepared, the metallocene ligands are used in the polymerization processes as described in the Examples. The synthesis of the relevant ligands and the metallocenes is illustrated in the embodiments of Scheme 1.

Thus, commercially available 4-hydroxy (or 4,4′-dihydroxy) benzophenone compounds were reacted with allyl bromide or 4-bromo-1-butene to form the 4-RO— or 4,4′-(RO)₂-benzophenones (R is allyl or butenyl), and these compounds were isolated as white solids. The benzophenones were then reacted with CpMgCl to give their corresponding fulvenes, 6-(4-allyloxyphenyl)-6-phenyl-fulvene and 6,6-(4-allyloxyphenyl)₂-fulvene were isolated as red oils which were purified by column chromatography, whereas the 6,6-(4-butenyloxyphenyl)₂-fulvene was isolated as a red solid. The linked cyclopentadienyl-fluorenyl ligands and their corresponding zirconocenes were synthesized in good yields as illustrated in Scheme 1. Single crystal X-ray diffraction studies of the metallocenes indicated that the allyloxy or butenyloxy groups generally do not significantly impact the solid-state structures of metallocenes.

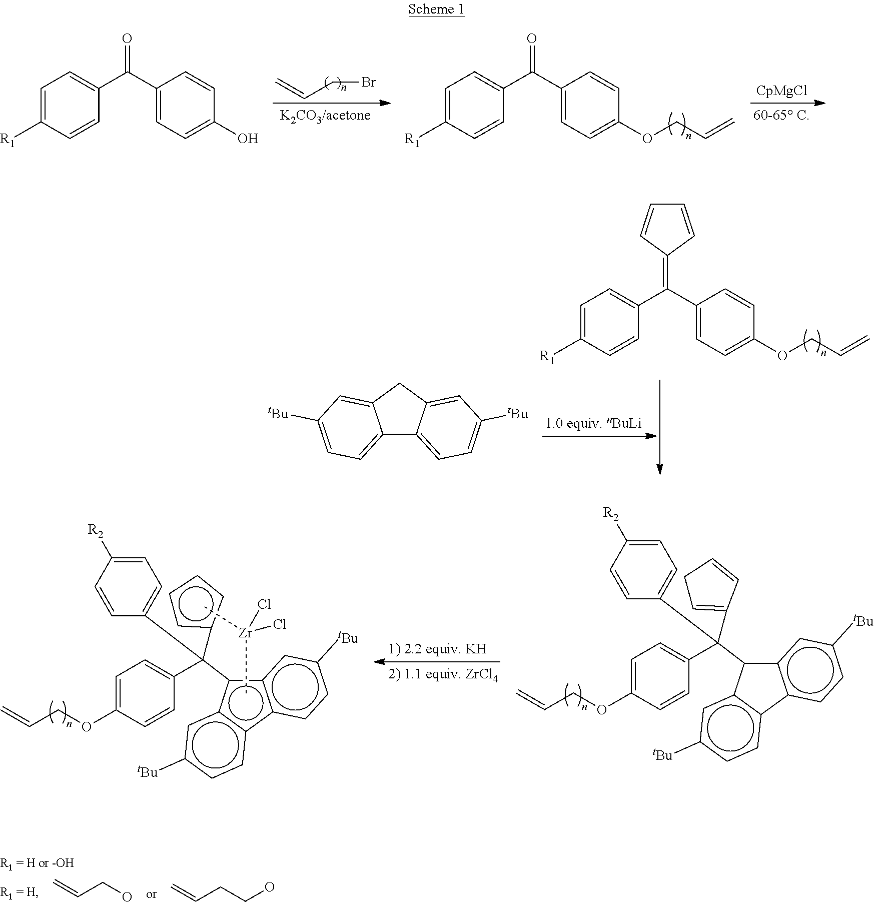

In an aspect, the catalyst compositions disclosed herein can further comprise at least one olefin (that is, olefin monomer), the catalyst compositions can further comprise the contact product of at least one olefin with the additional catalyst compositions components, or the method of making the catalyst composition can further comprise contacting in any order at least one olefin and the additional catalyst compositions components.

The disclosed process may comprise contacting at least one olefin monomer and a catalyst composition under polymerization conditions to form a polyolefin, wherein the catalyst composition comprises or comprises the contact product of: (a) a metallocene compound as provided in this disclosure; and (b) a metallocene activator or all components thereof, which may include a co-catalyst. In an aspect, the disclosed process may comprise contacting at least one olefin monomer and a catalyst composition under polymerization conditions to form a polyolefin, wherein the catalyst composition comprises or comprises the contact product of: (a) a metallocene compound as provided in this disclosure; (b) an activator-support comprising a solid oxide treated with an electron-withdrawing anion (“solid super acid”); and (c) a co-catalyst such as an organoaluminum co-catalyst. In this case, the activator-support and the organoaluminum compound are components which together activate the metallocene towards olefin polymerization activity.

Any of the metallocenes described herein may be used in the process for polymerizing olefins. The at least one olefin monomer can comprise, consist of, or consist essentially of (a) ethylene, or (b) ethylene in combination with an olefin co-monomer such as propylene, butene (e.g., 1-butene), pentene, hexene (e.g., 1-hexene), heptene, octene (e.g., 1-octene), styrene, and the like.

This disclosure also provides a method of making a catalyst composition as well as encompassing a process for polymerizing olefins by contacting at least one olefin monomer and a catalyst composition under polymerization conditions to form an olefin polymer. The catalyst composition can comprise, and the catalyst composition components can comprise, a metallocene compound, an activator-support comprising a solid oxide treated with an electron-withdrawing anion (a “solid super acid”), and an organoaluminum co-catalyst, as disclosed herein. Accordingly, making the catalyst composition involves contacting the components in any order. For example, in one aspect, the contacting steps can comprise contacting the recited components in the following order:
(a) the solid oxide treated with an electron-withdrawing anion, optionally contacted with a diluent, and constituting a first composition, is contacted with:
(b) the organoaluminum co-catalyst, forming a second composition, which is contacted with:
(c) the metallocene compound.

In a further aspect of making the catalyst composition, the contacting steps can comprise any of the following contacting procedures:
(a) the metallocene compound and the co-catalyst are contacted in a diluent, to provide a first composition, and the first composition is contacted with the metallocene activator such as an activator-support;
(b) the metallocene compound and the metallocene activator such as the activator-support are contacted in the diluent, to provide a second composition, and the second composition is contacted with the co-catalyst;
(c) the co-catalyst and the metallocene activator such as the activator-support are contacted in the diluent, to provide a third composition, and the third composition is contacted with the metallocene compound; or
(d) the metallocene compound, the metallocene activator such as the activator-support, and the co-catalyst are co-fed and contacted in a single step.

In any of these above contacting steps, the recited components can be contacted in the presence of an olefin, or the recited components can be contacted in the absence of an olefin. According to an aspect of making the catalyst composition and the process of polymerizing olefins, the contacting steps and the polymerization process can be conducted in a hydrocarbon slurry.

In the process for polymerizing olefins, at least one olefin monomer can comprise, consist essentially of, or be selected from ethylene, propylene, butene (e.g., 1-butene), pentene, hexene (e.g., 1-hexene), heptene, octene (e.g., 1-octene), styrene, and the like, or any combination thereof. In a particular aspect, the at least one olefin monomer can comprise, consist essentially of, or be selected from ethylene or ethylene in combination with an olefin co-monomer selected from propylene, butene (e.g., 1-butene), pentene, hexene (e.g., 1-hexene), heptene, octene (e.g., 1-octene), styrene, and the like. Moreover, the polymerization process can further comprise a step of monitoring the concentration of at least one reaction mixture component, at least one elimination reaction product, or a combination thereof.

In another aspect, the process for polymerizing olefins described herein can be conducted in the presence of hydrogen. For example, the polymerization process can be conducted in the presence of hydrogen at a concentration of 10 ppm to 1,000 ppmw in a polymerization reaction composition, where the ppmw concentration is the parts per million by weight of hydrogen relative to the ethylene weight, that is, the weight ratio of H₂ to ethylene. Conducting the polymerization in the presence of hydrogen can assist in molecular weight control of the resulting polymer. In another aspect, the process for polymerizing olefins according to this disclosure can be conducted in the absence of hydrogen.

Examples of the polymerization process include a process by which at least one olefin monomer and the catalyst composition can be contacted under any one or any combination of more than one of the following conditions:
(a) the molar ratio of the co-catalyst to the metallocene compound is from about 0.1:1 to about 1,200:1, or from about 2:1 to about 1,100:1, or from about 5:1 to about 1,000:1, or from about 10:1 to about 750:1;
(b) the weight ratio of the activator-support to the metallocene compound is from about 5:1 to about 1,500:1, or from about 10:1 to about 1,250:1, or form about 20:1 to about 1,000:1;
(c) the weight ratio of the at least one olefin monomer to the metallocene compound is from about 1,000:1 to about 100,000,000:1, or from about 5,000:1 to about 50,000,000:1, or from about 10,000:1 to about 25,000,000:1; or
(d) any combination of conditions (a), (b), and (c).
   These contacting conditions are also useful conditions as a method of making the catalyst composition.

In another aspect, for example, the at least one olefin monomer and the catalyst composition can be contacted under any one or any combination of more than one of the following conditions:
(a) the molar ratio of the co-catalyst to the metallocene compound(s) is from about 10:1 to about 500:1, for example when the co-catalyst comprises an organoaluminum compound such as a trialkylaluminum compound; or
(b) the weight ratio of the activator-support to the metallocene compound(s) is from about 5:1 to about 1,000:1, for example when the activator-support comprises a fluorided silica-alumina, fluorided silica-coated alumina, or a fluorided mullite; or
(c) the weight ratio of the at least one olefin monomer to the metallocene compound(s) is from about 1,000:1 to about 100,000,000:1; or
(d) any combination of (a), (b), and (c).

According to a further aspect, the polymerization conditions can include any one or any combination of more than one of the following conditions:
(a) a polymerization reaction temperature from about 40° C. to about 280° C., from about 50° C. to about 180° C., or from about from about 60° C. to about 160° C.; or
(b) a reaction pressure or a partial pressure of ethylene of from about 25 psi (0.17 MPa) to about 1500 psi (10.3 MPa), from about 50 psig (0.34 mPa) to about 1200 psig (8.3 MPa), from about 85 psig (0.59 mPa) to about 1100 psig (7.6 MPa), or from about 100 psig (0.69 MPa) to about 1000 psig (6.9 MPa);
(c) a time of the contacting step of from about 1 minute to about 3 hours, from about 5 minutes to about 2.5 hours, from about 10 minutes to about 2 hours, or from about 20 minutes to about 1.5 hours; or
(d) any combination of (a), (b), and (c).

The polymerization process is not limited to a specific reactor design or method. For example, the process for polymerizing olefins can be conducted in a polymerization reactor system comprising a batch reactor, a slurry reactor, a loop-slurry reactor, a gas phase reactor, a solution reactor, a high-pressure reactor, a tubular reactor, an autoclave reactor, a continuous stirred tank reactor (CSTR), or a combination thereof. A loop-slurry reactor can be particularly useful. Further, polymerization can be conducted in a polymerization reactor system comprising a single reactor or can be conducted in a polymerization reactor system comprising two or more reactors arranged in series or in parallel. Thus, the polymerization process can be conducted in a tubular reactor, under suitable polymerization conditions. The disclosed metallocenes are useful in single-metallocene or multiple metallocene applications and systems.

In an aspect, the polymerization conditions can comprise contacting the catalyst composition with at least one olefin monomer in the presence of a diluent selected from at least one olefin monomer in the case of bulk polymerizations, propane, butanes (for example, n-butane, iso-butane), pentanes (for example, n-pentane, iso-pentane), hexanes, heptanes, octanes, petroleum ether, light naphtha, heavy naphtha, and the like, or any combination thereof. In another aspect, the polymerization conditions can comprise contacting the catalyst composition with at least one olefin monomer in the presence of a diluent selected from any suitable aromatic hydrocarbon solvent, or any aromatic hydrocarbon solvent disclosed herein, for example, benzene, xylene, toluene, and the like.

The polymerization conditions also can comprise a co-polymerization of ethylene with a co-monomer or more than one co-monomer as described herein. For example, the olefin monomer can further comprise at least one C₃ to C₂₀ olefin comonomer. In one aspect, the olefin monomer can further comprise at least one olefin comonomer, the comonomer comprising, consisting essentially of, or being selected from propylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-ethyl-1-hexene, 1-heptene, 2-heptene, 3-heptene, 1-octene, 1-decene, styrene, or a combination thereof.

The disclosure also provides for, in an aspect, a process for polymerizing an olefin wherein the step of providing a catalyst composition further comprises providing the contact product in a solvent. That is, the step of contacting the catalyst composition components can be and typically is carried out in a solvent or a combination of solvents. Moreover, any order of contacting the components can be used. For example, the co-catalyst can be contacted in a solvent prior to contact with the metallocene compound(s). In another aspect, the co-catalyst, the activator such as an activator-support, and the at least one olefin monomer comprising ethylene can be contacted in a solvent prior to contact with the metallocene compound(s). According to other aspects, the co-catalyst and the metallocene compound can be contacted in a solvent in the presence or absence of at least one olefin monomer comprising ethylene, prior to contacting with the activator-support. A further aspect provides that the activator-support and the metallocene compound can be contacted in a solvent in the presence or absence of at least one olefin monomer comprising ethylene, prior to contacting with the co-catalyst.

### Polymerization Results Using the Metallocene Catalysts

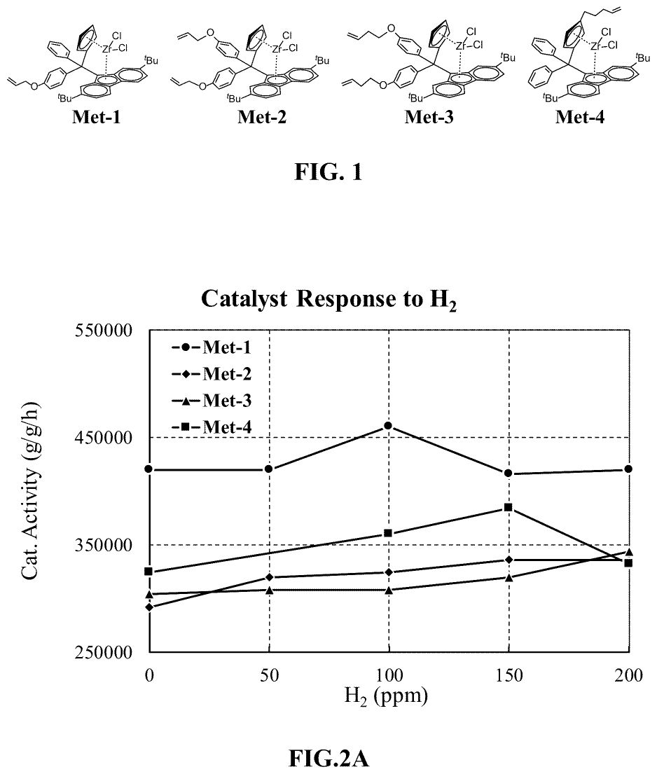

The Examples section sets out the general procedure for the polymerization studies. Table 1 provides exemplary polymerization conditions for ethylene homopolymerization runs for metallocene catalysts Met-1 through Met-3, and comparative metallocene and Met-4, shown in FIG. 1. Table 2 provides the polyethylene properties for the ethylene homopolymerizations of Table 1.

Therefore, in the tables:
Met-1 is [2,7-t-butylfluorenyl((4-allyl-O—C₆H₄)PhC)Cp]ZrCl₂;
Met-2 is [2,7-t-butylfluorenyl((4-allyl-O—C₆H₄)₂C)Cp]ZrCl₂;
Met-3 is [2,7-t-butylfluorenyl((4-buten-1-yl-O—C₆H₄)C)Cp]ZrCl₂; and
Met-4 is [2,7-t-butylfluorenyl(Ph₂C)(3-penten-1-yl-Cp)]ZrCl₂.

TABLE 1
Evaluation of metallocene catalysts for ethylene homopolymerization
under various hydrogen concentration conditions.

| | | Catalyst | TIBAL | m-SSA | H₂ | C6 | C2 | Time | Temp. | PE |
|---|---|---|---|---|---|---|---|---|---|---|
| Example | Catalyst | (mg) | (mL) | (mg) | (ppm) | (g) | (psig) | (min) | (° C.) | (g) |
| 1 | Met-1 | 0.50 | 0.6 | 200 | 0 | 0 | 390 | 30 | 90 | 105 |
| 2 | | 0.50 | 0.6 | 200 | 50 | 0 | 390 | 30 | 90 | 105 |
| 3 | | 0.50 | 0.6 | 200 | 100 | 0 | 390 | 30 | 90 | 115 |
| 4 | | 0.50 | 0.6 | 200 | 150 | 0 | 390 | 30 | 90 | 104 |
| 5 | | 0.50 | 0.6 | 200 | 200 | 0 | 390 | 30 | 90 | 105 |
| 6 | | 0.50 | 0.6 | 200 | 300 | 0 | 390 | 30 | 90 | 114 |
| 7 | Met-2 | 0.50 | 0.6 | 200 | 0 | 0 | 390 | 30 | 90 | 73 |
| 8 | | 0.50 | 0.6 | 200 | 50 | 0 | 390 | 30 | 90 | 80 |
| 9 | | 0.50 | 0.6 | 200 | 100 | 0 | 390 | 30 | 90 | 81 |
| 10 | | 0.50 | 0.6 | 200 | 150 | 0 | 390 | 30 | 90 | 84 |
| 11 | | 0.50 | 0.6 | 200 | 200 | 0 | 390 | 30 | 90 | 84 |
| 12 | Met-3 | 0.50 | 0.6 | 200 | 0 | 0 | 390 | 30 | 90 | 76 |
| 13 | | 0.50 | 0.6 | 200 | 50 | 0 | 390 | 30 | 90 | 77 |
| 14 | | 0.50 | 0.6 | 200 | 100 | 0 | 390 | 30 | 90 | 77 |
| 15 | | 0.50 | 0.6 | 200 | 150 | 0 | 390 | 30 | 90 | 80 |
| 16 | | 0.50 | 0.6 | 200 | 200 | 0 | 390 | 30 | 90 | 86 |
| 17 | Met-4 | 0.50 | 0.6 | 200 | 0 | 0 | 390 | 30 | 90 | 81 |
| 18 | | 0.50 | 0.6 | 200 | 100 | 0 | 390 | 30 | 90 | 90 |
| 19 | | 0.50 | 0.6 | 200 | 150 | 0 | 390 | 30 | 90 | 96 |
| 20 | | 0.50 | 0.6 | 200 | 200 | 0 | 390 | 30 | 90 | 83 |

TABLE 2
Analyses of ethylene homopolymer resins made
by the metallocene catalysts of Table 1.

| Example | Catalyst | Mn/1000 | Mw/1000 | Mz/1000 | Mw/Mn | Mz/Mw | Eta_0 |
|---|---|---|---|---|---|---|---|
| 1 | Met-1 | 335.0 | 844.5 | 1717.9 | 2.5 | 2.0 | 1.72E+07 |
| 2 | | 342.8 | 836.8 | 1660.0 | 2.4 | 2.0 | 2.91E+07 |
| 3 | | 352.9 | 842.9 | 1686.9 | 2.4 | 2.0 | 2.56E+07 |
| 4 | | 213.4 | 772.6 | 1745.5 | 3.6 | 2.3 | 1.86E+07 |
| 5 | | 59.8 | 389.7 | 1449.0 | 6.5 | 3.7 | 2.21E+07 |
| 6 | | 24.8 | 199.2 | 672.7 | 8.0 | 3.4 | 6.86E+04 |
| 7 | Met-2 | 324.0 | 988.0 | 2160.1 | 3.0 | 2.2 | 1.52E+08 |
| 8 | | 314.2 | 986.7 | 2131.4 | 3.1 | 2.2 | 1.76E+08 |
| 9 | | 333.5 | 1004.7 | 2147.7 | 3.0 | 2.1 | 1.87E+08 |
| 10 | | 191.2 | 851.5 | 2136.1 | 4.5 | 2.5 | 1.26E+08 |
| 11 | | 61.9 | 597.3 | 1990.5 | 9.7 | 3.3 | 2.04E+08 |
| 12 | Met-3 | 435.5 | 1108.2 | 2326.9 | 2.5 | 2.1 | 3.34E+07 |
| 13 | | 449.4 | 1161.7 | 2425.1 | 2.6 | 2.1 | — |
| 14 | | 448.0 | 1124.1 | 2352.4 | 2.5 | 2.1 | 4.15E+07 |
| 15 | | 443.1 | 1117.5 | 2366.3 | 2.5 | 2.1 | — |
| 16 | | 81.3 | 602.9 | 2135.5 | 7.4 | 3.5 | 6.72E+06 |
| 17 | Met-4 | 311.4 | 700.7 | 1320.3 | 2.2 | 1.9 | 4.08E+06 |
| 18 | | 265.0 | 575.5 | 1035.6 | 2.2 | 1.8 | 2.47E+06 |
| 19 | | 183.6 | 476.9 | 907.8 | 2.6 | 1.9 | 1.11E+06 |
| 20 | | 66.7 | 219.6 | 470.9 | 3.3 | 2.1 | 4.15E+04 |

Table 3 provides exemplary polymerization conditions and polyethylene resin properties for ethylene homopolymerization and ethylene-1l-hexene copolymerization runs metallocene catalysts [2,7-t-butylfluorenyl((4-allyl-O—C₆H₄)PhC)Cp]ZrCl₂ (Met-1), shown in FIG. 1 and below.

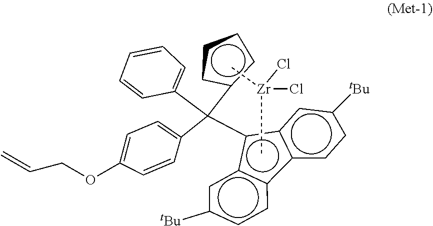

TABLE 3
Ethylene polymerization studies of Met-1 under hydrogen
concentrations and 1-hexene concentrations. ^{A}

| | | | Met. | | | | | |
|---|---|---|---|---|---|---|---|---|
| | H2 | C6 | Activity | Mn | Mw | Mz | | |
| Run No. | (ppm) | (g) | (g/g/h) ^{B} | (kg/mol) | (kg/mol) | (kg/mol) | Mw/Mn | Eta_0 |
| A | 0 | — | 420000 | 335.0 | 844.5 | 1717.9 | 2.5 | 1.72E+07 |
| B | 50 | — | 420000 | 342.8 | 836.8 | 1660.0 | 2.4 | 2.91E+07 |
| C | 100 | — | 460000 | 352.9 | 842.9 | 1686.9 | 2.4 | 2.56E+07 |
| D | 150 | — | 416000 | 213.4 | 772.6 | 1745.5 | 3.6 | 1.86E+07 |
| E | 200 | — | 420000 | 59.8 | 389.7 | 1449.0 | 6.5 | 2.21E+07 |
| F | 300 | — | 456000 | 24.8 | 199.2 | 672.7 | 8.0 | 6.86E+04 |
| G | — | 0 | 200000 | 504.7 | 1287.9 | 2613.6 | 2.6 | — |
| H | — | 8 | 248000 | 400.4 | 886.4 | 1614.9 | 2.2 | — |
| I | — | 16 | 340000 | 313.0 | 681.9 | 1229.7 | 2.2 | — |
| J | — | 25 | 408000 | 266.3 | 558.9 | 964.7 | 2.1 | — |
| K | 200 | 10 | 420000 | 47.2 | 313.8 | 1005.8 | 6.6 | 8.93E+11 |
| L | 300 | 11 | 400000 | 15.0 | 188.5 | 606.0 | 12.5 | 1.45E+07 |
| M | 300 | 19 | 492000 | 18.9 | 179.7 | 515.5 | 9.5 | 4.77E+09 |

^{A} Conditions for runs A-F and K-M: 0.5 mg of metallocene catalyst, 200 mg of m-SSA, 0.6 mL of TIBAL solution (1M in hexanes), 390 psi of ethylene, 90° C. for 30 minutes; conditions for runs G-J: 0.5 mg of catalyst, 200 mg of m-SSA, 0.6 mL of TIBAL solution (1M in hexanes), 340 psi of ethylene, 80° C. for 30 minutes.
^{B} Met. Activity (g/g/h) is the metallocene activity in units of g PE/(g metallocene · hour), i.e., grams of polyethylene per gram of metallocene per hour.

Table 3 presents polymerization data for Met-1 catalyst which features one allyloxy group bonded to the bridging atom by a rigid phenylene group, under different hydrogen concentrations and 1-hexene concentrations. High activity was observed with this catalyst, ranging from 420-460 kg of polymer/g metallocene/hour under homopolymerization conditions (90° C., 390 psi of ethylene, 30 minutes).

A hydrogen concentration in the range 0-300 ppm did not appear to impact catalyst activity. While not intending to be bound by theory, this observation could result from presence of the allyl group, as this effect has been observed in other metallocenes bearing an unsaturated group. However, as hydrogen concentration increased from 0 to 300 ppm, the polymer molecular weight decreased accordingly, and the molecular weight distribution (MWD) generally becomes broader.

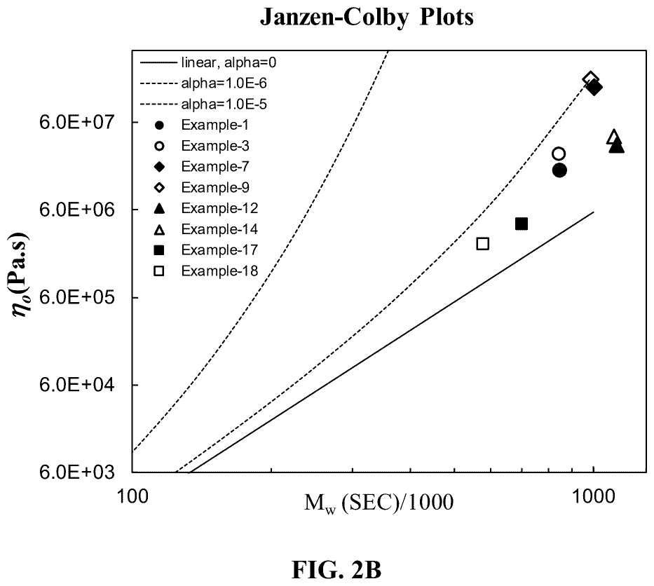

Comparative data for all of Met-1, Met-2, Met-3, and comparative metallocene Met-4 when producing ethylene homopolymers are presented in FIG. 2A and FIG. 2B. FIG. 2A demonstrates the catalyst response to hydrogen, plotting the H₂ concentration (ppm) versus metallocene catalyst activity (g PE/(g metallocene·hour)) using 0-200 ppm of H₂ and 390 psi of ethylene (90° C. for 30 minutes). The FIG. 2A data for Met-1 are presented in Table 4 and for Met-2 in Table 5. FIG. 2B shows a Janzen-Colby plot for the noted homopolymer Examples in Table 1 and Table 2 produced with metallocenes Met-1 through Met-4.

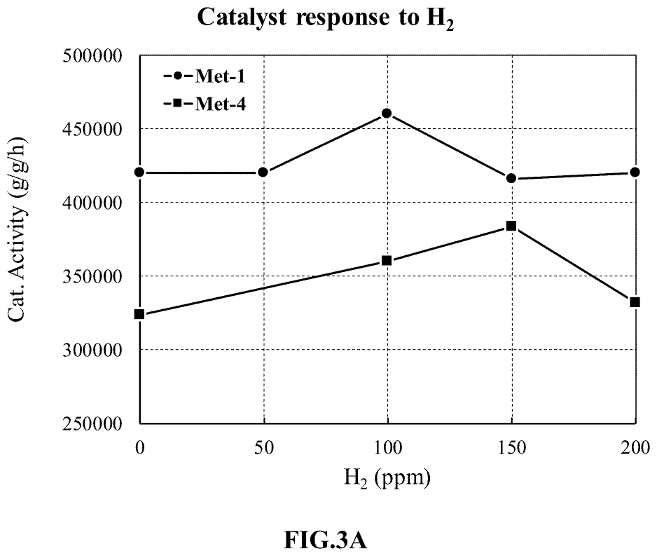

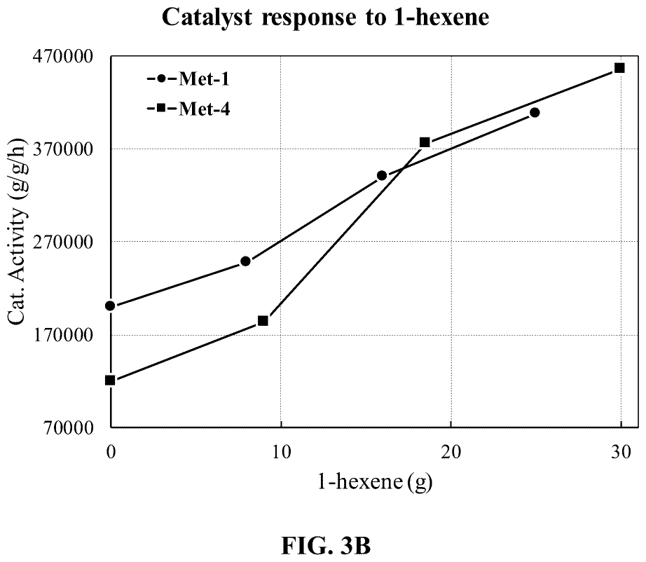

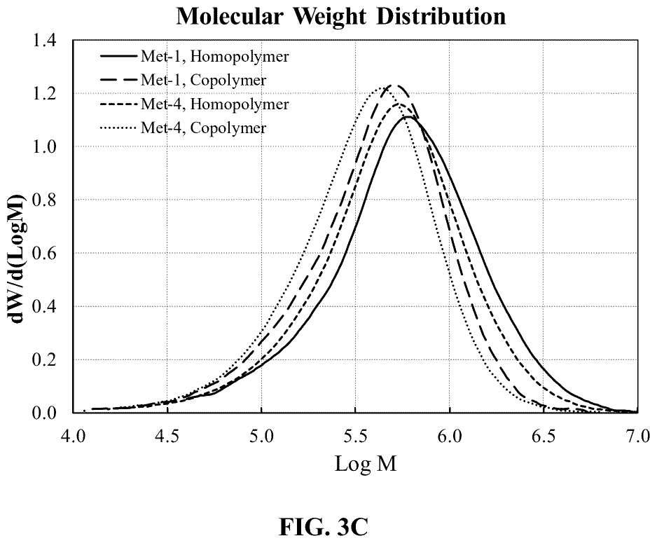

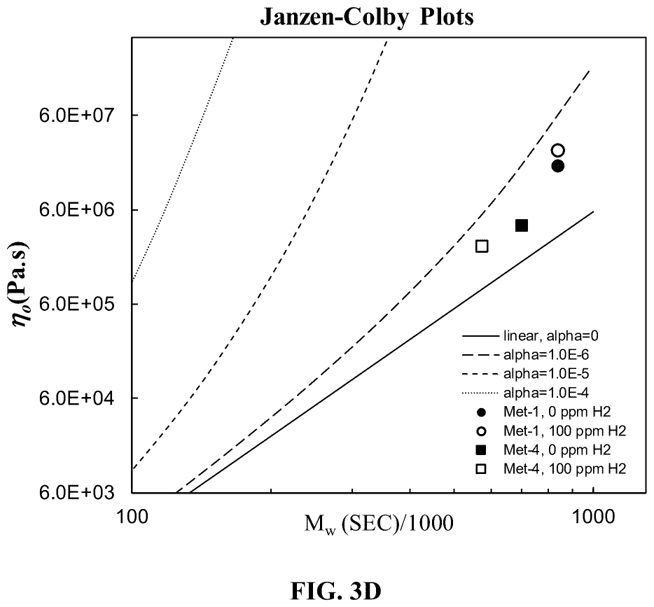

The benchmark metallocene in these tests was [2,7-t-butylfluorenyl(Ph₂C)(3-penten-1-yl-Cp)]ZrCl₂ (Met-4). Both Met-1 and Met-4 feature one unsaturated group; see FIG. 1. The unsaturated penten-1-yl group of Met-4 is bonded to the cyclopentadienyl in close proximity to the zirconium atom. In contrast, the allyloxy group in Met-1 is bonded to the bridging atom via a rigid phenylene group and therefore is more remote from the metal center. Comparisons of the performance of these metallocene catalysts and their resulting polymers are illustrated in FIGS. 3A-3D.

In the hydrogen response studies of FIG. 3A, Met-1 appears to be more active than Met-4 by about 15-30% across all hydrogen concentrations from 0-200 ppm. For both Met-1 and Met-4, hydrogen concentration [H2] in the range 0-200 ppm does not impact catalyst activity substantially, perhaps suggesting that the location of the unsaturated group does not discernably affect catalyst response to [H2] in ethylene polymerization. In the copolymerization studies of FIG. 3B, both metallocenes show dramatic increases in activity with 10-30 g of 1-hexene in ethylene polymerization. With low amounts of 1-hexene (0-10 g), Met-1 appears to be more active than Met-4, however with higher amounts of 1-hexene (20-30 g), Met-1 and Met-4 exhibit comparable activities. While not intending to be bound by any particular theory, it is possible that different impacts of 1-hexene on these catalyst activities could be due to the different locations of the unsaturated groups in each metallocene.

FIG. 3C also compares the MWD of homopolymers (no H2, 390 psi of ethylene, 90° C.) and copolymers (˜30 g of 1-hexene, 340 psi of ethylene, 80° C.) produced using Met-1 and Met-4. Under all conditions, the polymers produced by Met-1 consistently showed higher molecular weights than those produced using Met-4. Table 4 summarizes how the polymer molecular weights (Mw) compare using Met-1 versus Met-4 under comparable conditions.

TABLE 4
Comparison of Mw (kg/mol) of the polymers produced
by comparative metallocene Met-4 versus Met-1. ^{A}

Mw (kg/mol)

| Conditions | Met-4 | Met-1 |
|---|---|---|
| 0 ppm of H2 | 700.7 | 844.5 |
| 100 ppm of H2 | 575.5 | 842.9 |
| 150 ppm of H2 | 476.9 | 772.6 |
| 0 g of 1-hexene | 1056.2 | 1287.9 |
| ~10 g of 1-hexene | 717.4 | 886.4 |
| ~20 g of 1-hexene | 522.0 | 681.9 |
| ~30 g of 1-hexene | 483.8 | 558.9 |

^{A} H2 runs were conducted with 390 psi of ethylene, at 90° C. for 30 minutes; 1-hexene runs were conducted with 340 psi of ethylene, at 80° C. for 30 minutes.

Considering the structural differences between Met-1 and Met-4, and while not intending to be theory-bound, it is thought that at least two aspects could contribute to the different polymer molecular weights. One aspect could be the different locations of the unsaturated groups in these metallocene catalysts. Another aspect could be the oxygen atom in the allyloxy group which may alter the electronic property and Lewis basicity of this group, which might also impact polymer molecular weight.

FIG. 3D presents the Janzen-Colby plots of selected homopolymers produced by Met-1 and Met-4, demonstrating that both catalysts produce a similar level of LCB (<10 LCB/million carbon atoms) under the homopolymerization conditions. However, Met-1 makes higher LCB than Met-4 under copolymerization conditions.

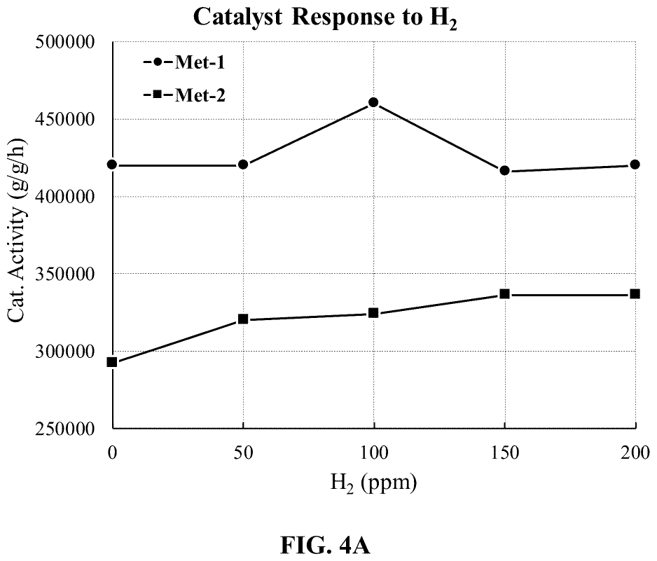

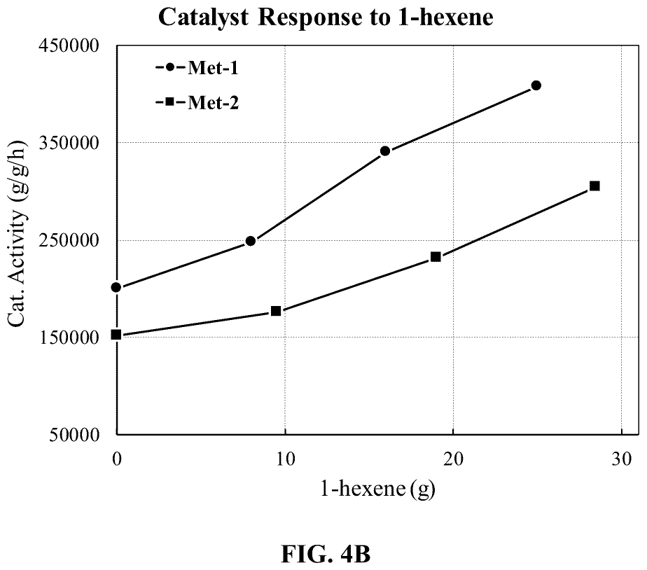

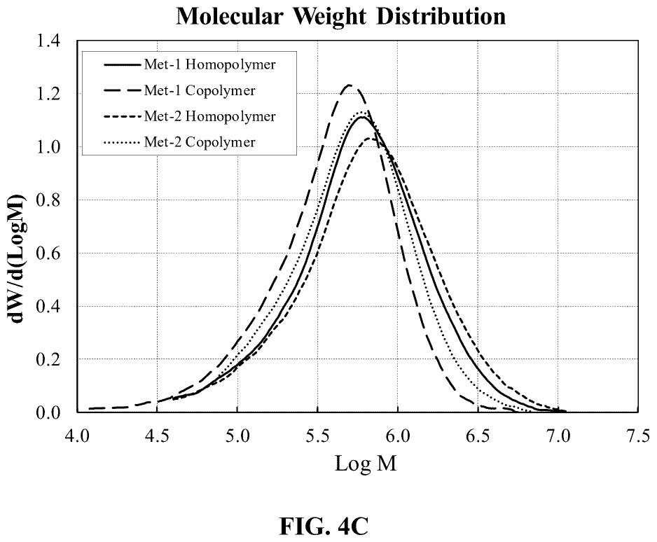

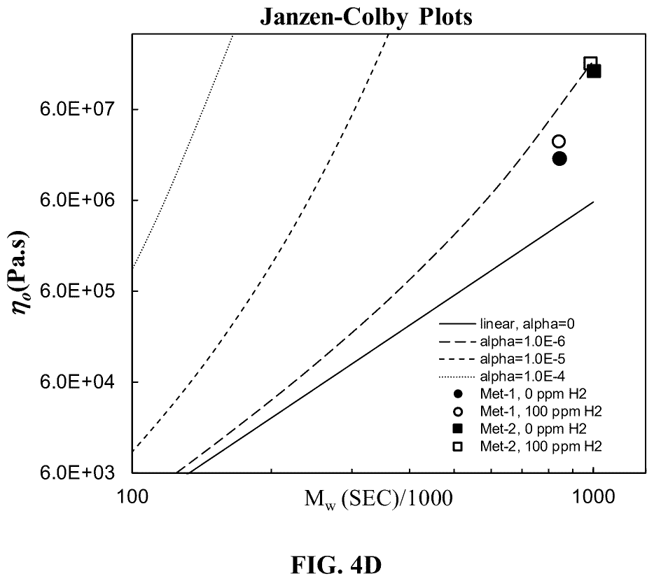

The polymers produced by the Met-1 catalyst were compared with those produced using Met-2 catalyst which includes a second 4-allyloxy group as compared with Met-1 on the second phenyl group bonded to the bridging carbon. FIGS. 4A-4D examine the effects of one versus two allyloxy groups and provide comparative data for Met-1 versus Met-2 metallocene catalysts and their resulting polymers. Under all polymerization conditions examined, Met-1 was more active than Met-2, perhaps because the additional allyloxy group decreased activity.

FIG. 4A illustrates the response of Met-1 and Met-2 metallocenes to H2 (0-200 ppm). While the activity of Met-1 is generally not impacted by H2 (0-200 ppm), Met-2 appears to show slightly increased activity in this H2 range. In copolymerization studies, FIG. 4B illustrates that both metallocenes show dramatic increases in activity when 1-hexene (10-30 g) is copolymerized. Overall, these generally similar behaviors towards H2 or 1-hexene may demonstrate in these metallocenes that increasing the number of allyloxy groups from one to two does not significantly impact catalyst responses to H2 or 1-hexene in ethylene polymerization.

FIG. 4C also provides polymer property data. The Mw molecular weights of the Met-1 homopolymer are 844.5 kg/mol (Example 1, Tables 1 and 2), and the Met-1 copolymer (soluble portion) of 558.9 kg/mol (Run J, Table 3), respectively, FIG. 4C. Both the Met-1 homopolymer and copolymer molecular weights are much lower than those of the Met-2 homopolymer of 988.0 kg/mol (Example 7, Tables 1 and 2), and the Met-2 copolymer of 698.6 kg/mol. While the second allyloxy group in Met-2 could contribute to the higher Mw of the resulting polymers, the lower activities of Met-2 may also play a role in polymer molecular weights. The rheological properties of the copolymer samples could not be obtained because they either did not melt or expanded/overloaded the normal force. FIG. 4D illustrates Janzen-Colby plots of selected homopolymers.

TABLE 5
Ethylene polymerization studies of Met-2 under hydrogen
concentrations and 1-hexene concentrations. ^{A}

| | | | Met. | | | | | |
|---|---|---|---|---|---|---|---|---|
| | H2 | C6 | Activity | Mn | Mw | Mz | | |
| Run No. | (ppm) | (g) | (g/g/h) ^{B} | (kg/mol) | (kg/mol) | (kg/mol) | Mw/Mn | Eta_0 |
| A | 0 | — | 292000 | 324.0 | 988.0 | 2160.1 | 3.1 | 1.52E+08 |
| B | 50 | — | 320000 | 314.2 | 986.7 | 2131.4 | 3.1 | 1.76E+08 |
| C | 100 | — | 324000 | 333.5 | 1004.7 | 2147.7 | 3.0 | 1.87E+08 |
| D | 150 | — | 336000 | 191.2 | 851.5 | 2136.1 | 4.5 | 1.26E+08 |
| E | 200 | — | 336000 | 61.9 | 597.3 | 1990.5 | 9.7 | 2.04E+08 |
| F | — | 0 | 152000 | 368.6 | 1423.6 | 3149.1 | 3.9 | 5.29E+08 |
| G | — | 9.5 | 176000 | 266.1 | 952.5 | 1923.8 | 3.6 | — |
| H | — | 19 | 232000 | 292.8 | 784.4 | 1483.9 | 2.7 | — |
| I | — | 28.5 | 304000 | 255.5 | 698.6 | 1323.4 | 2.7 | — |

^{A} Conditions for runs A-E: 0.5 mg of metallocene catalyst, 200 mg of m-SSA, 0.6 mL of TIBAL solution (1M in hexanes), 390 psi of ethylene, 90° C. for 30 minutes; conditions for runs F-I: 0.5 mg of catalyst, 200 mg of m-SSA, 0.6 mL of TIBAL solution (1M in hexanes), 340 psi of ethylene, 80° C. for 30 minutes.
^{B} Met. Activity (g/g/h) is the metallocene activity in units of g PE/(g metallocene · hour), i.e., grams of polyethylene per gram of metallocene per hour.

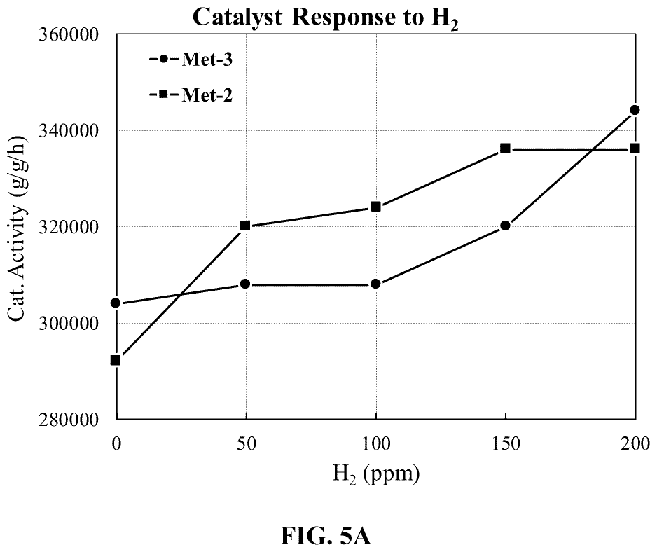

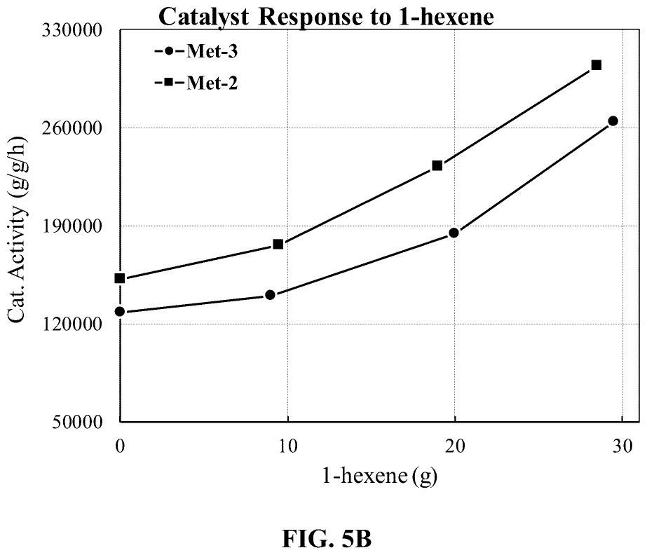

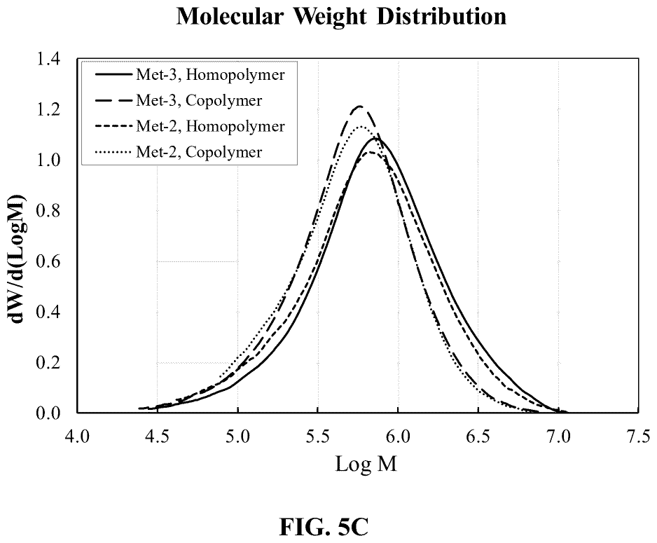

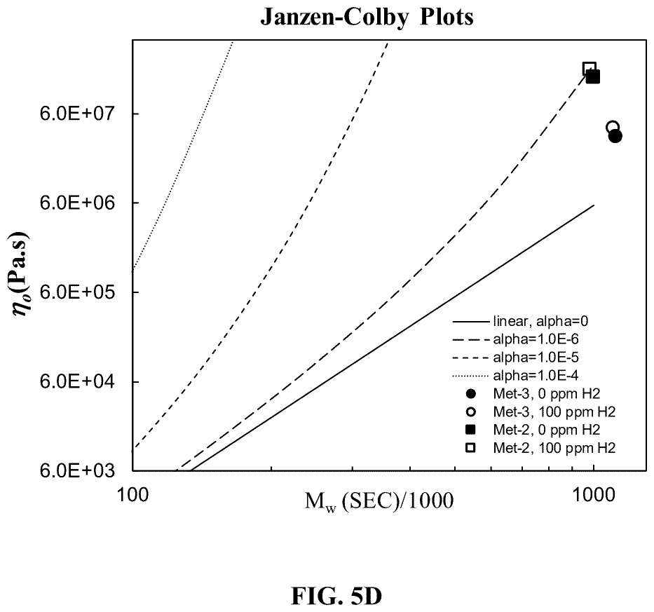

FIGS. 5A-5D present comparative data for the Met-2 metallocene with its two pendent allyloxyphenyl groups (4-allyl-O—C₆H₄) and the Met-3 metallocene with two pendent butenyloxyphenyl (4-buten-1-yl-O—C₆H₄) groups. Therefore, these metallocene catalysts differ only in the lengths of their unsaturated groups bonded to the phenylene moieties. The hydrogen response data of FIG. 5A demonstrate that both catalysts show slightly increased activities with increasing H2 concentration (0-200 ppm), and their activities generally comparable under these conditions. The copolymerization studies of FIG. 5B demonstrate that both catalysts show a similar 1-hexene response, with Met-2 exhibiting a slightly higher activity than Met-3. Overall, these comparisons suggest that the lengths of the unsaturated groups do not significantly impact catalyst performance under different polymerization conditions.

The MWD of selected homopolymers (no H2, 390 psi of ethylene, 90° C.) and copolymers (˜30 g of 1-hexene, 340 psi of ethylene, 80° C.) are illustrated in FIG. 5C. In all cases, the polymers made using Met-3 show somewhat higher molecular weights than polymers made using Met-2. While the length of the unsaturated groups in these catalysts might play a role in polymer molecular weight, the different activities of these metallocenes could also contribute to the polymer molecular weight. FIG. 5D illustrates Janzen-Colby plots of selected homopolymers made using Met-2 and Met-3.

Regarding the activity of the activator-support (SSA), this disclosure provides catalyst compositions, processes for polymerizing olefins, and a method of making catalyst compositions in which the catalyst composition can be characterized by an activator-support or SSA activity in a range from about 1,000 g PE/(g activator-support·hour) (grams of polyethylene per gram of activator-support per hour, or “g/(g·h)” in this Aspect) to about 55,000 g PE/(g activator-support·hour), alternatively from about 2,000 g/(g·h) to about 50,000 g/(g·h), or alternatively from about 3,000 g/(g·h) to about 45,000 g/(g·h), wherein the grams of activator-support is the grams of the SSA.

This disclosure also describes catalyst compositions, processes for polymerizing olefins, and methods of making catalyst compositions in which the catalyst compositions can be characterized by a metallocene activity in a range from about 100,000 g PE/(g metallocene·hour) (grams of polyethylene per gram of metallocene per hour, or “g/(g·h)” in this Aspect) to about 1,000,000 g PE/(g metallocene·hour), from about 150,000 g/(g·h) to about 800,000 g/(g·h), or from about 200,000 g/(g·h) to about 600,000 g/(g·h).

In further aspects, the polyolefin prepared according to the disclosed process for polymerizing olefins, when the polyolefin is an ethylene homopolymer, can be characterized by any one or any combination of the following properties:
(a) a polydispersity index (molecular weight distribution, Mw/Mn) of from 1.5 to 10, alternatively from 1.7 to 9, or alternatively from 2.0 to 8.5;
(b) a weight average molecular weight (Mw) in the absence of hydrogen of from 100 kg/mol to 2,000 kg/mol, alternatively from 200 kg/mol to 1,500 kg/mol, or alternatively from 300 kg/mol to 1,200 kg/mol; and/or
(c) a Janzen-Colby η(0) value of from 0.5 to 20 long chain branches (LCB) per 10⁶ carbon atoms (“LCB/10⁶C”), alternatively from 1 to 18 LCB/10⁶C, or alternatively from 5 to 15 LCB/10⁶C.

In other aspects, the polyolefin prepared according to the disclosed process for polymerizing olefins, when the polyolefin is an ethylene-α-olefin copolymer characterized by any one or any combination of the following properties:
(a) a polydispersity index (molecular weight distribution, Mw/Mn) of from 1.5 to 13.5, alternatively, from 1.7 to 13, or alternatively from 2.0 to 12.5;
(b) a weight average molecular weight (Mw) in the absence of hydrogen of from 100 kg/mol to 2,500 kg/mol, alternatively from 200 kg/mol to 2,000 kg/mol, or alternatively from 400 kg/mol to 1,500 kg/mol; and/or
(c) a Janzen-Colby η(0) value of from 5 to 100 long chain branches (LCB) per 10⁶ carbon atoms (“LCB/10⁶C”), alternatively from 10 to 80 LCB/10⁶C, or alternatively from 14 to 60 LCB/10⁶C.

### Articles

This disclosure also provides, in an aspect, a method for forming or preparing an article of manufacture comprising an olefin polymer, in which the method can comprise:
a) performing the olefin polymerization process according to any process disclosed herein; and
b) fabricating the article of manufacture comprising the olefin polymer by any technique disclosed herein.

In another aspect, the article of manufacture comprising the olefin polymer that can be fabricated or made can be, for example, an agricultural film, an automobile part, a bottle, a drum, a fiber or fabric, a food packaging film or container, a container preform, a food service article, a fuel tank, a geomembrane, a household container, a liner, a molded product, a medical device or material, a pipe, a sheet or tape, or a toy.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, may suggest themselves to one of ordinary skill in the art without departing from the spirit of the present invention or the scope of the appended claims.

### EXAMPLES

In the following examples, unless otherwise specified, the syntheses and preparations described therein were carried out under an inert atmosphere such as nitrogen and/or argon. Solvents were purchased from commercial sources as anhydrous solvents or were dried prior to use. Unless otherwise specified, reagents were obtained from commercial sources.

### General Considerations

All manipulations using air sensitive reagents were performed under standard Schlenk line or dry box techniques. Anhydrous solvents (e.g., Et₂O, CH₂Cl₂, THF, and pentane), n-BuLi, ZrCl₄, 4-hydroxybenzophenone, 4,4′-dihydroxybenzophenone, and allyl bromide were purchased from Sigma-Aldrich. 4-Bromo-1-butene was purchased from Eburon Organics USA Inc. and stored in the refrigerator. 2,7-t-Bu₂-fluorene was made by Degussa GmbH. CpMgCl (1M in THF) was purchased from Boulder Scientific Company and stored in the glovebox under an inert atmosphere. NMR solvents C₆D₆ and CDCl₃ were from Cambridge Isotope Laboratories. All chemicals were used as received, and reactions were not optimized.

### Ligand Syntheses

General Procedure for the Synthesis of 4-Substituted Benzophenone. Hydroxy-benzophenone (1.0 equiv.), allyl bromide or 4-bromo-1-butene (1.1 equiv. for 4-hydroxy-benzophenone; 2.1 equiv. for 4,4′-dihydroxybenzophenone), K₂CO₃ (2-4 equiv.) and acetone (˜200 mL) were loaded into a 500 mL flask. The reaction content was stirred at 50° C. for 4-6 hours. The reaction mixture was then filtered using a glass-frit; the solid material on the glass-frit was washed with 100-300 mL of acetone. The combined organic solution was evaporated to give a pale-yellow solid, which was washed with a small amount of cold MeOH to give the desired product as a white solid.

4,4′-di(allyloxy)benzophenone. A white solid (70%). ¹H NMR (CDCl3, 300 MHz): δ 7.77 (d, J=8.8 Hz, 4H), 6.96 (d, J=8.8 Hz, 4H), 6.00-6.13 (m, 2H), 5.30-5.47 (m, 4H), 4.61 (d, J=5.2 Hz, 4H).

4,4′-di(but-3-en-1-yloxy)benzophenone. A white solid (23%, due possibly to the slow reaction rate). ¹H NMR (CDCl3, 300 MHz): δ 7.76 (d, J=8.8 Hz, 4H), 6.95 (d, J=8.8 Hz, 4H), 5.84-5.98 (m, 2H), 5.11-5.22 (m, 4H), 4.09 (t, J=6.7 Hz, 4H), 2.58 (q, J=6.7 Hz, 4H).

4-(allyloxy)benzophenone. A white solid (94%). ¹H NMR (CDCl₃, 75 MHz): δ 7.70-7.88 (m, 4H), 7.44-7.58 (m, 3H), 6.92-7.03 (m, 2H), 5.92-6.26 (m, 1H), 5.25-5.54 (m, 2H), 4.55-4.66 (m, 2H).

General Procedure for the Synthesis of Fulvene Compounds. In the glovebox, a 250 mL Schlenk flask was charged with a 4-substituted benzophenone compound (20-40 mmol, 1.0 equiv.), 20-40 mL of anhydrous THF, and a magnetic stir bar. With stirring, a CpMgCl solution (1.3 equiv., 1 M in THF) was added into the flask at room temperature. The resulting reaction mixture was then heated to 60-65° C. under N₂. At this temperature, the reaction progress was monitored by GC-MS analysis of aliquots of the reaction content that were quenched with water. After the reaction was complete (e.g., >95% conversion of benzophenone, usually within 1-6 hours), the reaction mixture was cooled to 0° C., quenched with 5% HCl aqueous solution (50-100 mL), and extracted with Et₂O (50 mL, 2-3 times). The combined organic phase was washed with a saturated NaHCO₃ solution (30 mL, 2 times) and water (30 mL), and dried over anhydrous MgSO₄. Evaporation of volatiles usually gave a dark red residue, which was then purified by column chromatography (0.2% ethyl acetate/n-hexane) to give the desired fulvene.

6,6-(4-allyloxyphenyl)2-fulvene. This compound was purified by column chromatography (0.2% ethyl acetate/n-hexane) and isolated as a dark red, thick oil (84%). ¹H NMR (CDCl3, 300 MHz): δ 7.28 (d, J=8.6 Hz, 4H), 6.94 (d, J=8.6 Hz, 4H), 6.61 (d, J=4.5 Hz, 2H), 6.32 (d, J=4.5 Hz, 2H), 6.04-6.17 (m, 2H), 5.32-5.49 (m, 4H), 4.61 (d, J=5.3 Hz, 4H).

6,6-(4-butenyloxyphenyl)2-fulvene. This compound was purified by washing the crude product with cold MeOH and isolated as a red solid (95%). ¹H NMR (CDCl3, 300 MHz): δ 7.26 (d, J=8.6 Hz, 4H), 6.90 (d, J=8.6 Hz, 4H, 6.59 (d, J=3.6 Hz, 2H, 6.30 (d, J=3.6 Hz, 2H), 5.86-5.99 (m, 2H), 5.11-5.22 (m, 4H), 4.07 (t, J=6.7 Hz, 4H), 2.57 (q, J=6.7 Hz, 4H).

6-(4-allyloxyphenyl)-6-phenyl-fulvene. This compound was purified by column chromatography (0.2% ethyl acetate/n-hexane) and isolated as a dark red, thick oil (86%). ¹H NMR (CDCl3, 75 MHz): δ 7.20-7.34 (m, 7H), 6.84-6.95 (m, 2H), 6.55-6.61 (m, 1H), 5.85-6.37 (m, 3H), 5.22-5.51 (m, 2H), 4.53-4.61 (m, 2H).

General Procedure for the Synthesis of Cyclopentadienyl-Fluorenyl Ligands. In a typical reaction, a solution of 2,7-t-Bu₂-fluorene (4-6 mmol, 1.0 equiv.) in Et₂O (40-50 mL) was cooled to −78° C. A quantity of n-BuLi (1.05 equiv., 1.6 M in hexanes) was added into the mixture via a syringe (usually within 1-3 minutes). The reaction content was warmed to room temperature and stirred for 6-8 hours. A fulvene (1.1-1.3 equiv.) solution in Et₂O (10-20 mL) was then added into the fluorenyllithium solution at room temperature. After stirring for 16 hours, the reaction mixture was quenched with water (˜30 mL) and extracted with Et₂O (˜30 mL). The combined organic phase was washed with water, dried over anhydrous MgSO₄, and evaporated to give a crude product (usually a thick oil). Trituration of the crude product with cold MeOH (−20° C.) gave a solid, which was then filtered using a glass frit, washed with some cold MeOH, and dried under vacuum to give the targeted ligand as a white or off-white solid.

[Flu-(4-allylO-Ph)2C-Cp]. A beige solid (64%). ¹H NMR (CDCl₃, 300 MHz): δ 7.31-7.37 (m, 4H), 7.15-7.22 (m, 5H), 6.20-6.83 (m, 9H), 5.95-6.14 (m, 2H), 5.23-5.39 (m, 5H), 4.45-4.54 (m, 4H), 2.85-3.02 (m, 1H), 1.15-1.32 (m, 18H).

[Flu-(4-butenylO-Ph)₂C-Cp]. A beige solid (77%). ¹H NMR (CDCl3, 300 MHz): δ 7.34-7.37 (m, 3H), 7.13-7.19 (m, 6H), 6.08-6.92 (m, 8H), 5.81-5.95 (m, 2H), 5.33-5.35 (1H), 5.07-5.17 (m, 4H), 4.07 (t, J=6.7 Hz, 4H), 2.48-2.59 (m, 4H), 1.12-1.19 (18H).

[Flu-(4-allylO-Ph)(Ph)C-Cp]. An off-white solid (94%). ¹H NMR (CDCl3, 75 MHz): δ 7.26-7.41 (m, 5H), 6.81-7.20 (m, 9H), 5.80-6.86 (m, 6H), 5.21-5.42 (m 3H), 4.44-4.50 (m, 2H), 2.90-3.02 (m, 1H), 1.14-1.18 (18H).

General Procedure for the Synthesis of Metallocenes. In a typical reaction, a ligand compound (˜0.5 mmol, 1.0 equiv.) and KH (2.2-2.6 equiv.) were charged into a Schlenk tube. Upon addition of anhydrous THF (˜15 mL) at room temperature and stirring, bubble formation occurred immediately. Concurrently, the reaction content gradually changed from colorless to dark red (or purple red). After stirring at room temperature for 5-8 hours (bubble formation stopped), the dark (or purple) red mixture was filtered using a syringe filter, and the filtrate was transferred into a suspension of ZrCl₄ (1.1 equiv.) in toluene (˜15 mL) at room temperature. After stirring at room temperature for 16 hours, the reaction mixture was held under vacuum to give a red residue, which was then extracted with anhydrous CH₂Cl₂ (10-20 mL). The mixture was then filtered using a syringe filter (0.25-0.45 μm); the filtrate was evaporated to dryness, usually giving the desired metallocene as a red solid.

[2,7-t-butylfluorenyl((4-allyl-O—C₆—H₄)PhC)Cp]ZrCl₂ (Met-1). A dark red solid (81%). ¹H NMR (C₆D₆, 75 MHz): δ 7.55-8.01 (m, 8H), 6.95-7.10 (m, 3H), 6.49-6.81 (m, 4H), 6.18-6.25 (m, 2H), 5.56-5.89 (m, 3H), 4.94-5.27 (m, 2H), 4.10 (d, J=4.4 Hz, 2H), 1.12-1.13 (18H).

[2,7-t-butylfluorenyl((4-allyl-O—C₆—H₄)₂C)Cp]ZrCl₂ (Met-2). A dark red solid (80%). ¹H NMR (C₆D₆, 300 MHz): δ 7.94 (d, J=8.8 Hz, 2H), 7.49-7.65 (m, 6H), 6.79-6.82 (m, 4H), 6.61 (s, 2H), 6.21-6.23 (m, 2H), 5.70-5.83 (m, 4H), 4.99-5.22 (m, 4H), 4.43 (d, J=5.1 Hz, 4H), 1.14 (s, 18H).

[2,7-t-butylfluorenyl((4-buten-1-yl-O—C₆H₄)₂C)Cp]ZrCl₂ (Met-3). A dark red solid (71%). ¹H NMR (C₆D₆, 75 MHz): δ 7.91-8.01 (2H), 7.50-7.68 (m, 7H), 6.63-6.86 (m, 5H), 6.22-6.27 (m, 2H), 5.51-5.93 (m, 4H), 4.90-5.09 (m, 4H), 3.64 (t, J=6.1 Hz, 4H), 2.27 (q, J=6.1 Hz, 4H), 1.15 (s, 18H).

[2,7-t-butylfluorenyl(Ph₂C)(3-penten-1-yl-Cp)]ZrCl₂. An orange-red, crystalline solid. ¹H NMR (C₆D₆, 300 MHz): δ 7.95-7.99 (m. 2H), 7.86 (t, J=7.7 Hz, 2H), 7.65 (d, J=8.0 Hz, 2H), 7.57 (td, J1=7.7 Hz, J2=1.6 Hz, 2H), 6.89-7.14 (m, 6H), 6.50 (2H), 6.09 (t, J=2.8 Hz, 1H), 5.77 (t, J=3.1 Hz, 1H), 5.59-5.72 (m, 1H), 5.56 (t, J=2.9 Hz, 1H), 4.88-4.99 (m, 2H), 2.46-2.52 (m, 2H), 1.90-1.96 (m, 2H), 1.54-1.63 (m, 2H), 1.13 (s, 9H), 1.11 (s, 9H).

General Procedure for Polymerization Studies. All polymerization runs were conducted in a one-gallon stainless steel reactor. In a typical run, 0.5 mL of a metallocene solution in toluene (1 mg of metallocene/mL), 0.6 mL of triisobutylaluminum solution (1.0 M in heptane), and ˜200 mg of fluorided silica-coated alumina were loaded into the reactor through a charge port while slowly venting isobutane vapor. The charge port was then closed, and isobutane (˜2 L) was added. The reaction content was stirred and heated to the desired temperature. In H₂ studies (390 psi of ethylene, 90° C. for 30 minutes), H₂ and ethylene were introduced into the reactor simultaneously at the target ratio. In 1-hexene studies (340 psi of ethylene, 80° C. for 30 minutes), ethylene and 1-hexene were introduced into the reactor simultaneously, with 1-hexene feeding rate at ˜5 g/minute until the target amount is reached. During polymerization, ethylene was fed on demand to maintain the target pressure; the reactor temperature was maintained at the desired temperature throughout the run by an automated heating-cooling system. After running for the pre-planned time (e.g., 30 minutes), all feeds were closed. The reactor was vented and then cooled to ambient conditions. The resulting polymer fluff was removed from the rector, dried in a vacuum oven at 50° C., and then weighed.

These and other aspects, examples, and embodiments of the invention can be further described in the numbered Aspects of the Disclosure that are set out below.

### ASPECTS OF THE DISCLOSURE

### Catalyst Compositions, Processes for Polymerizing Olefins, and Methods of Making Catalyst Compositions

Aspect 1. A catalyst composition for polymerizing olefins, the catalyst composition comprising the contact product of:
(a) a metallocene compound having the formula:

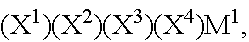

wherein
   M¹ is titanium, zirconium, or hafnium;
   X¹ is a substituted or an unsubstituted cyclopentadienyl ligand, wherein substituents, when present, are selected independently from a C₁-C₂₀ hydrocarbyl group;
   X² is a substituted or an unsubstituted fluorenyl ligand, wherein substituents, when present, are selected independently from a C₁-C₂₀ hydrocarbyl group;
   X¹ and X² are bridged by a linking group having the formula >C[C₆H₂R¹R²₂][R³], wherein
      R¹ is —O(CH₂)ₘCH═CH₂;
      R² in each occurrence is selected independently from H or a C₁-C₂₀ hydrocarbyl group;
      R³ is H, a C₁-C₂₀ hydrocarbyl group, or [C₆H₂R⁴R⁵₂];
      R⁴ is H, a C₁-C₂₀ hydrocarbyl group, or —O(CH₂)ₙCH═CH₂;
      R⁵ in each occurrence is selected independently from H or a C₁-C₂₀ hydrocarbyl group; and
      m and n in each occurrence are selected independently from an integer from 1 to 20; and
   X³ and X⁴ are independently a monoanionic ligand;
(b) a metallocene activator or any components thereof; and
(c) optionally, a co-catalyst.

Aspect 2. A process for polymerizing olefins, the process comprising contacting at least one olefin monomer and a catalyst composition under polymerization conditions to form a polyolefin, wherein the catalyst composition comprises the contact product of:
(a) a metallocene compound having the formula:

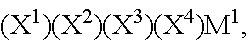

wherein
   M¹ is titanium, zirconium, or hafnium;
   X¹ is a substituted or an unsubstituted cyclopentadienyl ligand, wherein substituents, when present, are selected independently from a C₁-C₂₀ hydrocarbyl group;
   X² is a substituted or an unsubstituted fluorenyl ligand, wherein substituents, when present, are selected independently from a C₁-C₂₀ hydrocarbyl group;
   X¹ and X² are bridged by a linking group having the formula >C[C₆H₂R¹R²₂][R³], wherein
      R¹ is —O(CH₂)ₘCH═CH₂;
      R² in each occurrence is selected independently from H or a C₁-C₂₀ hydrocarbyl group;
      R³ is H, a C₁-C₂₀ hydrocarbyl group, or [C₆H₂R⁴R⁵₂];
      R⁴ is H, a C₁-C₂₀ hydrocarbyl group, or —O(CH₂)ₙCH═CH₂;
      R⁵ in each occurrence is selected independently from H or a C₁-C₂₀ hydrocarbyl group; and
      m and n in each occurrence are selected independently from an integer from 1 to 20; and
   X³ and X⁴ are independently a monoanionic ligand;
(b) a metallocene activator or all components thereof; and
(c) optionally, a co-catalyst.

Aspect 3. A method of making a catalyst composition, the method comprising contacting in any order:
(a) a metallocene compound having the formula:

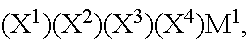

wherein
   M¹ is titanium, zirconium, or hafnium;
   X¹ is a substituted or an unsubstituted cyclopentadienyl ligand, wherein substituents, when present, are selected independently from a C₁-C₂₀ hydrocarbyl group;
   X² is a substituted or an unsubstituted fluorenyl ligand, wherein substituents, when present, are selected independently from a C₁-C₂₀ hydrocarbyl group;
   X¹ and X² are bridged by a linking group having the formula >C[C₆H₂R¹R²₂][R³], wherein
      R¹ is —O(CH₂)ₘCH═CH₂;
      R² in each occurrence is selected independently from H or a C₁-C₂₀ hydrocarbyl group;
      R³ is H, a C₁-C₂₀ hydrocarbyl group, or [C₆H₂R⁴R⁵₂];
      R⁴ is H, a C₁-C₂₀ hydrocarbyl group, or —O(CH₂)ₙCH═CH₂;
      R⁵ in each occurrence is selected independently from H or a C₁-C₂₀ hydrocarbyl group; and
      m and n in each occurrence are selected independently from an integer from 1 to 20; and
   X³ and X⁴ are independently a monoanionic ligand;
(b) a metallocene activator or any components thereof; and
(c) optionally, a co-catalyst.

Aspect 4. A catalyst composition, a process for polymerizing olefins, or a method of making a catalyst composition according to any preceding Aspect, wherein M¹ is Ti; alternatively, M¹ is Zr; alternatively, M¹ is Hf; or alternatively, M¹ is Zr or Hf.

Aspect 5. A catalyst composition, a process for polymerizing olefins, or a method of making a catalyst composition according to any preceding Aspect, wherein X³ and X⁴ are independently halide, hydride, a C₁-C₂₀ hydrocarbyl group, a C₁-C₂₀ heterohydrocarbyl group, tetrahydroborate, OBR^{A}₂, OSO₂R^{A}, or NR^{A}₂ wherein R^{A} is independently a C₁-C₁₂ hydrocarbyl group.

Aspect 6. A catalyst composition, a process for polymerizing olefins, or a method of making a catalyst composition according to any preceding Aspect, wherein X³ and X⁴ are selected independently from F, Cl, Br, a hydride, a C₁-C₁₂ hydrocarbyl group, a C₁-C₁₂ hydrocarbyloxide group, or an SiR^{D}₃-substituted C₁ to C₁₂ hydrocarbyl group wherein R^{D} is independently a C₁ to C₈ hydrocarbyl group.

Aspect 7. A catalyst composition, a process for polymerizing olefins, or a method of making a catalyst composition according to any preceding Aspect, wherein X³ and X⁴ are selected independently from Cl or Br.

Aspect 8. A catalyst composition, a process for polymerizing olefins, or a method of making a catalyst composition according to any preceding Aspect, wherein the substituent on X¹ and the substituent on X², when present, are selected independently from a C₁ to C₁₅ hydrocarbyl group; a C₁ to C₁₀ hydrocarbyl group, a C₁ to C₈ hydrocarbyl group, or a C₁ to C₆ hydrocarbyl group.

Aspect 9. A catalyst composition, a process for polymerizing olefins, or a method of making a catalyst composition according to any preceding Aspect, wherein the substituent on X¹ and the substituent on X², when present, are selected independently from a C₁-C₂₀ aliphatic group, a C₆-C₂₀ aromatic group, a C₁-C₁₂ aliphatic group, a C₆-C₁₂ aromatic group, a C₁-C₁₀ aliphatic group, or a C₆-C₁₀ aromatic group, wherein the carbon count includes any hydrocarbyl substituent or branch on the aliphatic group or the aromatic group.

Aspect 10. A catalyst composition, a process for polymerizing olefins, or a method of making a catalyst composition according to any preceding Aspect, wherein the substituent on X¹ and X², when present, is selected independently from a C₁-C₁₂ alkyl, a C₂-C₁₂ alkenyl, a C₃-C₇ cycloalkyl, a C₆-C₁₀ aryl, or a C₇-C₁₂ aralkyl.

Aspect 11. A catalyst composition, a process for polymerizing olefins, or a method of making a catalyst composition according to any preceding Aspect, wherein the C₁-C₂₀ hydrocarbyl group, when present as a substituent on X¹ or X², is selected independently from methyl, ethyl, i-propyl, n-propyl, t-butyl, n-butyl, n-hexyl, or phenyl.

Aspect 12. A catalyst composition, a process for polymerizing olefins, or a method of making a catalyst composition according to any preceding Aspect, wherein:
(a) X¹ is an unsubstituted cyclopentadienyl and X² is an unsubstituted fluorenyl;
(b) X¹ is an unsubstituted cyclopentadienyl and X² is 2,7-di-t-butyl-fluorenyl;
(c) X¹ is a substituted cyclopentadienyl and X² is an unsubstituted fluorenyl; or
(d) X¹ is a substituted cyclopentadienyl and X² is 2,7-di-t-butyl-fluorenyl.

Aspect 13. A catalyst composition, a process for polymerizing olefins, or a method of making a catalyst composition according to any preceding Aspect, wherein n and m are independently an integer from 1 to 15, alternatively an integer from 1 to 12, alternatively an integer from 1 to 6, alternatively an integer from 1 to 4, or alternatively 1, 2, or 3.

Aspect 14. A catalyst composition, a process for polymerizing olefins, or a method of making a catalyst composition according to any preceding Aspect, wherein n and m are both 1, alternatively n and m are both 2, alternatively n and m are both 3, alternatively n and m are both 4, or alternatively n and m are both 5.

Aspect 15. A catalyst composition, a process for polymerizing olefins, or a method of making a catalyst composition according to any preceding Aspect, wherein independently:
R¹ is bonded to the 3-, 4-, or 5-position of the C₆H₂R¹R²₂ group; and
R is bonded to the 3-, 4-, or 5-position of the C₆H₂R⁴R⁵₂ group.

Aspect 16. A catalyst composition, a process for polymerizing olefins, or a method of making a catalyst composition according to any preceding Aspect, wherein independently:
R¹ and the independently selected R² groups are bonded to and distributed among the 3-, 4-, and 5-positions of the C₆H₂R¹R²₂ moiety; and
R⁴ and the independently selected R⁵ groups are bonded to and distributed among the 3-, 4-, and 5-positions of the C₆H₂R⁴R⁵₂ moiety.

Aspect 17. A catalyst composition, a process for polymerizing olefins, or a method of making a catalyst composition according to any preceding Aspect, wherein independently:
(a) R¹ is bonded to the 4-position and the independently selected R² groups are bonded to and distributed between the 3- and 5-positions of the C₆H₂R¹R²₂ moiety; and
R⁴ is bonded to the 4-position and the independently selected R⁵ groups are bonded to and distributed between the 3- and 5-positions of the C₆H₂R⁴R⁵₂ moiety;
(b) R¹ is bonded to the 3-position and the independently selected R² groups are bonded to and distributed between the 4- and 5-positions of the C₆H₂R¹R²₂ moiety; and
R⁴ is bonded to the 3-position and the independently selected R⁵ groups are bonded to and distributed between the 4- and 5-positions of the C₆H₂R⁴R⁵₂ moiety;
(c) R¹ is bonded to the 4-position and the independently selected R² groups are bonded to and distributed between the 3- and 5-positions of the C₆H₂R¹R²₂ moiety; and
R⁴ is bonded to the 3-position and the independently selected R⁵ groups are bonded to and distributed between the 4- and 5-positions of the C₆H₂R⁴R⁵₂ moiety;

or
(d) R¹ is bonded to the 3-position and the independently selected R² groups are bonded to and distributed between the 4- and 5-positions of the C₆H₂R¹R²₂ moiety; and
R⁴ is bonded to the 4-position and the independently selected R⁵ groups are bonded to and distributed between the 3- and 5-positions of the C₆H₂R⁴R⁵₂ moiety;

Aspect 18. A catalyst composition, a process for polymerizing olefins, or a method of making a catalyst composition according to any preceding Aspect, wherein the linking group has the formula:

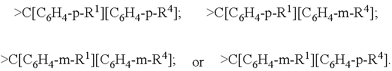

Aspect 19. A catalyst composition, a process for polymerizing olefins, or a method of making a catalyst composition according to any preceding Aspect, wherein independently:
R¹ is bonded to the 4-position of the C₆H₂R¹R²₂ group; and
R⁴ is bonded to the 4-position of the C₆H₂R⁴R⁵₂ group.

Aspect 20. A catalyst composition, a process for polymerizing olefins, or a method of making a catalyst composition according to any preceding Aspect, wherein:
R¹ and R⁴ are selected independently from OCH₂CH═CH₂, O(CH₂)₂CH═CH₂, O(CH₂)₃CH═CH₂, O(CH₂)₄CH═CH₂, O(CH₂)₅CH═CH₂, or O(CH₂)₆CH═CH₂.

Aspect 21. A catalyst composition, a process for polymerizing olefins, or a method of making a catalyst composition according to any preceding Aspect, wherein R³ is C₆H₂R⁴R⁵₂, and R⁴ and R⁵ in each occurrence is H.

Aspect 22. A catalyst composition, a process for polymerizing olefins, or a method of making a catalyst composition according to any preceding Aspect, wherein R² and R⁵ in each occurrence is selected independently from H, methyl, ethyl, i-propyl, n-propyl, t-butyl, n-butyl, n-hexyl, or phenyl.

Aspect 23. A catalyst composition, a process for polymerizing olefins, or a method of making a catalyst composition according to any preceding Aspect, wherein the metallocene compound has the formula:

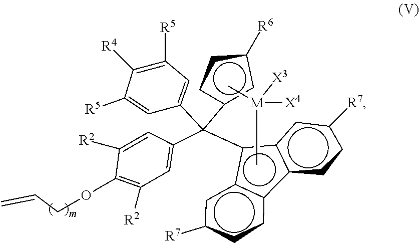

wherein
M is Zr or Hf;
X³ and X⁴ are both Cl or both Br;
R⁴ is H or —O(CH₂)ₙCH═CH₂;
R², R⁵, and R⁶ in each occurrence are selected independently from H, methyl, ethyl, n-propyl, i-propyl, or t-butyl;
R⁷ is H, methyl, or t-butyl; and
m and n are selected independently from 1, 2, 3, 4, 5, 6, 7, or 8.

Aspect 24. A catalyst composition, a process for polymerizing olefins, or a method of making a catalyst composition according to any preceding Aspect, wherein the metallocene compound has the formula:

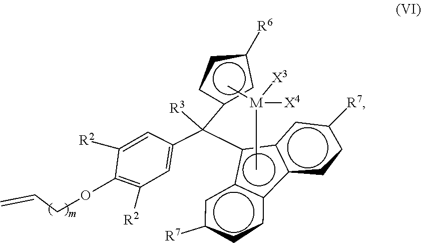

wherein
M is Zr or Hf;
X³ and X⁴ are both Cl or both Br;
R² in each occurrence, R³, and R⁶ are selected independently from H, methyl, ethyl, n-propyl, i-propyl, t-butyl, or phenyl;
R⁷ is H, methyl, or t-butyl; and
m is selected from 1, 2, 3, 4, 5, 6, 7, or 8.

Aspect 25. A catalyst composition, a process for polymerizing olefins, or a method of making a catalyst composition according to any preceding Aspect, wherein the metallocene compound has the formula:

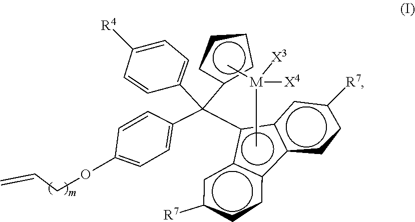

wherein
M is Zr or Hf;
X³ and X⁴ are both Cl or both Br;
R⁴ is H or —O(CH₂)ₙCH═CH₂;
R⁷ is H, methyl, or t-butyl; and
m and n are selected independently from 1, 2, 3, 4, 5, 6, 7, or 8.

Aspect 26. A catalyst composition, a process for polymerizing olefins, or a method of making a catalyst composition according to any preceding Aspect, wherein the metallocene compound has the formula:

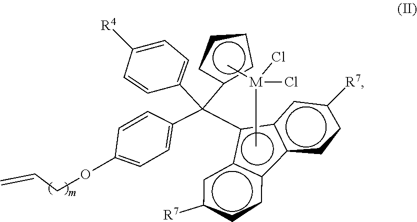

wherein
M is Zr or Hf;
R⁴ is H or —O(CH₂)ₙCH═CH₂;
R⁷ is H or t-butyl; and
m and n are selected independently from 1, 2, 3, 4, 5, or 6.

Aspect 27. A catalyst composition, a process for polymerizing olefins, or a method of making a catalyst composition according to any preceding Aspect, wherein the metallocene compound has the formula:

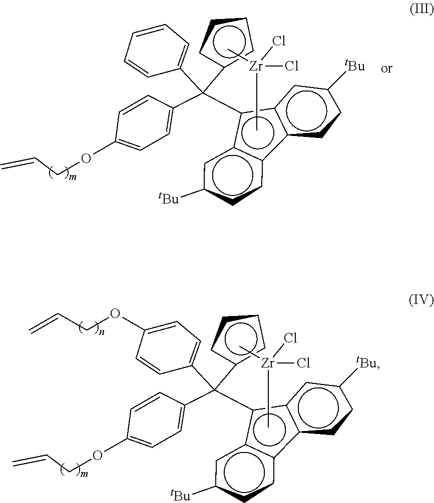

wherein m and n are selected independently from 1, 2, 3, 4, or 5.

Aspect 28. A catalyst composition, a process for polymerizing olefins, or a method of making a catalyst composition according to any preceding Aspect, wherein the metallocene compound has the formula:

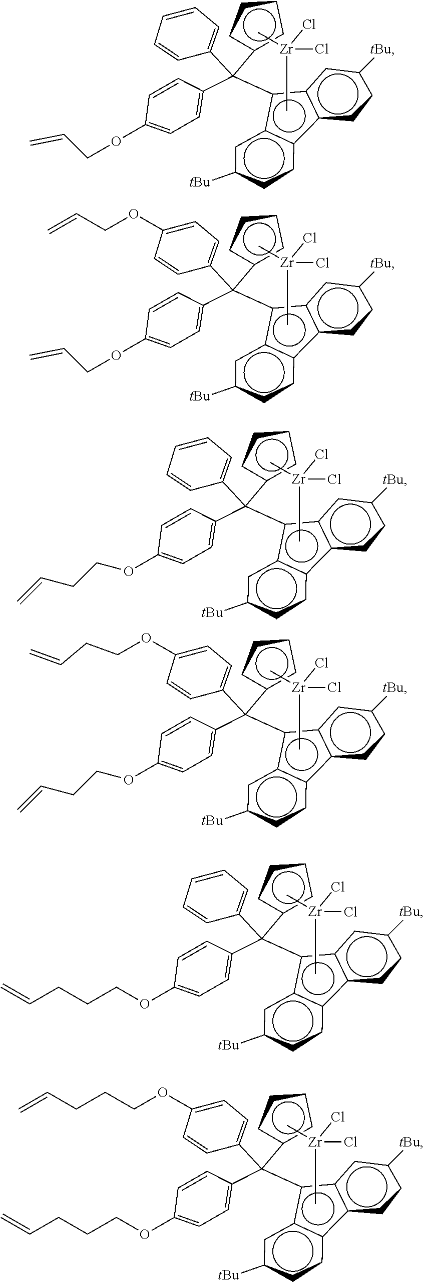

or any combination thereof.

Aspect 29. A catalyst composition, a process for polymerizing olefins, or a method of making a catalyst composition according to any preceding Aspect, wherein the catalyst composition is absent any other (e.g., second) metallocene compound, or wherein the contacting step is absent any other (e.g., second) metallocene compound.

### Metallocene Activators

Aspect 30. A catalyst composition, a process for polymerizing olefins, or a method of making a catalyst composition according to any preceding Aspect, wherein:
the metallocene activator comprises, consists essentially of, or is selected from an activator-support comprising a solid oxide treated with an electron-withdrawing anion (“SSA”, or solid super-acid), an organoboron compound, an organoborate compound, an ionizing ionic compound, an aluminoxane compound, or any combination thereof, such as organoboron compounds, organoborate compounds, or ionizing ionic compounds disclosed in U.S. Pat. Nos. 5,576,259, 5,807,938, 5,919,983, 11,186,665, and 11,325,938, each of which is incorporated by reference.

Aspect 31. A catalyst composition, a process for polymerizing olefins, or a method of making a catalyst composition according to any preceding Aspect, wherein the metallocene activator comprises a solid oxide treated with an electron-withdrawing anion (referred to as a “SSA” or solid super-acid or an activator-support).

Aspect 32. A catalyst composition, a process for polymerizing olefins, or a method of making a catalyst composition according to any of Aspects 30-31, wherein the solid oxide comprises or is selected from Al₂O₃, B₂O₃, BeO, Bi₂O₃, CdO, Co₃O₄, Cr₂O₃, CuO, Fe₂O₃, Ga₂O₃, La₂O₃, Mn₂O₃, MoO₃, Na₂O, NiO, P₂O₅, Sb₂O₅, SiO₂, SnO₂, SrO, ThO₂, TiO₂, V₂O₅, WO₃, Y₂O₃, ZnO, ZrO₂, K₂O, CaO, Ce₂O₃, mixtures thereof, mixed oxides thereof, and any combinations thereof.

Aspect 33. A catalyst composition, a process for polymerizing olefins, or a method of making a catalyst composition according to any of Aspects 30-32, wherein the solid oxide comprises or is selected from silica, alumina, titania, zirconia, magnesia, boria, calcia, zinc oxide, silica-alumina, silica-coated alumina, silica-titania, silica-zirconia, silica-magnesia, alumina-titania, alumina-zirconia, zinc-aluminate, alumina-boria, silica-boria, aluminum phosphate, aluminophosphate, aluminophosphate-silica, magnesium aluminate, titania-zirconia, mullite, boehmite, heteropolytungstates, mixed oxides thereof, a pillared clay such as a pillared montmorillonite, or any combination thereof.

Aspect 34. A catalyst composition, a process for polymerizing olefins, or a method of making a catalyst composition according to any of Aspects 30-33, wherein the electron-withdrawing anion comprises or is selected from fluoride, chloride, bromide, iodide, sulfate, bisulfate, fluorosulfate, phosphate, fluorophosphate, triflate, mesylate, tosylate, thiosulfate, C₁-C₁₀ alkyl sulfonate, C₆-C₁₄ aryl sulfonate, trifluoroacetate, fluoroborate, fluorozirconate, fluorotitanate, or any combination thereof.

Aspect 35. A catalyst composition, a process for polymerizing olefins, or a method of making a catalyst composition according to any of Aspects 30-34, wherein the solid oxide treated with an electron-withdrawing anion comprises at least one solid oxide treated with at least two electron-withdrawing anions, and wherein the at least two electron-withdrawing anions comprise or are selected from fluoride and phosphate, fluoride and sulfate, chloride and phosphate, chloride and sulfate, triflate and sulfate, or triflate and phosphate.

Aspect 36. A catalyst composition, a process for polymerizing olefins, or a method of making a catalyst composition according to any of Aspects 30-35, wherein the solid oxide treated with an electron-withdrawing anion is generated by treatment of a solid oxide with sulfuric acid, sulfate ion, bisulfate ion, fluorosulfuric acid, fluorosulfate ion, phosphoric acid, phosphate ion, fluorophosphoric acid, monofluorophosphate ion, triflic (trifluoromethane-sulfonic) acid, triflate trifluoromethanesulfonate) ion, methanesulfonic acid, mesylate (methanesulfonate) ion, toluenesulfonic acid, tosylate (toluenesulfonate) ion, thiosulfate ion, C₁-C₁₀ alkyl sulfonic acid, C₁-C₁₀ alkyl sulfonate ion, C₆-C₁₄ aryl sulfonic acid, C₆-C₁₄ aryl sulfonate ion, fluoride ion, chloride ion, or any combination thereof.

Aspect 37. A catalyst composition, a process for polymerizing olefins, or a method of making a catalyst composition according to any of Aspects 30-36, wherein the solid oxide treated with an electron-withdrawing anion comprises a sulfated solid oxide, bisulfated (hydrogen sulfated) solid oxide, fluorosulfated solid oxide, phosphated solid oxide, fluorophosphated solid oxide, fluoride solid oxide, or chloride solid oxide.

Aspect 38. A catalyst composition, a process for polymerizing olefins, or a method of making a catalyst composition according to any of Aspects 30-37, wherein the solid oxide treated with an electron-withdrawing anion comprises a fluorided solid oxide, a sulfated solid oxide or a phosphated solid oxide.

Aspect 39. A catalyst composition, a process for polymerizing olefins, or a method of making a catalyst composition according to any of Aspects 30-38, wherein the solid oxide treated with an electron-withdrawing anion comprises or is selected from fluorided alumina, chlorided alumina, bromided alumina, sulfated alumina, phosphated alumina, fluorided silica-alumina, chlorided silica-alumina, bromided silica-alumina, sulfated silica-alumina, phosphated silica-alumina, fluorided silica-zirconia, chlorided silica-zirconia, bromided silica-zirconia, sulfated silica-zirconia, phosphated silica-zirconia, fluorided mullite, chlorided mullite, bromided mullite, sulfated mullite, phosphated mullite, fluorided silica-coated alumina, chlorided silica-coated alumina, bromided silica-coated alumina, sulfated silica-coated alumina, phosphated silica-coated alumina, or any combination thereof.

Aspect 40. A catalyst composition, a process for polymerizing olefins, or a method of making a catalyst composition according to any of Aspects 30-39, wherein:
(a) the solid oxide comprises, consists essentially of, or is selected from silica, alumina, silica-alumina, silica-coated alumina, mullite, aluminum phosphate, aluminophosphate, heteropolytungstate, titania, zirconia, magnesia, boria, zinc oxide, a mixed oxide thereof, or any mixture thereof; and
(b) the electron-withdrawing anion comprises, consists essentially of, or is selected from sulfate, bisulfate, fluorosulfate, phosphate, fluorophosphates, fluoride, or chloride.

Aspect 41. A catalyst composition, a process for polymerizing olefins, or a method of making a catalyst composition according to any of Aspects 30-40, wherein:
(a) the solid oxide comprises, consists essentially of, or is selected from alumina, silica-alumina, silica-coated alumina, silica-zirconia, mullite, or a mixture thereof, and
(b) the electron-withdrawing anion comprises, consists essentially of, or is selected from fluoride, chloride, sulfate, or phosphate.

Aspect 42. A catalyst composition, a process for polymerizing olefins, or a method of making a catalyst composition according to any of Aspects any of Aspects 30-41, wherein the electron-withdrawing anion comprises or is selected from a sulfur oxoacid anion-modified solid oxide generated by sulfuric acid treatment or sulfate ion treatment.

Aspect 43. A catalyst composition, a process for polymerizing olefins, or a method of making a catalyst composition according to any of Aspects 30-42, wherein the electron-withdrawing anion comprises or is selected from a phosphorus oxoacid anion-modified solid oxide generated by phosphoric acid treatment or phosphate ion treatment.

Aspect 44. A catalyst composition, a process for polymerizing olefins, or a method of making a catalyst composition according to any of Aspects 30-43, wherein the solid oxide treated with an electron-withdrawing anion is any solid oxide or any combination of solid oxides disclosed herein, treated with any electron-withdrawing anion or any combination of electron-withdrawing anions disclosed herein.

Aspect 45. A catalyst composition, a process for polymerizing olefins, or a method of making a catalyst composition according to any of Aspects 30-44, wherein the solid oxide treated with an electron-withdrawing anion is produced by a process comprising contacting any suitable solid oxide and any suitable solid oxide with an electron-withdrawing anion to provide a mixture, and concurrently and/or subsequently drying and/or calcining the mixture.

Aspect 46. A catalyst composition, a process for polymerizing olefins, or a method of making a catalyst composition according to any of Aspects 30-45, wherein:
(a) the solid oxide component used to prepare the solid oxide treated with an electron-withdrawing anion, that is, the solid oxide prior to treatment with the electron-withdrawing anion, has the following properties:
   (i) a surface area from about 100 m²/g to about 1000 m²/g, from about 200 to about 800 m²/g, or from about 250 to about 600 m²/g;
   (ii) a pore volume from about 0.1 mL/g to about 3.0 mL/g, from about 0.25 mL/g to about 2.5 mL/g; or from about 0.4 mL/g to about 2.0 mL/g, or from about 0.5 mL/g to about 1.7 mL/g, greater than about 0.1 mL/g, greater than about 0.5 mL/g, or greater than about 1.0 mL/g;
   (iii) an average particle size from about 1 micron to about 250 microns, from about 2 microns to about 200 microns, from about 5 microns to about 150 microns, or from about 10 to about 100 microns; or
   (iv) any combination of (i), (ii), and (iii);

or
(b) the solid oxide treated with an electron-withdrawing anion has the following properties:
   (i) a surface area from about 100 m²/g to about 1000 m²/g, from about 200 to about 800 m²/g, or from about 250 to about 600 m²/g;
   (ii) a pore volume from about 0.1 mL/g to about 3.0 mL/g, from about 0.25 mL/g to about 2.5 mL/g; or from about 0.4 mL/g to about 2.0 mL/g, or from about 0.5 mL/g to about 1.7 mL/g, greater than about 0.1 mL/g, greater than about 0.5 mL/g, or greater than about 1.0 mL/g;
   (iii) an average particle size from about 1 micron to about 250 microns, from about 2 microns to about 200 microns, from about 5 microns to about 150 microns, or from about 10 to about 100 microns; or
   (iv) any combination of (i), (ii), and (iii).

Aspect 47. A catalyst composition, a process for polymerizing olefins, or a method of making a catalyst composition according to any of Aspects 30-46, wherein the solid oxide treated with an electron-withdrawing anion has a surface area from about 150 m²/g to about 700 m²/g.

Aspect 48. A catalyst composition, a process for polymerizing olefins, or a method of making a catalyst composition according to any of Aspects 30-47, wherein the solid oxide treated with an electron-withdrawing anion has a pore volume from about 0.5 mL/g to about 2.5 mL/g.

Aspect 49. A catalyst composition, a process for polymerizing olefins, or a method of making a catalyst composition according to any of Aspects 30-48, wherein the solid oxide treated with an electron-withdrawing anion has an average particle size (d50) from about 20 microns to about 100 microns.

Aspect 50. A catalyst composition, a process for polymerizing olefins, or a method of making a catalyst composition according to any preceding Aspect, wherein the metallocene activator comprises or further comprises an aluminoxane compound, or wherein the contacting step further comprises contacting in any order an aluminoxane compound.

Aspect 51. A catalyst composition, a process for polymerizing olefins, or a method of making a catalyst composition according to Aspect 50, wherein the aluminoxane comprises:
a cyclic aluminoxane having the formula

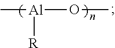

wherein R is a linear or branched alkyl having from 1 to 10 carbon atoms, and n is an integer from 3 to about 10;
   a linear aluminoxane having the formula

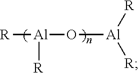

wherein R is a linear or branched alkyl having from 1 to 10 carbon atoms, and n is an integer from 1 to about 50;
a cage aluminoxane having the formula R^{t}_{5m+α}R^{b}_{m-α}Al₄ₘO₃ₘ, wherein m is 3 or 4 and α=n_{Al(3)}−n_{O(2)}+n_{O(4)}; wherein n_{Al(3)} is the number of three coordinate aluminum atoms, n_{O(2)} is the number of two coordinate oxygen atoms, n_{O(4)} is the number of 4 coordinate oxygen atoms, R^{t} represents a terminal alkyl group, and R^{b} represents a bridging alkyl group; wherein R is a linear or branched alkyl having from 1 to 10 carbon atoms; or
any combination thereof.

Aspect 52. A catalyst composition, a process for polymerizing olefins, or a method of making a catalyst composition according to Aspect 50, wherein aluminoxane has the formula:

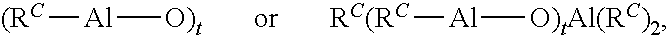

wherein
R^{C} is a linear or branched C₁-C₆ alkyl such as methyl, ethyl, propyl, butyl, pentyl, or hexyl wherein t is an integer from 1 to 50, inclusive.

Aspect 53. A catalyst composition, a process for polymerizing olefins, or a method of making a catalyst composition according to any of Aspects 50-52, wherein the aluminoxane comprises, consists essentially of, or is selected from methylaluminoxane (MAO), ethylaluminoxane, modified methylaluminoxane (MMAO) such as an isobutyl-modified methyl alumoxane, n-propylaluminoxane, iso-propylaluminoxane, n-butylaluminoxane, t-butyl-aluminoxane, sec-butylaluminoxane, iso-butylaluminoxane, t-butyl aluminoxane, 1-pentyl-aluminoxane, 2-pentylaluminoxane, 3-pentylaluminoxane, iso-pentylaluminoxane, neopentylaluminoxane, or combinations thereof.

Aspect 54. A catalyst composition, a process for polymerizing olefins, or a method of making a catalyst composition according to any preceding Aspect, wherein the catalyst composition is substantially free of, or wherein the contacting step is absent, an aluminoxane compound, an organoboron or organoborate compound, an ionizing ionic compound, or combinations thereof, or wherein the contacting step is absent an aluminoxane compound, an organoboron or organoborate compound, an ionizing ionic compound, or combinations thereof.

Aspect 55. A catalyst composition, a process for polymerizing olefins, or a method of making a catalyst composition according to any preceding Aspect, wherein the catalyst composition is substantially free of an aluminoxane compound, or wherein the contacting step is absent an aluminoxane compound.

### Co-Catalysts

Aspect 56. The catalyst composition, the process for polymerizing olefins, or the method of making a catalyst composition according to any of Aspects 1-55, wherein:
in the catalyst composition or the process for polymerizing olefins, the catalyst composition further comprises the contact product with a co-catalyst; or
in the method of making a catalyst composition, the contacting step further comprises contacting the metallocene compound and the metallocene activator or any components thereof with a co-catalyst in any order.

Aspect 57. A catalyst composition, a process for polymerizing olefins, or a method of making a catalyst composition according to Aspect 56, wherein the co-catalyst comprises, consists essentially of, or is selected from an alkylating agent.

Aspect 58. A catalyst composition, a process for polymerizing olefins, or a method of making a catalyst composition according to any of Aspects 56-57, wherein the co-catalyst further comprises an organoboron compound, an organozinc compound, an organomagnesium compound, an organolithium compound, or any combination thereof.

Aspect 59. The catalyst composition, the process for polymerizing olefins, or the method of making a catalyst composition according to any of Aspects 56-58, wherein the co-catalyst has a general formula:
M³(X¹⁰)_{q}(X¹¹)_{3-q}, wherein M³ is boron or aluminum, and q is from 1 to 3 inclusive;
M⁴(X¹⁰)_{q}(X¹¹)_{2-q}, wherein M⁴ is magnesium or zinc, and q is from 1 to 2 inclusive;
M^{S}X¹⁰, wherein M⁵ is Li; or any combination thereof;
wherein X¹⁰ in each occurrence is independently hydride or a C₁ to C₂₀ hydrocarbyl; and X¹¹ in each occurrence is independently a halide, a hydride, a C₁ to C₂₀ hydrocarbyl, or a C₁ to C₂₀ hydrocarbyloxide.

Aspect 60. A catalyst composition, a process for polymerizing olefins, or a method of making a catalyst composition according to any of Aspects 56-59, wherein the co-catalyst comprises, consists essentially of, or is selected from any organoaluminum compound having a formula Al(X¹⁰)ₙ(X¹¹)₃₋ₙ, wherein n is 1, 2 or to 3; X¹⁰ is independently a C₁ to C₂₀ hydrocarbyl; and X¹¹ is independently a halide, a hydride, a C₁ to C₂₀ hydrocarbyl, or a C₁ to C₂₀ hydrocarbyloxide.

Aspect 61. The catalyst composition, the process for polymerizing olefins, or the method of making a catalyst composition according to any of Aspects 56-60, wherein the co-catalyst comprises, consists of, consists essentially of, or is selected from trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, or any combination thereof.

Aspect 62. The catalyst composition, the process for polymerizing olefins, or the method of making a catalyst composition according to any of Aspects 56-61, wherein the co-catalyst comprises, consists of, consists essentially of, or is selected from trimethylaluminum, triethylaluminum, triisobutylaluminum, diethylaluminum chloride, or any combination thereof.

Aspect 63. A catalyst composition, a process for polymerizing olefins, or a method of making a catalyst composition according to any of Aspects 56-62, wherein the co-catalyst comprises, consists essentially of, or is selected from a trialkylaluminum compound.

Aspect 64. A catalyst composition, a process for polymerizing olefins, or a method of making a catalyst composition according to any of Aspects 56-63, wherein the co-catalyst comprises, consists essentially of, or is selected from any organoaluminum compound disclosed herein.

Aspect 65. A catalyst composition, a process for polymerizing olefins, or a method of making a catalyst composition according to any of Aspects 56-64, wherein the catalyst composition further comprises an aluminoxane compound, or wherein the contacting step further comprises contacting in any order an aluminoxane compound.

### Diluents

Aspect 66. The catalyst composition, the process for polymerizing olefins, or the method of making a catalyst composition according to any of Aspects 1-65, wherein:
the catalyst composition further comprises a diluent; or
the catalyst composition further comprises the contact product of a diluent; or
the method further comprises contacting in any order a diluent.

Aspect 67. A catalyst composition, a process for polymerizing olefins, or a method of making a catalyst composition according to Aspect 66, wherein the diluent comprises any suitable non-protic solvent, or any non-protic solvent disclosed herein.

Aspect 68. A catalyst composition, a process for polymerizing olefins, or a method of making a catalyst composition according to any of Aspects 66-67, wherein the diluent comprises any suitable weakly-coordinating or non-coordinating solvent, or any weakly-coordinating or non-coordinating solvent disclosed herein.

Aspect 69. A catalyst composition, a process for polymerizing olefins, or a method of making a catalyst composition according to any of Aspects 66-68, wherein the diluent comprises any suitable aliphatic hydrocarbon solvent, or any aliphatic hydrocarbon solvent disclosed herein, e.g. a diluent olefin in the case of bulk polymerizations, propane, butanes (for example, n-butane, iso-butane), pentanes (for example, n-pentane, iso-pentane), hexanes, heptanes, octanes, petroleum ether, light naphtha, heavy naphtha, or any combination thereof.

Aspect 70. A catalyst composition, a process for polymerizing olefins, or a method of making a catalyst composition according to any of Aspects 66-69, wherein the diluent or further comprises any suitable aromatic hydrocarbon solvent, or any aromatic hydrocarbon solvent disclosed herein, e.g., benzene, toluene, xylenes, etc.

Aspect 71. A method of making a catalyst composition according to any of Aspects 3-70, wherein:
(a) the metallocene compound and the co-catalyst are contacted in a diluent, to provide a first composition, and the first composition is contacted with the metallocene activator;
(b) the metallocene compound and the metallocene activator are contacted in the diluent, to provide a second composition, and the second composition is contacted with the co-catalyst;
(c) the co-catalyst and the metallocene activator are contacted in the diluent, to provide a third composition, and the third composition is contacted with the metallocene compound; or
(d) the metallocene compound, the metallocene activator, and the co-catalyst are co-fed and contacted in a single step.

Aspect 72. A method of making a catalyst composition according to any of Aspects 3-71, wherein the recited components are contacted in the presence of an olefin.

Aspect 73. A method of making a catalyst composition according to any of Aspects 3-71, wherein the recited components are contacted in the absence of an olefin.

### Processes for Polymerizing Olefins

Aspect 74. A process for polymerizing olefins according to any of Aspects 2 and 4-70, wherein at least one olefin monomer comprises ethylene.

Aspect 75. A process for polymerizing olefins according to any of Aspects 2, 4-70, and 74, wherein the at least one olefin monomer comprises ethylene or ethylene in combination with an olefin co-monomer selected from propylene, butene (e.g., 1-butene), pentene, hexene (e.g., 1-hexene), heptene, octene (e.g., 1-octene), styrene, and the like.

Aspect 76. A process for polymerizing olefins according to any of Aspects 2, 4-70, and 74-75, wherein the at least one olefin monomer comprises ethylene, propylene, butene (e.g., 1-butene), pentene, hexene (e.g., 1-hexene), heptene, octene (e.g., 1-octene), or styrene.

Aspect 77. A process for polymerizing olefins according to any of Aspects 2, 4-70, and 74-76, wherein the process is conducted in the presence of hydrogen.

Aspect 78. A process for polymerizing olefins according to any of Aspects 2, 4-70, and 74-76, wherein the process is conducted in the absence of hydrogen.

Aspect 79. A process for polymerizing olefins or a method of making a catalyst composition according to any of Aspects 2 and 4-78, wherein:
(a) the process or the method is carried out under any of following conditions:
   (i) a molar ratio of the co-catalyst to the metallocene compound is from about 0.1:1 to about 1,200:1, or from about 2:1 to about 1,100:1, or from about 5:1 to about 1,000:1, or from about 10:1 to about 750:1;
   (ii) a weight ratio of the metallocene activator to the metallocene compound is from about 5:1 to about 1,500:1, or from about 10:1 to about 1,250:1, or form about 20:1 to about 1,000:1;
   (iii) a weight ratio of the at least one olefin monomer to the metallocene compound is from about 1,000:1 to about 100,000,000:1, or from about 5,000:1 to about 50,000,000:1, or from about 10,000:1 to about 25,000,000:1; or
   (iv) any combination of conditions (i), (ii), and (iii);

or
(b) the process or the method is carried out under any of following conditions:
   (i) a molar ratio of the co-catalyst to the metallocene compound(s) is from about 10:1 to about 500:1, for example when the co-catalyst comprises an organoaluminum compound such as a trialkylaluminum compound; or
   (ii) a weight ratio of the metallocene activator to the metallocene compound(s) is from about 5:1 to about 1,000:1, for example when the metallocene activator comprises a fluorided silica-alumina, fluorided silica-coated alumina or a fluorided mullite; or
   (iii) a weight ratio of the at least one olefin monomer to the metallocene compound(s) is from about 1,000:1 to about 100,000,000:1; or
   (iv) any combination of (i), (ii), and (iii).

Aspect 80. A process for polymerizing olefins according to any of Aspects 2, 4-70, and 74-79, wherein the process is conducted in a polymerization reactor system comprising, consisting essentially of, or selected from a batch reactor, a slurry reactor, a loop-slurry reactor, a gas phase reactor, a solution reactor, a high pressure reactor, a tubular reactor, an autoclave reactor, a continuous stirred tank reactor (CSTR), or a combination thereof.

Aspect 81. A process for polymerizing olefins according to any of Aspects 2, 4-70, and 74-80, wherein the polymerization conditions suitable to form a polyethylene comprise:
(a) a polymerization reaction temperature from about 40° C. to about 280° C., from about 50° C. to about 180° C., or from about from about 60° C. to about 160° C.; or
(b) a reaction pressure or a partial pressure of ethylene of from about 25 psi (0.17 MPa) to about 1500 psi (10.3 MPa), from about 50 psig (0.34 mPa) to about 1200 psig (8.3 MPa), from about 85 psig (0.59 mPa) to about 1100 psig (7.6 MPa), or from about 100 psig (0.69 MPa) to about 1000 psig (6.9 MPa);
(c) a time of the contacting step of from about 1 minute to about 3 hours, from about 5 minutes to about 2.5 hours, from about 10 minutes to about 2 hours, or from about 20 minutes to about 1.5 hours; or
(d) any combination of (a), (b), and (c).

Aspect 82. A catalyst composition, a process for polymerizing olefins, or a method of making a catalyst composition according to any preceding Aspect, wherein the catalyst composition is characterized by an activator-support (e.g. SSA) in a range from about 1,000 g PE(g activator-support·hour) (grams of polyethylene per gram of activator-support per hour, or “g/(g·h)” in this Aspect) to about 55,000 g PE/(g activator-support·hour), alternatively from about 2,000 g/(g·h) to about 50,000 g/(g·h), or alternatively from about 3,000 g/(g·h) to about 45,000 g/(g·h).

Aspect 83. A catalyst composition, a process for polymerizing olefins, or a method of making a catalyst composition according to any preceding Aspect, wherein the catalyst composition is characterized by a metallocene activity in a range from about 100,000 g PE/(g metallocene·hour) (grams of polyethylene per gram of metallocene per hour, or “g/(g·h)” in this Aspect) to about 1,000,000 g PE/(g metallocene·hour), from about 150,000 g/(g·h) to about 800,000 g/(g·h), or from about 200,000 g/(g·h) to about 600,000 g/(g·h).

Aspect 84. A polyolefin prepared according to the process for polymerizing olefins of any of Aspects 2, 4-70, and 74-83, wherein the polyolefin is an ethylene homopolymer characterized by any one or any combination of the following properties:
(a) a polydispersity index (molecular weight distribution, Mw/Mn) of from 1.5 to 10, alternatively from 1.7 to 9, or alternatively from 2.0 to 8.5;
(b) a weight average molecular weight (Mw) in the absence of hydrogen of from 100 kg/mol to 2,000 kg/mol, alternatively from 200 kg/mol to 1,500 kg/mol, or alternatively from 300 kg/mol to 1,200 kg/mol; and/or
(c) a Janzen-Colby η(0) value of from 0.5 to 20 long chain branches (LCB) per 10⁶ carbon atoms (“LCB/10⁶C”), alternatively from 1 to 18 LCB/10⁶C, or alternatively from 5 to 15 LCB/10⁶C.

Aspect 85. A polyolefin prepared according to the process for polymerizing olefins of any of Aspects 2, 4-70, and 74-83, wherein the polyolefin is an ethylene-α-olefin copolymer characterized by any one or any combination of the following properties:
(a) a polydispersity index (molecular weight distribution, Mw/Mn) of from 1.5 to 13.5, alternatively, from 1.7 to 13, or alternatively from 2.0 to 12.5;
(b) a weight average molecular weight (Mw) in the absence of hydrogen of from 100 kg/mol to 2,500 kg/mol, alternatively from 200 kg/mol to 2,000 kg/mol, or alternatively from 400 kg/mol to 1,500 kg/mol; and/or
(c) a Janzen-Colby η(0) value of from 5 to 100 long chain branches (LCB) per 10⁶ carbon atoms (“LCB/10⁶C”), alternatively from 10 to 80 LCB/10⁶C, or alternatively from 14 to 60 LCB/10⁶C.

Aspect 86. A polyolefin produced by the process for polymerizing olefins of any of Aspects 2, 4-70, and 74-85.

Aspect 87. An article comprising the polyolefin according to Aspect 86.

Aspect 88. An article according to Aspect 87, wherein the article is an agricultural film, an automobile part, a bottle, a drum, a fiber, a fabric, a food packaging film or container, a container preform, a food service article, a fuel tank, a geomembrane, a household container, a liner, a molded product, a medical device or material, a pipe, a sheet, a tape, or a toy.

Aspect 89. A method for making an article of manufacture comprising a polyolefin, the method comprising:
(a) performing the polymerization process according to any of Aspects 2, 4-70, and 74-83; and
(b) fabricating the article of manufacture comprising the polyolefin.

### Metallocenes

Aspect 90. A metallocene compound having the formula:

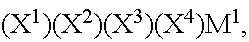

wherein
M¹ is titanium, zirconium, or hafnium;
M¹ is titanium, zirconium, or hafnium;
X¹ is a substituted or an unsubstituted cyclopentadienyl ligand, wherein substituents, when present, are selected independently from a C₁-C₂₀ hydrocarbyl group;
X² is a substituted or an unsubstituted fluorenyl ligand, wherein substituents, when present, are selected independently from a C₁-C₂₀ hydrocarbyl group;
X¹ and X² are bridged by a linking group having the formula >C[C₆H₂R¹R²₂][R³], wherein
   R¹ is —O(CH₂)ₘCH═CH₂;
   R² in each occurrence is selected independently from H or a C₁-C₂₀ hydrocarbyl group;
   R³ is H, a C₁-C₂₀ hydrocarbyl group, or [C₆H₂R⁴R⁵₂];
   R⁴ is H, a C₁-C₂₀ hydrocarbyl group, or —O(CH₂)ₙCH═CH₂;
   R⁵ in each occurrence is selected independently from H or a C₁-C₂₀ hydrocarbyl group; and
   m and n in each occurrence are selected independently from an integer from 1 to 20; and
X³ and X⁴ are independently a monoanionic ligand.

Aspect 91. A metallocene compound according to Aspect 90, wherein:
(a) the substituent on X¹ and the substituent on X², when present, are selected independently from a C₁-C₂₀ aliphatic group, a C₆-C₂₀ aromatic group, a C₁-C₁₂ aliphatic group, a C₆-C₁₂ aromatic group, a C₁-C₁₀ aliphatic group, or a C₆-C₁₀ aromatic group, wherein the carbon count includes any hydrocarbyl substituent or branch on the aliphatic group or the aromatic group;
(b) X³ and X⁴ are independently halide, hydride, a C₁-C₂₀ hydrocarbyl group, a C₁-C₂₀ heterohydrocarbyl group, tetrahydroborate, OBR^{A}₂, OSO₂R^{A}, or NR^{A}₂ wherein R^{A} is independently a C₁-C₁₂ hydrocarbyl group, for example, X³ and X⁴ can be selected independently from F, Cl, Br, a hydride, a C₁-C₁₂ hydrocarbyl group, a C₁-C₁₂ hydrocarbyloxide group, or an SiR^{D}₃-substituted C₁ to C₁₂ hydrocarbyl group wherein R^{D} is independently a C₁ to C₈ hydrocarbyl group; and/or
(c) n is an integer from 1 to 10.

Aspect 92. A metallocene compound according to any of Aspects 90-91, wherein the C₁-C₂₀ hydrocarbyl group, when present as a substituent on X¹ or X², is selected independently from methyl, ethyl, i-propyl, n-propyl, t-butyl, n-butyl, n-hexyl, or phenyl.

Aspect 93. A metallocene compound according to any of Aspects 90-92, wherein:
(a) X¹ is an unsubstituted cyclopentadienyl and X² is an unsubstituted fluorenyl;
(b) X¹ is an unsubstituted cyclopentadienyl and X² is 2,7-di-t-butyl-fluorenyl;
(c) X¹ is a substituted cyclopentadienyl and X² is an unsubstituted fluorenyl; or
(d) X¹ is a substituted cyclopentadienyl and X² is 2,7-di-t-butyl-fluorenyl.

Aspect 94. A metallocene compound according to any of Aspects 90-93, wherein n and m are independently an integer from 1 to 15, alternatively an integer from 1 to 12, alternatively an integer from 1 to 6, alternatively an integer from 1 to 4, or alternatively 1, 2, or 3.

Aspect 95. A metallocene compound according to any of Aspects 90-94, wherein n and m are both 1, alternatively n and m are both 2, alternatively n and m are both 3, alternatively n and m are both 4, or alternatively n and m are both 5.

Aspect 96. A metallocene compound according to any of Aspects 90-95, wherein independently:
R¹ is bonded to the 3-, 4-, or 5-position of the C₆H₂R¹R²₂ group; and
R⁴ is bonded to the 3-, 4-, or 5-position of the C₆H₂R⁴R⁵₂ group.

Aspect 97. A metallocene compound according to any of Aspects 90-96, wherein independently:
R¹ and the independently selected R² groups are bonded to and distributed among the 3-, 4-, and 5-positions of the C₆H₂R¹R²₂ moiety; and
R⁴ and the independently selected R⁵ groups are bonded to and distributed among the 3-, 4-, and 5-positions of the C₆H₂R⁴R⁵₂ moiety.

Aspect 98. A metallocene compound according to any of Aspects 90-97, wherein independently:
(a) R¹ is bonded to the 4-position and the independently selected R² groups are bonded to and distributed between the 3- and 5-positions of the C₆H₂R¹R²₂ moiety; and
R⁴ is bonded to the 4-position and the independently selected R⁵ groups are bonded to and distributed between the 3- and 5-positions of the C₆H₂R⁴R⁵₂ moiety;
(b) R¹ is bonded to the 3-position and the independently selected R² groups are bonded to and distributed between the 4- and 5-positions of the C₆H₂R¹R²₂ moiety; and
R⁴ is bonded to the 3-position and the independently selected R⁵ groups are bonded to and distributed between the 4- and 5-positions of the C₆H₂R⁴R⁵₂ moiety;
(c) R¹ is bonded to the 4-position and the independently selected R² groups are bonded to and distributed between the 3- and 5-positions of the C₆H₂R¹R²₂ moiety; and
R⁴ is bonded to the 3-position and the independently selected R⁵ groups are bonded to and distributed between the 4- and 5-positions of the C₆H₂R⁴R⁵₂ moiety;

or
(d) R¹ is bonded to the 3-position and the independently selected R² groups are bonded to and distributed between the 4- and 5-positions of the C₆H₂R¹R²₂ moiety; and
R⁴ is bonded to the 4-position and the independently selected R⁵ groups are bonded to and distributed between the 3- and 5-positions of the C₆H₂R⁴R⁵₂ moiety;
Aspect 99. A metallocene compound according to any of Aspects 90-98, wherein the linking group has the formula:

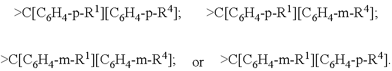

Aspect 100. A metallocene compound according to any of Aspects 90-99, wherein independently:
R¹ is bonded to the 4-position of the C₆H₂R¹R²₂ group; and
R⁴ is bonded to the 4-position of the C₆H₂R⁴R⁵₂ group.

Aspect 101. A metallocene compound according to any of Aspects 90-100, wherein:
R¹ and R⁴ are selected independently from OCH₂CH═CH₂, O(CH₂)₂CH═CH₂, O(CH₂)₃CH═CH₂, O(CH₂)₄CH═CH₂, O(CH₂)₅CH═CH₂, or O(CH₂)₆CH═CH₂.

Aspect 102. A metallocene compound according to any of Aspects 90-101, wherein R³ is C₆H₂R⁴R⁵₂, and R⁴ and R⁵ in each occurrence is H.

Aspect 103. A metallocene compound according to any of Aspects 90-102, wherein R² and R⁵ in each occurrence is selected independently from H, methyl, ethyl, i-propyl, n-propyl, t-butyl, n-butyl, n-hexyl, or phenyl.

Aspect 104. A metallocene compound according to any of Aspects 90-103, wherein the metallocene compound has the formula:

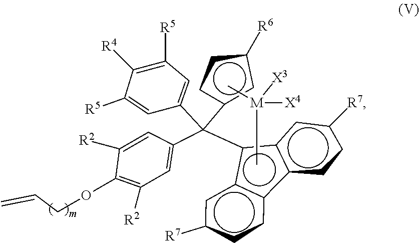

wherein
M is Zr or Hf;
X³ and X⁴ are both Cl or both Br;
R⁴ is H or —O(CH₂)ₙCH═CH₂;
R², R⁵, and R⁶ in each occurrence are selected independently from H, methyl, ethyl, n-propyl, i-propyl, or t-butyl;
R⁷ is H, methyl, or t-butyl; and
m and n are selected independently from 1, 2, 3, 4, 5, 6, 7, or 8.

Aspect 105. A metallocene compound according to any of Aspects 90-104, wherein the metallocene compound has the formula:

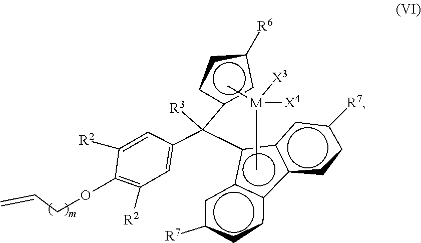

wherein
M is Zr or Hf;
X³ and X⁴ are both Cl or both Br;
R² in each occurrence, R³, and R⁶ are selected independently from H, methyl, ethyl, n-propyl, i-propyl, t-butyl, or phenyl;
R⁷ is H, methyl, or t-butyl; and
m is selected from 1, 2, 3, 4, 5, 6, 7, or 8.

Aspect 106. A metallocene compound according to any of Aspects 90-105, wherein the metallocene compound has the formula:

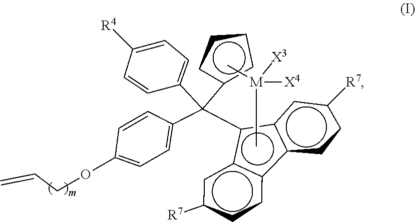

wherein
M is Zr or Hf;
X³ and X⁴ are both Cl or both Br;
R⁴ is H or —O(CH₂)ₙCH═CH₂;
R⁷ is H, methyl, or t-butyl; and
m and n are selected independently from 1, 2, 3, 4, 5, 6, 7, or 8.

Aspect 107. A metallocene compound according to any of Aspects 90-106, wherein the metallocene compound has the formula:

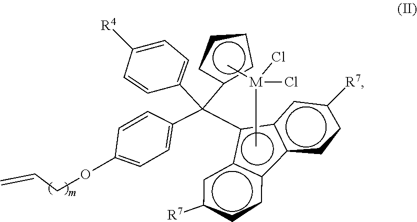

wherein
M is Zr or Hf;
R⁴ is H or —O(CH₂)ₙCH═CH₂;
R⁷ is H or t-butyl; and
m and n are selected independently from 1, 2, 3, 4, 5, or 6.

Aspect 108. A metallocene compound according to any of Aspects 90-107, wherein the metallocene compound has the formula:

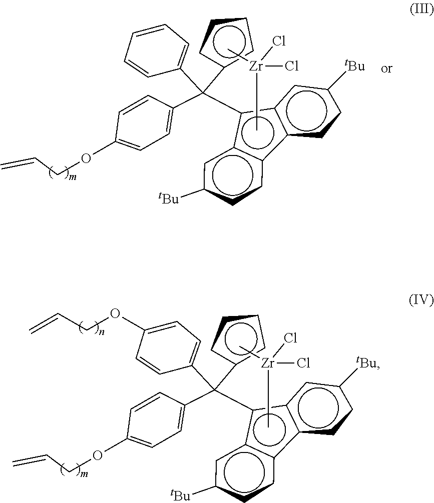

wherein m and n are selected independently from 1, 2, 3, 4, or 5.

Aspect 109. A metallocene compound having the formula:

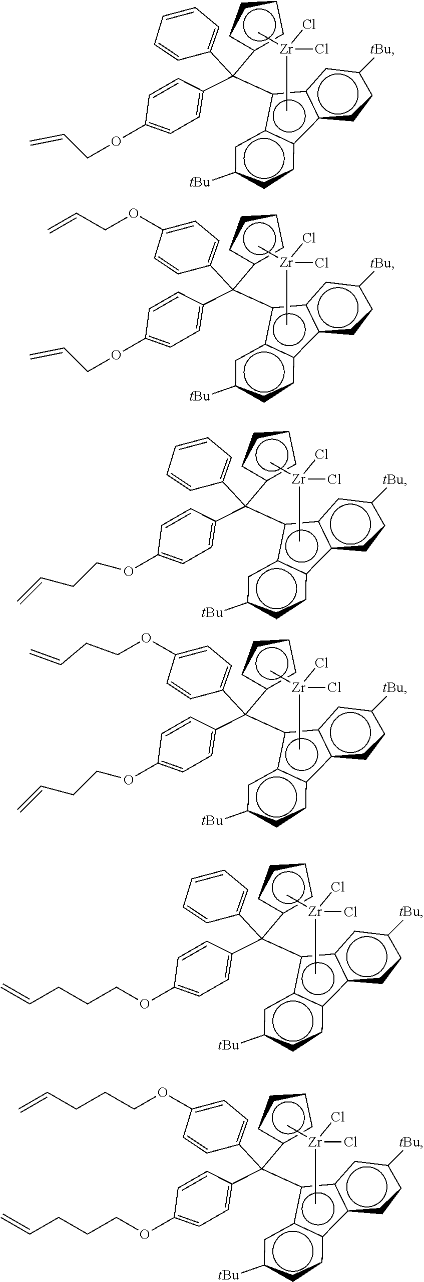

or any combination thereof.

We claim:

1. A catalyst composition for polymerizing olefins, the catalyst composition comprising the contact product of:
(a) a metallocene compound having the formula: 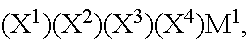
wherein
M¹ is titanium, zirconium, or hafnium;
X¹ is a substituted or an unsubstituted cyclopentadienyl ligand, wherein substituents, when present, are selected independently from a C₁-C₂₀ hydrocarbyl group;
X² is a substituted or an unsubstituted fluorenyl ligand, wherein substituents, when present, are selected independently from a C₁-C₂₀ hydrocarbyl group;
X¹ and X² are bridged by a linking group having the formula >C[C₆H₂R¹R²₂][R³], wherein
R¹ is —O(CH₂)ₘCH═CH₂;
R² in each occurrence is selected independently from H or a C₁-C₂₀ hydrocarbyl group;
R³ is H, a C₁-C₂₀ hydrocarbyl group, or [C₆H₂R⁴R⁵₂];
R⁴ is H, a C₁-C₂₀ hydrocarbyl group, or —O(CH₂)ₙCH═CH₂;
R⁵ in each occurrence is selected independently from H or a C₁-C₂₀ hydrocarbyl group; and
m and n in each occurrence are selected independently from an integer from 1 to 20; and
X³ and X⁴ are independently a monoanionic ligand;
(b) a metallocene activator or any components thereof; and
(c) optionally, a co-catalyst.

2. The catalyst composition according to claim 1, wherein X³ and X⁴ are independently halide, hydride, a C₁-C₂₀ hydrocarbyl group, a C₁-C₂₀ heterohydrocarbyl group, tetrahydroborate, OBR^{A}₂, OSO₂R^{A}, or NR^{A}₂ wherein R^{A} is independently a C₁-C₁₂ hydrocarbyl group.

3. The catalyst composition according to claim 1, wherein X³ and X⁴ are selected independently from F, Cl, Br, a hydride, a C₁-C₁₂ hydrocarbyl group, a C₁-C₁₂ hydrocarbyloxide group, or an SiR^{D}₃-substituted C₁ to C₁₂ hydrocarbyl group wherein R^{D} is independently a C₁ to C₈ hydrocarbyl group.

4. The catalyst composition according to claim 1, wherein the substituent on X¹ and the substituent on X², when present, are selected independently from methyl, ethyl, i-propyl, n-propyl, t-butyl, n-butyl, n-hexyl, or phenyl.

5. The catalyst composition according to claim 1, wherein m and n are independently an integer from 1 to 12.

6. The catalyst composition according to claim 1, wherein independently:
R¹ is bonded to the 3-, 4-, or 5-position of the C₆H₂R¹R²₂ group; and
R⁴ is bonded to the 3-, 4-, or 5-position of the C₆H₂R⁴R⁵₂ group.

7. The catalyst composition according to claim 1, wherein independently:
R¹ and the independently selected R² groups are bonded to and distributed among the 3-, 4-, and 5-positions of the C₆H₂R¹R²₂ moiety; and
R⁴ and the independently selected R⁵ groups are bonded to and distributed among the 3-, 4-, and 5-positions of the C₆H₂R⁴R⁵₂ moiety.

8. The catalyst composition according to claim 1, wherein the linking group has the formula:

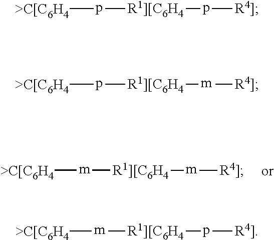

9. The catalyst composition according to claim 1, wherein:
R¹ and R² are selected independently from OCH₂CH═CH₂, O(CH₂)₂CH═CH₂, O(CH₂)₃CH═CH₂, O(CH₂)₄CH═CH₂, O(CH₂)₅CH═CH₂, or O(CH₂)₆CH═CH₂.

10. The catalyst composition according to claim 1, wherein the metallocene compound has the formula: 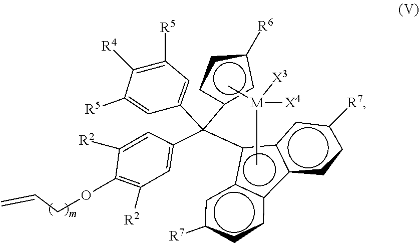
wherein
M is Zr or Hf;
X³ and X⁴ are both Cl or both Br;
R⁴ is H or —O(CH₂)ₙCH═CH₂;
R², R⁵, and R⁶ in each occurrence are selected independently from H, methyl, ethyl, n-propyl, i-propyl, or t-butyl;
R⁷ is H, methyl, or t-butyl; and
m and n are selected independently from 1, 2, 3, 4, 5, 6, 7, or 8.

11. The catalyst composition according to claim 1, wherein the metallocene compound has the formula: 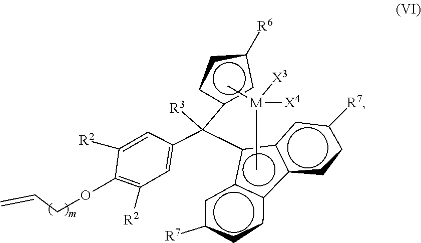
wherein
M is Zr or Hf;
X³ and X⁴ are both Cl or both Br;
R² in each occurrence, R³, and R⁶ are selected independently from H, methyl, ethyl, n-propyl, i-propyl, t-butyl, or phenyl;
R⁷ is H, methyl, or t-butyl; and
m is selected from 1, 2, 3, 4, 5, 6, 7, or 8.

12. The catalyst composition according to claim 1, wherein the metallocene compound has the formula: 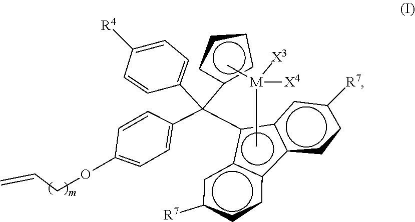
wherein
M is Zr or Hf;
X³ and X⁴ are both Cl or both Br;
R⁴ is H or —O(CH₂)ₙCH═CH₂;
R⁷ is H, methyl, or t-butyl; and
m and n are selected independently from 1, 2, 3, 4, 5, 6, 7, or 8.

13. The catalyst composition according to claim 1, wherein the metallocene compound has the formula: 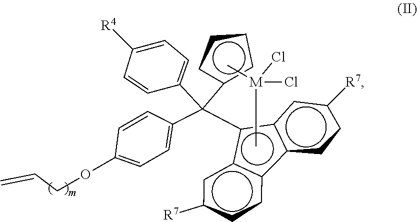
wherein
M is Zr or Hf;
R⁴ is H or —O(CH₂)ₙCH═CH₂;
R⁷ is H or t-butyl; and
m and n are selected independently from 1, 2, 3, 4, 5, or 6.

14. The catalyst composition according to claim 1, wherein the metallocene compound has the formula: 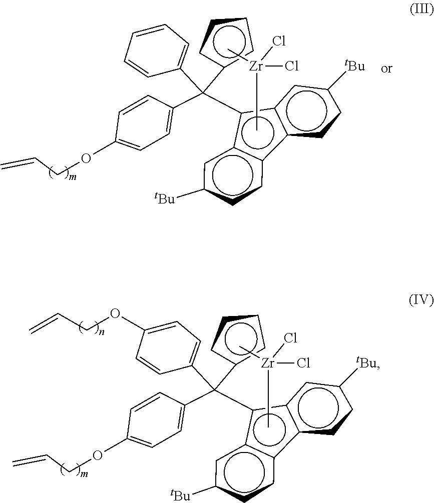
wherein m and n are selected independently from 1, 2, 3, 4, or 5.

15. The catalyst composition according to claim 1, wherein the metallocene compound has the formula: 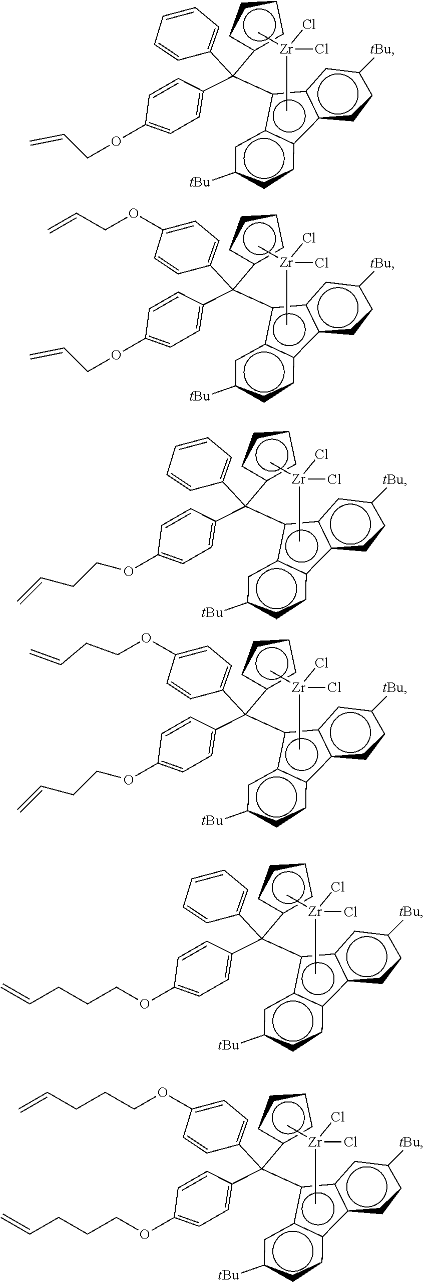
or any combination thereof.

16. The catalyst composition according to claim 1, wherein:
the metallocene activator comprises a solid oxide treated with an electron-withdrawing anion, an organoboron compound, an organoborate compound, an ionizing ionic compound, an aluminoxane compound, or any combination thereof.

17. The catalyst composition according to claim 1, wherein:
the metallocene activator comprises a solid oxide treated with an electron-withdrawing anion, and
the solid oxide comprises silica, alumina, titania, zirconia, magnesia, boria, calcia, zinc oxide, silica-alumina, silica-coated alumina, silica-titania, silica-zirconia, silica-magnesia, alumina-titania, alumina-zirconia, zinc-aluminate, alumina-boria, silica-boria, aluminum phosphate, aluminophosphate, aluminophosphate-silica, magnesium aluminate, titania-zirconia, mullite, boehmite, heteropolytungstates, mixed oxides thereof, or any combination thereof.

18. The catalyst composition according to claim 17, wherein the electron-withdrawing anion comprises fluoride, chloride, bromide, iodide, sulfate, bisulfate, fluorosulfate, phosphate, fluorophosphate, triflate, mesylate, tosylate, thiosulfate, C₁-C₁₀ alkyl sulfonate, C₆-C₁₄ aryl sulfonate, trifluoroacetate, fluoroborate, fluorozirconate, fluorotitanate, or any combination thereof.

19. The catalyst composition according to claim 18, wherein:
the solid oxide comprises silica, alumina, silica-alumina, silica-coated alumina, or any combination thereof; and
the electron-withdrawing anion comprises fluoride, sulfate, or phosphate.

20. The catalyst composition according to claim 17, wherein the solid oxide treated with an electron-withdrawing anion has the following properties:
(a) a surface area from about 100 m²/g to about 1000 m²/g;
(b) a pore volume from about 0.1 mL/g to about 3.0 mL/g;
(c) an average particle size from about 1 micron to about 250 microns; or
(d) any combination of (a), (b), and (c).

21. The catalyst composition according to claim 17, wherein the solid oxide treated with an electron-withdrawing anion has an average particle size (d50) from about 10 microns to about 100 microns.

22. The catalyst composition according to claim 1, wherein catalyst composition is substantially free of an aluminoxane compound.

23. The catalyst composition according to claim 1, wherein the catalyst composition comprises an organoaluminum co-catalyst.

24. A process for polymerizing olefins, the process comprising contacting at least one olefin monomer and a catalyst composition under polymerization conditions to form a polyolefin, wherein the catalyst composition comprises the contact product of:
(a) a metallocene compound having the formula: 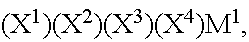
wherein
M¹ is titanium, zirconium, or hafnium;
X¹ is a substituted or an unsubstituted cyclopentadienyl ligand, wherein substituents, when present, are selected independently from a C₁-C₂₀ hydrocarbyl group;
X² is a substituted or an unsubstituted fluorenyl ligand, wherein substituents, when present, are selected independently from a C₁-C₂₀ hydrocarbyl group;
X¹ and X² are bridged by a linking group having the formula >C[C₆H₂R¹R²₂][R³], wherein
R¹ is —O(CH₂)ₘCH═CH₂;
R² in each occurrence is selected independently from H or a C₁-C₂₀ hydrocarbyl group;
R³ is H, a C₁-C₂₀ hydrocarbyl group, or [C₆H₂R⁴R⁵₂];
R⁴ is H, a C₁-C₂₀ hydrocarbyl group, or —O(CH₂)ₙCH═CH₂;
R⁵ in each occurrence is selected independently from H or a C₁-C₂₀ hydrocarbyl group; and
m and n in each occurrence are selected independently from an integer from 1 to 20; and
X³ and X⁴ are independently a monoanionic ligand;
(b) a metallocene activator; and
(c) optionally, a co-catalyst.

25. The process for polymerizing olefins according to claim 24, wherein the metallocene compound has the formula: 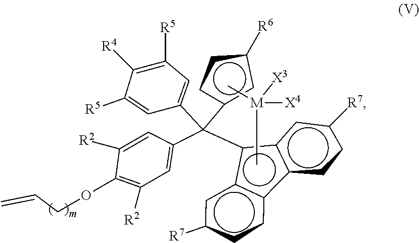
wherein
M is Zr or Hf;
X³ and X⁴ are both Cl or both Br;
R⁴ is H or —O(CH₂)ₙCH═CH₂;
R², R⁵, and R⁶ in each occurrence are selected independently from H, methyl, ethyl, n-propyl, i-propyl, or t-butyl;
R⁷ is H, methyl, or t-butyl; and
m and n are selected independently from 1, 2, 3, 4, 5, 6, 7, or 8.

26. The process for polymerizing olefins according to claim 24, wherein the metallocene compound has the formula: 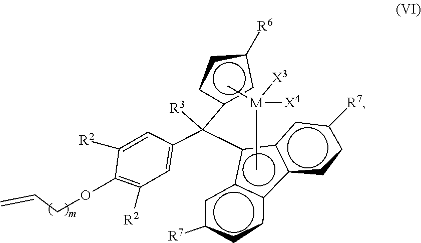
wherein
M is Zr or Hf;
X³ and X⁴ are both Cl or both Br;
R² in each occurrence, R³, and R⁶ are selected independently from H, methyl, ethyl, n-propyl, i-propyl, t-butyl, or phenyl;
R⁷ is H, methyl, or t-butyl; and
m is selected from 1, 2, 3, 4, 5, 6, 7, or 8.

27. A metallocene compound having the formula: 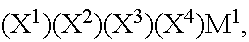
wherein
M¹ is titanium, zirconium, or hafnium;
X¹ is a substituted or an unsubstituted cyclopentadienyl ligand, wherein substituents, when present, are selected independently from a C₁-C₂₀ hydrocarbyl group;
X² is a substituted or an unsubstituted fluorenyl ligand, wherein substituents, when present, are selected independently from a C₁-C₂₀ hydrocarbyl group;
X¹ and X² are bridged by a linking group having the formula >C[C₆H₂R¹R²₂][R³], wherein
R¹ is —O(CH₂)ₘCH═CH₂;
R² in each occurrence is selected independently from H or a C₁-C₂₀ hydrocarbyl group;
R³ is H, a C₁-C₂₀ hydrocarbyl group, or [C₆H₂R⁴R⁵₂];
R⁴ is H, a C₁-C₂₀ hydrocarbyl group, or —O(CH₂)ₙCH═CH₂;
R⁵ in each occurrence is selected independently from H or a C₁-C₂₀ hydrocarbyl group; and
m and n in each occurrence are selected independently from an integer from 1 to 20; and
X³ and X⁴ are independently a monoanionic ligand.
